(19) United States
(12) Patent Application Publication
(10) Pub. No.: US 2026/0058343 A1
(43) Pub. Date: Feb. 26, 2026

(54) ELECTRODE ASSEMBLIES FOR SECONDARY BATTERIES THAT INCLUDE CURRENT LIMITERS

(71) Applicant: Enovix Corporation, Fremont, CA (US)

(72) Inventors: Michael J. Armstrong, New Braunfels, TX (US); Daniel J. Noelle, Mountain View, CA (US); Robert S. Busacca, Oakland, CA (US); Bruno A. Valdes, Sunnyvale, CA (US); Robert K. Rosen, Lincoln, CA (US); Murali Ramasubramanian, Fremont, CA (US); Ashok Lahiri, Fremont, CA (US); Robert M. Spotnitz, Pleasanton, CA (US)

(21) Appl. No.: 19/119,072

(22) PCT Filed: Oct. 5, 2023
(86) PCT No.: PCT/US2023/076066

§ 371 Date: Apr. 7, 2025

Related U.S. Application Data
(60) Provisional application No. 63/378,493, filed on Oct. 5, 2022.

(51) Int. Cl. H01M 50/586; H01M 10/653; H01M 50/105; H01M 50/533; H01M 50/54; H01M 50/581

(52) U.S. Cl. CPC H01M 50/586; H01M 10/653; H01M 50/533; H01M 50/54; H01M 50/581; H01M 50/105

(57) ABSTRACT

An electrode assembly includes unit cells stacked in a stacking direction, each including an electrode structure, a separator structure, and a counter-electrode structure. The electrode structure includes an electrode current collector and an electrode active material layer, the electrode structure extends in a longitudinal direction perpendicular to the stacking direction, an end portion of the electrode current collector extends past an outer surface of the electrode active material layer and the separator structure. The electrode assembly further includes an adhesive layer including a resistive polymeric material, and an electrode busbar attached to the end portions of the electrode current collectors through the adhesive layer. The adhesive layer is configured to adhere with the electrode busbar and the electrode current collectors below a transition temperature, and at least partially melt at or above the transition temperature to increase an electrical resistance between the electrode busbar and the electrode current collectors.

### CROSS REFERENCE TO RELATED APPLICATIONS

The present application claims benefit of U.S. Provisional Patent Application Ser. No. 63/378,493, filed on Oct. 5, 2022, which is incorporated by reference herein in its entirety.

### FIELD

The field of the disclosure relates generally to energy storage technology, such as battery technology. More specifically, the field of the disclosure relates to electrode assemblies including current limiters and secondary batteries having such electrode assemblies.

### BACKGROUND

Secondary batteries, such as lithium based secondary batteries, have become desirable energy sources due to their comparatively high energy density, power and shelf life. Examples of lithium secondary batteries include non-aqueous batteries such as lithium-ion and lithium-polymer batteries.

Known energy storage devices, such as batteries, fuel cells and electrochemical capacitors, typically have two-dimensional laminar architectures, such as planar or spirally wound (i.e., jellyroll) laminate structures, where a surface area of each laminate is approximately equal to its geometric footprint (ignoring porosity and surface roughness).

FIG. 1 illustrates a cross-sectional view of a known laminar type secondary battery, indicated generally at 10. The battery 10 includes a positive electrode current collector 15 in contact with a positive electrode 20. A negative electrode 25 is separated from the positive electrode 20 by a separator 30. The negative electrode 25 is in contact with a negative electrode current collector 35. As shown in FIG. 1, the battery 10 is formed in a stack. The stack is sometimes covered with another separator layer (not shown) above the negative electrode current collector 35, and then rolled and placed into a can (not shown) to assemble the battery 10. During a charging process, a carrier ion (typically, lithium) leaves the positive electrode 20 and travels through separator 30 into the negative electrode 25. Depending upon the anode material used, the carrier ion either intercalates (e.g., sits in a matrix of negative electrode material without forming an alloy) or forms an alloy with the negative electrode material. During a discharge process, the carrier ion leaves the negative electrode 25 and travels back through the separator 30 and back into the positive electrode 20.

Three-dimensional secondary batteries may provide increased capacity and longevity compared to laminar secondary batteries. Three-dimensional battery architectures (e.g., interdigitated electrode arrays) have been proposed in the literature to provide higher electrode surface area, higher energy and power density, improved battery capacity, and improved active material utilization compared with two-dimensional architectures (e.g., flat and spiral laminates). For example, reference to Long et al., “Three-dimensional battery architectures,” Chemical Reviews, 2004, 104, 4463-4492, may help to illustrate the state of the art in proposed three-dimensional battery architectures, and is therefore incorporated by reference as non-essential subject matter herein.

There is a risk that energy storage devices, including secondary batteries, might release energy in an undesirable or uncontrolled manner though accident, abuse, exposure to extreme conditions, or the like. Building safety features into secondary batteries can reduce this risk and improve abuse tolerance.

The safety of current lithium-based batteries may be compromised by various mechanisms, many of which are related through a temperature increase phenomenon. Excessive heat and thermal runaway may occur due to electrolyte decomposition at overcharge and at elevated operating temperatures. Thermal runaway might also occur due to oxygen evolution in case of high voltage cathode materials such as LiCoO2. In some cases, mechanical abuse can also cause active materials to short together, thereby resulting in thermal runaway. This could be caused due to overcharging the batteries, electrical shorts, or mechanical abuse related shorting. A rapid release of heat during chemical reactions pertaining to electrolyte or cathode decomposition can increase the risk of thermal runaway in conventional two-dimensional batteries.

Self-stopping devices, for example polymer or ceramic materials with a Positive Temperature Coefficient (PTC) of resistance, have been used to enhance the safety of conventional two-dimensional batteries. Such materials are sometimes referred to as resettable fuses or self-regulating thermostats. Other systems have been proposed that include non-resettable or sacrificial fuses that melt to mechanically create an open circuit that interrupts the flow of excess current through a battery. For example, reference to P. G. Balakrishnan, R. Ramesh, and T. Prem Kumar, “Safety mechanisms in lithium-ion batteries,” Journal of Power Sources, 2006, 155, 401-414 may help to illustrate the state of the art in safety mechanisms in conventional lithium-ion batteries and is therefore incorporated by reference as non-essential subject matter herein.

In at least some known lithium based secondary batteries, the resettable or non-resettable fuses have a measurable lag between the flow of excess current and the tripping of the fuse. This lag occurs because the fuses are typically activated by the heat generated when excess current flows through the battery. Thus, excess current will flow through the battery for some time until the temperature experienced by the fuse reaches the temperature required to melt the fuse, in the case of a non-resettable fuse, or increase the resistance enough to limit the current flowing through the battery, in the case of a resettable fuse using a PTC material. In some circumstances, the lag between the onset of excess current and tripping of the fuse may result in the failure of the fuse to prevent thermal runaway.

Thus, it would be desirable to produce three-dimensional batteries that include current limiters to limit the current that may flow through the battery independent of the temperature of the battery to address the issues in the known art. Further, it would be desirable to produce three-dimensional batteries where the current limiters and the structures attached thereto operate in cases of abuse (e.g., nail punctures) to prevent thermal runaways.

### BRIEF DESCRIPTION

In one aspect, an electrode assembly for cycling between a charged state and a discharged state is provided. The electrode assembly includes a population of unit cells stacked atop each other in a stacking direction, each member of the population of unit cells including an electrode structure, a separator structure, and a counter-electrode structure. The electrode structure includes an electrode current collector and an electrode active material layer, the electrode structure extends in a longitudinal direction perpendicular to the stacking direction, an end portion of the electrode current collector extends past an outer surface of the electrode active material layer and the separator structure in the longitudinal direction, the counter-electrode structure comprises a counter-electrode current collector and a counter-electrode active material layer, the counter-electrode structure extends in a longitudinal direction perpendicular to the stacking direction. The electrode assembly further includes an adhesive layer including a resistive polymeric material, and an electrode busbar extending in the stacking direction and having a first surface and a second surface opposite the first surface, the first surface positioned adjacent to the end portions of the electrode current collectors, the first surface being attached to the end portions of the electrode current collectors through the adhesive layer. The adhesive layer is configured to adhere with the electrode busbar and the electrode current collectors below a transition temperature, and the adhesive layer is configured to at least partially melt at or above the transition temperature to increase an electrical resistance between the electrode busbar and the electrode current collectors.

In another aspect, an electrode assembly for cycling between a charged state and a discharged state is provided. The electrode assembly includes a population of unit cells stacked atop each other in a stacking direction, each member of the population of unit cells including an electrode structure, a separator structure, and a counter-electrode structure. The electrode structure includes an electrode current collector and an electrode active material layer, the electrode structure extends in a longitudinal direction perpendicular to the stacking direction, an end portion of the electrode current collector extends past an outer surface of the electrode active material layer and the separator structure in the longitudinal direction, the counter-electrode structure comprises a counter-electrode current collector and a counter-electrode active material layer, the counter-electrode structure extends in a longitudinal direction perpendicular to the stacking direction. The electrode assembly further includes an adhesive layer including a resistive polymeric material, and an electrode busbar extending in the stacking direction and having a first surface and a second surface opposite the first surface, the first surface positioned adjacent to the end portions of the electrode current collectors, the first surface being attached to the end portions of the electrode current collectors through the adhesive layer. The resistive polymeric material includes at least one phase change element that is configured to expand a volume of the adhesive layer at or above a transition temperature, the adhesive layer has a first volume below the transition temperature; and the adhesive layer is configured to expand from the first volume towards a second volume at or above the transition temperature to increase an electrical resistance between the electrode busbar and the electrode current collectors.

In another aspect, an electrode assembly for cycling between a charged state and a discharged state is provided. The electrode assembly includes a population of unit cells stacked atop each other in a stacking direction, each member of the population of unit cells including an electrode structure, a separator structure, and a counter-electrode structure. The electrode structure includes an electrode current collector and an electrode active material layer, the electrode structure extends in a longitudinal direction perpendicular to the stacking direction, an end portion of the electrode current collector extends past an outer surface of the electrode active material layer and the separator structure in the longitudinal direction, the counter-electrode structure comprises a counter-electrode current collector and a counter-electrode active material layer, the counter-electrode structure extends in a longitudinal direction perpendicular to the stacking direction. The electrode assembly further includes an adhesive layer including a resistive polymeric material, and an electrode busbar extending in the stacking direction and having a first surface and a second surface opposite the first surface, the first surface positioned adjacent to the end portions of the electrode current collectors, the first surface being attached to the end portions of the electrode current collectors through the adhesive layer. The electrode busbar and the electrode current collectors are configured to adhere to the adhesive layer below a transition temperature, and at least one of the electrode busbar and the electrode current collectors are configured to at least partially detach from the adhesive layer at or above the transition temperature.

In another aspect, an electrode assembly for cycling between a charged state and a discharged state is provided. The electrode assembly includes a population of unit cells stacked atop each other in a stacking direction, each member of the population of unit cells including an electrode structure, a separator structure, and a counter-electrode structure. The electrode structure includes an electrode current collector and an electrode active material layer, the electrode structure extends in a longitudinal direction perpendicular to the stacking direction, an end portion of the electrode current collector extends past an outer surface of the electrode active material layer and the separator structure in the longitudinal direction, the counter-electrode structure comprises a counter-electrode current collector and a counter-electrode active material layer, the counter-electrode structure extends in a longitudinal direction perpendicular to the stacking direction. The electrode assembly further includes an adhesive layer including a resistive polymeric material, and an electrode busbar extending in the stacking direction and having a first surface and a second surface opposite the first surface, the first surface positioned adjacent to the end portions of the electrode current collectors, the first surface being attached to the end portions of the electrode current collectors through the adhesive layer. The first surface of the electrode busbar and the outer surface of the electrode active material layer are separated by a separation distance, and the separation distance between the first surface of the electrode busbar and the outer surface of the electrode active material layer changes in response to at least one of an electrical short and a current through the adhesive layer.

Various refinements exist of the features noted in relation to the above-mentioned aspects. Further features may also be incorporated in the above-mentioned aspects. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 is a cross-section of an existing laminar battery.

FIG. 2 is a simplified diagram of an example electrode assembly for cycling between a charged state and a discharged state in a secondary battery.

FIG. 3A is a simplified diagram of an end of a counter-electrode current collector of the electrode assembly of FIG. 2.

FIG. 3B is a diagram of the end of a counter-electrode current collector in FIG. 3A connected to a counter-electrode busbar.

FIG. 4A is a top view of a pair of electrode structures of the electrode assembly of FIG. 2 with their current collectors attached to a busbar through current limiters.

FIG. 4B is a side view one of the electrode structures of FIG. 4A with its current collector attached to the busbar through a current limiter.

FIG. 5 is a simplified diagram of another example electrode assembly for cycling between a charged state and a discharged state in a secondary battery.

FIG. 6 is a simplified diagram of yet another example electrode assembly for cycling between a charged state and a discharged state in a secondary battery.

FIG. 7 is a simplified diagram of still another example electrode assembly for cycling between a charged state and a discharged state in a secondary battery.

FIG. 8A is a simplified isometric view of an anodic electrode structure for use in an electrode assembly.

FIG. 8B is a simplified isometric view of a cathodic electrode structure for use in an electrode assembly.

FIG. 9 is an isometric view of an example stacked cell created as part of the manufacture of a secondary battery.

FIG. 10 is a portion of a top view of the stacked cell shown in FIG. 9.

FIG. 11A is an isometric view of the stacked cell shown in FIG. 9 positioned at a packaging station.

FIG. 11B is an isometric view of the stacked cell shown in FIG. 11A with a battery package placed thereon.

FIG. 12 is a simplified diagram of a unit cell of an electrode assembly being tested in a forced internal short circuit test.

FIG. 13 is a simplified diagram of a portion of another example electrode assembly for cycling between a charged state and a discharged state in a secondary battery.

FIG. 14 is a side view an electrode structure with its current collector attached to a busbar through a current limiter and an interface layer applied to the busbar.

FIG. 15 is a side view an electrode structure with its current collector attached to a busbar through a current limiter and an interface layer applied to applied to electrode current collector.

FIG. 16 is a side view an electrode structure with its current collector attached to a busbar through a current limiter, an interface layer applied to the current electrode current collector, and an interface layer applied to the busbar.

FIG. 17 is a side view of a counter-electrode current collector connected to a counter-electrode busbar without the use of a slot in the current collector.

FIG. 18 is a side view of one of an electrode structure with its current collector attached to the busbar through a current limiter formed as a unitary layer without the use of a slot in the current collector.

FIG. 19 is a side view of one of an electrode structure with its current collector attached to the busbar through a discrete current limiter formed as a unitary layer without the use of a slot in the current collector.

FIG. 20 is an isometric view of another example stacked cell created as part of the manufacture of a secondary battery.

FIG. 21 is a side view of another electrode structure with its current collector attached to the busbar through a current limiter formed as a unitary layer without the use of a slot in the current collector.

FIG. 22 is a side view of another electrode structure with its current collector attached to the busbar through a discrete current limiter formed as a unitary layer without the use of a slot in the current collector.

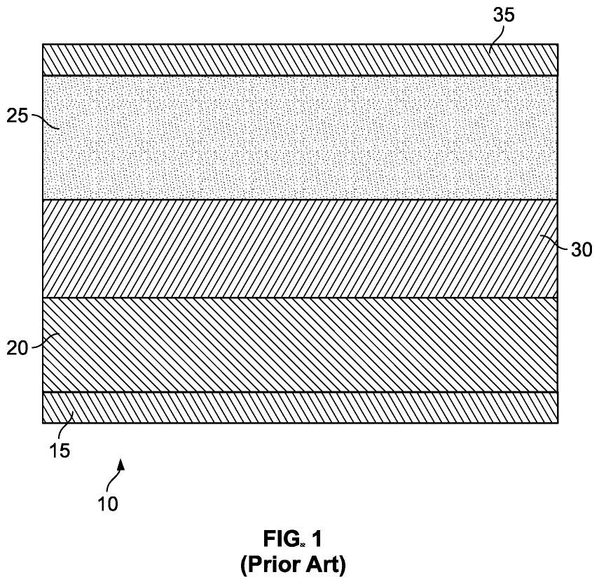

Corresponding reference characters indicate corresponding parts throughout the drawings.

### Definitions

“A,” “an,” and “the” (i.e., singular forms) as used herein refer to plural referents unless the context clearly dictates otherwise. For example, in one instance, reference to “an electrode” includes both a single electrode and a plurality of similar electrodes.

“About” and “approximately” as used herein refers to plus or minus 10%, 5%, or 1% of the value stated. For example, in one instance, about 250 μm would include 225 μm to 275 μm. By way of further example, in one instance, about 1,000 μm would include 900 μm to 1,100 μm. Unless otherwise indicated, all numbers expressing quantities (e.g., measurements, and the like) and so forth used in the specification and claims are to be understood as being modified in all instances by the term “about.” Accordingly, unless indicated to the contrary, the numerical parameters set forth in the following specification and attached claims are approximations. Each numerical parameter should at least be construed in light of the number of reported significant digits and by applying ordinary rounding techniques.

“Anode” as used herein in the context of a secondary battery refers to the negative electrode in the secondary battery.

“Anode material” or “Anodically active” as used herein means material suitable for use as the negative electrode of a secondary battery

“Cathode” as used herein in the context of a secondary battery refers to the positive electrode in the secondary battery

“Cathode material” or “Cathodically active” as used herein means material suitable for use as the positive electrode of a secondary battery.

“Conversion chemistry active material” or “Conversion chemistry material” refers to a material that undergoes a chemical reaction during the charging and discharging cycles of a secondary battery.

“Counter-electrode” as used herein may refer to the negative or positive electrode (anode or cathode), opposite of the Electrode, of a secondary battery unless the context clearly indicates otherwise.

“Counter-electrode current collector” as used herein may refer to the negative or positive (anode or cathode) current collector, opposite of the Electrode current connector, of a secondary battery unless the context clearly indicates otherwise.

“Cycle” as used herein in the context of cycling of a secondary battery between charged and discharged states refers to charging and/or discharging a battery to move the battery in a cycle from a first state that is either a charged or discharged state, to a second state that is the opposite of the first state (i.e., a charged state if the first state was discharged, or a discharged state if the first state was charged), and then moving the battery back to the first state to complete the cycle. For example, a single cycle of the secondary battery between charged and discharged states can include, as in a charge cycle, charging the battery from a discharged state to a charged state, and then discharging back to the discharged state, to complete the cycle. The single cycle can also include, as in a discharge cycle, discharging the battery from the charged state to the discharged state, and then charging back to a charged state, to complete the cycle.

“Electrochemically active material” as used herein means anodically active or cathodically active material.

“Electrode” as used herein may refer to the negative or positive electrode (anode or cathode) of a secondary battery unless the context clearly indicates otherwise.

“Electrode current collector” as used herein may refer to the negative or positive (anode or cathode) current collector of a secondary battery unless the context clearly indicates otherwise.

“Electrode material” as used herein may refer to anode material or cathode material unless the context clearly indicates otherwise.

“Electrode structure” as used herein may refer to an anode structure (e.g., negative electrode structure) or a cathode structure (e.g., positive electrode structure) adapted for use in a battery unless the context clearly indicates otherwise.

“Longitudinal axis,” “transverse axis,” and “vertical axis,” as used herein refer to mutually perpendicular axes (i.e., each are orthogonal to one another) that define a length L, a width W, and a height H, respectively. For example, the “longitudinal axis,” “transverse axis,” and the “vertical axis” as used herein are akin to a Cartesian coordinate system used to define three-dimensional aspects or orientations. As such, the descriptions of elements of the disclosed subject matter herein are not limited to the particular axis or axes used to describe three-dimensional orientations of the elements. Alternatively stated, the axes may be interchangeable when referring to three-dimensional aspects of the disclosed subject matter.

### DETAILED DESCRIPTION

Embodiments of the present disclosure relate to batteries, such as three-dimensional secondary batteries, and electrode assemblies for such batteries that include current limiters to limit the current that may flow through the battery to thereby limit thermal increases, help prevent thermal runaway, and improve the safety of the battery.

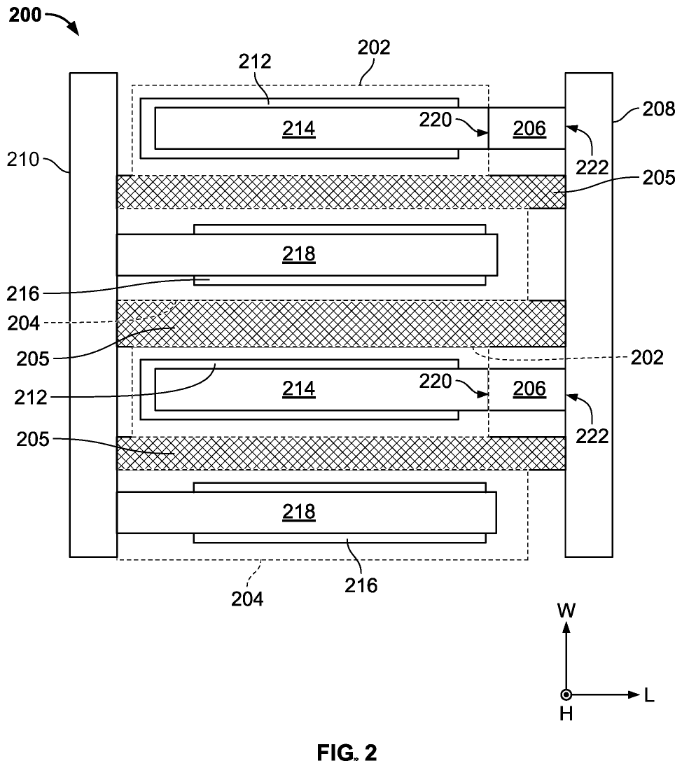

FIG. 2 is a simplified diagram of an example electrode assembly 200 for cycling between a charged state and a discharged state in a battery. The electrode assembly 200 includes a population of electrode structures 202, a population of counter-electrode structures 204, a population of separator structures 205, a population of current limiters 206, an electrode busbar 208, and a counter-electrode busbar 210. The example embodiment is an electrode assembly suitable for use in a three-dimensional secondary battery, in which the electrode structures 202 and counter-electrode structures 204 each extend primarily along a length (or longitudinal) direction L and a height direction H of the assembly and are separated from each other along a width direction W. In other embodiments, the electrode assembly 200 may be for use in a laminar secondary battery.

A voltage difference V exists between adjacent electrode structures 202 and counter-electrode structures 204, which adjacent pairs may be considered a unit cell. Each unit cell has a capacity C determined by the makeup and configuration of the electrode structures 202 and counter-electrode structures 204. In the example embodiment, each unit cell produces a voltage difference of about 4.35 volts. In other embodiments, each unit cell has a voltage difference of about 0.5 volts, about 1.0 volts, about 1.5 volts, about 2.0 volts, about 2.5 volts, about 3.0 volts, about 3.5 volts, about 4.0 volts, 4.5 volts, about 5.0 volts, between 4 and 5 volts, or any other suitable voltage. During cycling between charged and discharged, the voltage may vary, for example, between about 2.5 volts and about 4.35 volts. The capacity C of a unit cell in the example embodiment is about 25 mAh. In other embodiments, the capacity C of a unit cell is about 50 mAh, less than 50 mAh, or any other suitable capacity. In some embodiments, the capacity C of a unit cell may be up to about 500 mAh.

In the example embodiment, the electrode structures 202 and counter-electrode structures 204 are generally rectangular and arranged in an interdigitated structure. That is, the electrode structures 202 and counter-electrode structures 204 extend from opposite electrode and counter-electrode busbars 208, 210 and alternate along the length direction L. In other embodiments, other shapes and arrangements of the electrode structures 202 and counter-electrode structures 204 are used. For example, the electrode assembly 200 (and the battery within which it is included) may have any of the shapes and/or arrangements described or shown in U.S. Pat. No. 9,166,230, which is hereby incorporated by reference in its entirety.

Each member of the population of electrode structures 202 includes an electrode active material 212 and an electrode current collector 214. The electrode structures 202 are electrically connected in parallel to the electrode busbar 208 through a current limiter 206. The electrode structures 202 may be anodic or cathodic, but all of the electrode structures 202 in the population are of the same type (anodic or cathodic) in the example embodiment. In some other embodiments, the electrode structures 202 may include anodic and cathodic structures. Each member of the population of counter-electrode structures 204 includes a counter-electrode active material 216 and a counter-electrode current collector 218. The counter-electrode structures 204 are electrically connected in parallel to the counter-electrode busbar 210. The counter-electrode structures 204 are all of the same type (anodic or cathodic) in the example embodiment and are of the opposite type to the electrode structures 202. In some other embodiments, the counter-electrode structures 204 may include anodic and cathodic structures. Although only two electrode structures 202 and two counter-electrode structures 204 are shown in FIG. 2, the electrode assembly 200 may have any number of electrode structures 202 and counter-electrode structures 204. The populations of electrode structures 202 and counter-electrode structures 204 will generally include the same number of members but may include different numbers of electrode structures 202 and counter-electrode structures 204 in some embodiments. For example, some embodiments may begin and end with the same electrode structure 202 or counter-electrode structure 204, resulting in one more electrode structure 202 or counter-electrode structure 204. In some embodiments, the populations of electrode structures 202 and counter-electrode structures 204 include at least twenty members each. Some embodiments include populations of electrode structures 202 and counter-electrode structures 204 having about 10 members each, between 10 and 25 members each, between 25 and 250 members each, between 25 and 150 members each, between 50 and 150 members each, or up to 500 members each. In some embodiments, the electrode structures 202 or the counter electrode structures 204 do not include an active material when discharged, and only the other of the counter electrode structures 204 or the electrode structures 202 includes an active material when discharged.

The cathodic type of the electrode structure 202 or the counter-electrode structure 204 includes a current collector 214 or 218 that is a cathode current collector. The cathode current collector may comprise aluminum, nickel, cobalt, titanium, and tungsten, or alloys thereof, or any other material suitable for use as a cathode current collector layer. In general, the cathode current collector will have an electrical conductivity of at least about 10³ Siemens/cm. For example, in one such embodiment, the cathode current collector will have a conductivity of at least about 10⁴ Siemens/cm. By way of further example, in one such embodiment, the cathode current collector will have a conductivity of at least about 10⁵ Siemens/cm. The anodic type of the electrode structure 202 or the counter-electrode structure 204 includes a current collector 214 or 218 that is an anode current collector. The anode current collector may comprise a conductive material such as copper, carbon, nickel, stainless steel, cobalt, titanium, and tungsten, and alloys thereof, or any other material suitable as an anode current collector layer.

The cathodic type of the electrode structure 202 or the counter-electrode structure 204 includes an active material 212 or 216 that is a cathodically active material. The cathodically active material may be an intercalation-type chemistry active material, a conversion chemistry active material, or a combination thereof.

Exemplary conversion chemistry materials useful in the present disclosure include, but are not limited to, S (or Li₂S in the lithiated state), LiF, Fe, Cu, Ni, FeF₂, FeO_{d}F_{3.2d}, FeF₃, CoF₃, CoF₂, CuF₂, NiF₂, where 0≤d≤0.5, and the like.

Exemplary cathodically active materials include any of a wide range of cathode active materials. For example, for a lithium-ion battery, the cathodically active material may comprise a cathode material selected from transition metal oxides, transition metal sulfides, transition metal nitrides, lithium-transition metal oxides, lithium-transition metal sulfides, and lithium-transition metal nitrides may be selectively used. The transition metal elements of these transition metal oxides, transition metal sulfides, and transition metal nitrides can include metal elements having a d-shell or f-shell. Specific examples of such metal element are Sc, Y, lanthanoids, actinoids, Ti, Zr, Hf, V, Nb, Ta, Cr, Mo, W, Mn, Tc, Re, Fe, Ru, Os, Co, Rh, Ir, Ni, Pb, Pt, Cu, Ag, and Au. Additional cathode active materials include LiCoO2, LiNi0.5Mn1.5O4, Li(NixCoyAlz)O2, LiFePO4, Li2MnO4, V2O5, molybdenum oxysulfides, phosphates, silicates, vanadates, sulfur, sulfur compounds, oxygen (air), Li(NixMnyCoz)O2, and combinations thereof. Furthermore, compounds for the cathodically active material layers can comprise lithium-containing compounds further comprising metal oxides or metal phosphates such as compounds comprising lithium, cobalt and oxygen (e.g., LiCoO2), compounds comprising lithium, manganese and oxygen (e.g., LiMn2O4) and compound comprising lithium iron and phosphate (e.g., LiFePO¬). In one embodiment, the cathodically active material comprises at least one of lithium manganese oxide, lithium cobalt oxide, lithium nickel oxide, lithium iron phosphate, or a complex oxide formed from a combination of aforesaid oxides. In another embodiment, the cathodically active material can comprise one or more of lithium cobalt oxide (LiCoO2), lithium nickel oxide (LiNiO2), etc. or a substituted compound with one or more transition metals; lithium manganese oxide such as Li1+xMn2−xO4 (where, x is 0 to 0.33), LiMnO3, LiMn2O3, LiMnO2, etc.; lithium copper oxide (Li2CuO2); vanadium oxide such as LiV3O8, LiFe3O4, V2O5, Cu2V2O7 etc.; Ni site-type lithium nickel oxide represented by the chemical formula of LiNi1−xMx02 (where, M=Co, Mn, Al, Cu, Fe, Mg, B or Ga, and x=0.01 to 0.3); lithium manganese complex oxide represented by the chemical formula of LiMn2−xMxO2 (where, M=Co, Ni, Fe, Cr, Zn or Ta, and x=0.01 to 0.1) or Li2Mn3MO8 (where, M=Fe, Co, Ni, Cu or Zn); LiMn2O4 in which a portion of Li is substituted with alkaline earth metal ions; a disulfide compound; Fe2(MoO4)3, and the like. In one embodiment, the cathodically active material can comprise a lithium metal phosphate having an olivine crystal structure of Formula

Li1+aFe1-xM′x(PO4−b)Xb wherein M′ is at least one selected from Al, Mg, Ni, Co, Mn, Ti, Ga, Cu, V, Nb, Zr, Ce, In, Zn, and Y, X is at least one selected from F, S, and N, −0.5≤a≤+0.5, 0≤x≤0.5, and 0≤b≤0.1, such at least one of LiFePO4, Li(Fe, Mn)PO4, Li(Fe, Co)PO4, Li(Fe, Ni)PO4, or the like. In one embodiment, the cathodically active material comprises at least one of LiCoO2, LiNiO2, LiMnO2, LiMn2O4, LiNi1−yCoyO2, LiCo1−yMnyO2, LiNi1−yMnyO2(0≤y≤1), Li(NiaCobMnc)O4(0<a<2, 0<b<2, 0<c<2, and a+b+c=2), LiMn2−zNizO4, LiMn2−zCozO4 (0<z<2), LiCoPO4 and LiFePO4, or a mixture of two or more thereof.

In yet another embodiment, a cathodically active material can comprise elemental sulfur (S8), sulfur series compounds or mixtures thereof. The sulfur series compound may specifically be Li2Sn (n≥1), an organosulfur compound, a carbon-sulfur polymer ((C2Sx)n: x=2.5 to 50, n≥2) or the like. In yet another embodiment, the cathodically active material can comprise an oxide of lithium and zirconium.

In yet another embodiment, the cathodically active material can comprise at least one composite oxide of lithium and metal, such as cobalt, manganese, nickel, or a combination thereof, may be used, and examples thereof are LiaA1−bMbD2 (wherein, 0.90≤a≤1, and 0≤b≤0.5); LiaE1−bMbO2−cDc (wherein, 0.90≤a≤1, 0≤b≤0.5, and 0≤c≤0.05); LiE2−bMbO4−cDc (wherein, 0≤b≤0.5, and 0≤c≤0.05); LiaNi1−b−cCobMcDa (wherein, 0.90≤a≤1, 0≤b≤0.5, 0≤c≤0.05, and 0<a≤2); LiaNi1−b−cCobMcO2−aXa (wherein, 0.90≤a≤1, 0≤b≤0.5, 0≤c≤0.05, and 0<a<2); LiaNi1−b−cCobMcO2−aX2 (wherein, 0.90≤a≤1, 0≤b≤0.5, 0≤c≤0.05, and 0<a<2); LiaNi1−b−cMnbMcDa (wherein, 0.90≤a≤1, 0≤b≤0.5, 0≤c≤0.05, and 0<a≤2); LiaNi1−b−cMnbMcO2−aXa (wherein, 0.90≤a≤1, 0≤b≤0.5, 0≤c≤0.05, and 0<a<2); LiaNi1−b−cMnbMcO2−aX2 (wherein, 0.90≤a≤1, 0≤b≤0.5, 0≤c≤0.05, and 0<a<2); LiaNibEcGdO2 (wherein, 0.90≤a≤1, 0≤b≤0.9, 0≤c≤0.5, and 0.001≤d≤0.1); LiaNibCocMndGeO2 (wherein, 0.90≤a≤1, 0≤b≤0.9, 0≤c≤0.5, 0≤d≤0.5, and 0.001≤e≤0.1); LiaNiGbO2 (wherein, 0.90≤a≤1 and 0.001≤b≤0.1); LiaCoGbO2 (wherein, 0.90≤a≤1 and 0.0014≤b≤0.1); LiaMnGbO2 (wherein, 0.90≤a≤1 and 0.001≤b≤50.1); LiaMn2GbO4 (wherein, 0.90≤a≤1 and 0.0014≤b≤0.1); QO2; QS2; LiQS2; V2O5; LiV2O5; LiX′O2; LiNiVO4; Li(3−f)J2(PO4)3 (0≤f≤2); Li(3−f)Fe2(PO4)3 (0≤f≤2); and LiFePO4. In the formulas above, A is Ni, Co, Mn, or a combination thereof, M is Al, Ni, Co, Mn, Cr, Fe, Mg, Sr, V, a rare-earth element, or a combination thereof, D is O, F, S, P, or a combination thereof, E is Co, Mn, or a combination thereof, X is F, S, P, or a combination thereof, G is Al, Cr, Mn, Fe, Mg, La, Ce, Sr, V, or a combination thereof, Q is Ti, Mo, Mn, or a combination thereof, X is Cr, V, Fe, Sc, Y, or a combination thereof, and J is V, Cr, Mn, Co, Ni, Cu, or a combination thereof. For example, LiCoO2, LiMnxO2x (x=1 or 2), LiNi1−xMnxO2x (0<x<1), LiNi1−x−yCoxMnyO2 (0≤x≤0.5, 0≤y≤0.5), or FePO4 may be used. In one embodiment, the cathodically active material comprises at least one of a lithium compound such as lithium cobalt oxide, lithium nickel oxide, lithium nickel cobalt oxide, lithium nickel cobalt aluminum oxide, lithium nickel cobalt manganese oxide, lithium manganese oxide, or lithium iron phosphate; nickel sulfide; copper sulfide; sulfur; iron oxide; or vanadium oxide.

In one embodiment, the cathodically active material can comprise a sodium containing material, such as at least one of an oxide of the formula NaM1aO2 such as NaFeO2, NaMnO2, NaNiO2, or NaCoO2; or an oxide represented by the formula NaMn1−aM1aO2, wherein M1 is at least one transition metal element, and 0≤a<1. Representative positive active materials include Na[Ni1/2Mn1/2]O2, Na2/3 [Fe1/2Mn1/2]O2, and the like; an oxide represented by Na0.44Mn1−aM1aO2, an oxide represented by Na0.7Mn1−aM1a O2.05 an (wherein M1 is at least one transition metal element, and 0≤a<1); an oxide represented by NabM2cSi12O30 as Na6Fe2Si12O30 or Na2Fe5Si12O (wherein M2 is at least one transition metal element, 2≤b≤6, and 2≤c≤5); an oxide represented by NadM3eSi6O18 such as Na2Fe2Si6O18 or Na2MnFeSi6O18 (wherein M3 is at least one transition metal element, 3≤d≤6, and 1≤e≤2); an oxide represented by NafM4gSi2O6 such as Na2FeSiO6 (wherein M4 is at least one element selected from transition metal elements, magnesium (Mg) and aluminum (Al), 1≤f≤2 and 1≤g≤2); a phosphate such as NaFePO4, Na3Fe2(PO4)3, Na3V2(PO4)3, Na4Co3(PO4)2P2O7 and the like; a borate such as NaFeBO4 or Na3Fe2(BO4)3; a fluoride represented by NahM5F6 such as Na3FeF6 or Na2MnF6 (wherein M5 is at least one transition metal element, and 2≤h≤3), a fluorophosphate such as Na3V2(PO4)2F3, Na3V2(PO4)2FO2 and the like. The positive active material is not limited to the foregoing and any suitable positive active material that is used in the art can be used. In an embodiment, the positive active material preferably comprises a layered-type oxide cathode material such as NaMnO2, Na[Ni1/2Mn1/2]O2 and Na2/3[Fe1/2Mns1/2]02, a phosphate cathode such as Na3V2(PO4)3 and Na4Co3(PO4)2P2O7, or a fluorophosphate cathode such as Na3V2(PO4)2F3 and Na3V2(PO4)2FO2.

In yet another embodiment, the cathodically active material can further comprise one or more of a conductive aid and/or binder, which for example may be any of the conductive aids and/or binders described for the anodically active material herein.

In general, the cathodically active material will have a thickness of at least about 20 um in whichever of the electrode structure 202 or the counter-electrode structure 204 is the cathodic type structure. For example, in one embodiment, the cathodically active material will have a thickness of at least about 40 um. By way of further example, in one such embodiment, the cathodically active material will have a thickness of at least about 60 um. By way of further example, in one such embodiment, the cathodically active material will have a thickness of at least about 100 um. Typically, however, the cathodically active material will have a thickness of less than about 90 um or even less than about 70 um.

The anodic type of the electrode structure 202 or the counter-electrode structure 204 includes an active material 212 or 216 that is an anodically active material. In general, the anodically active material may be selected from the group consisting of: (a) silicon (Si), germanium (Ge), tin (Sn), lead (Pb), antimony (Sb), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium-containing titanium oxide, lithium transition metal oxide, ZnCo2O4; (f) particles of graphite and carbon; (g) lithium metal, and (h) combinations thereof.

Exemplary anodically active electroactive materials include carbon materials such as graphite and soft or hard carbons, or any of a range of metals, semi-metals, alloys, oxides and compounds capable of forming an alloy with lithium. Specific examples of the metals or semi-metals capable of constituting the anode material include graphite, tin, lead, magnesium, aluminum, boron, gallium, silicon, Si/C composites, Si/graphite blends, SiOx, porous Si, intermetallic Si alloys, indium, zirconium, germanium, bismuth, cadmium, antimony, silver, zinc, arsenic, hafnium, yttrium, lithium, sodium, graphite, carbon, lithium titanate, palladium, and mixtures thereof. In one exemplary embodiment, the anodically active material comprises aluminum, tin, or silicon, or an oxide thereof, a nitride thereof, a fluoride thereof, or other alloy thereof. In another exemplary embodiment, the anodically active material comprises silicon, silicon oxide, or an alloy thereof.

In yet further embodiment, the anodically active material can comprise lithium metals, lithium alloys, carbon, petroleum cokes, activated carbon, graphite, silicon compounds, tin compounds, and alloys thereof. In one embodiment, the anodically active material comprises carbon such as non-graphitizable carbon, graphite-based carbon, etc.; a metal complex oxide such as LixFe2O3 (0≤x≤1), LixWO2 (0≤x≤1), SnxMe1−xMe′yOz (Me: Mn, Fe, Pb, Ge; Me′: Al, B, P, Si, elements found in Group 1, Group 2 and Group 3 in a periodic table, halogen; 0<x≤1; 1≤y≤3; 1≤z≤8), etc.; a lithium metal; a lithium alloy; a silicon-based alloy; a tin-based alloy; a metal oxide such as SnO, SnO2, PbO, PbO2, Pb2O3, Pb3O4, Sb2O3, Sb2O4, Sb2O5, GeO, GeO2, Bi2O3, Bi2O4, Bi2O5, etc.; a conductive polymer such as polyacetylene, etc.; Li—Co—Ni-based material, etc. In one embodiment, the anodically active material can comprise carbon-based active material include crystalline graphite such as natural graphite, synthetic graphite and the like, and amorphous carbon such as soft carbon, hard carbon and the like. Other examples of carbon material suitable for anodically active material can comprise graphite, Kish graphite, pyrolytic carbon, mesophase pitch-based carbon fibers, meso-carbon microbeads, mesophase pitches, graphitized carbon fiber, and high-temperature sintered carbon such as petroleum or coal tar pitch derived cokes. In one embodiment, the negative electrode active material may comprise tin oxide, titanium nitrate and silicon. In another embodiment, the negative electrode can comprise lithium metal, such as a lithium metal film, or lithium alloy, such as an alloy of lithium and one or more types of metals selected from the group consisting of Na, K, Rb, Cs, Fr, Be, Mg, Ca, Sr, Ba, Ra, Al and Sn. In yet another embodiment, the anodically active material can comprise a metal compound capable of alloying and/or intercalating with lithium, such as Si, Al, C, Pt, Sn, Pb, Ir, Ni, Cu, Ti, Na, K, Rb, Cs, Fr, Be, Ca, Sr, Sb, Ba, Ra, Ge, Zn, Bi, In, Mg, Ga, Cd, a Si alloy, a Sn alloy, an Al alloy or the like; a metal oxide capable of doping and dedoping lithium ions such as SiOv (0<v<2), SnO2, vanadium oxide or lithium vanadium oxide; and a composite including the metal compound and the carbon material such as a Si—C composite or a Sn—C composite. For example, in one embodiment, the material capable of alloying/intercalating with lithium may be a metal, such as lithium, indium, tin, aluminum, or silicon, or an alloy thereof; a transition metal oxide, such as Li4/3Ti5/3O4 or SnO; and a carbonaceous material, such as artificial graphite, graphite carbon fiber, resin calcination carbon, thermal decomposition vapor growth carbon, corks, mesocarbon microbeads (“MCMB”), furfuryl alcohol resin calcination carbon, polyacene, pitch-based carbon fiber, vapor growth carbon fiber, or natural graphite. In yet another embodiment, the negative electrode active material can comprise a composition suitable for a carrier ion such as sodium or magnesium. For example, in one embodiment, the negative electrode active material can comprise a layered carbonaceous material; and a composition of the formula NaxSny-zMz disposed between layers of the layered carbonaceous material, wherein M is Ti, K, Ge, P, or a combination thereof, and 0<x≤15, 1≤y≤5, and 0≤z≤1.

In one embodiment, the negative electrode active material may further comprise a conductive material and/or conductive aid, such as carbon-based materials, carbon black, graphite, graphene, active carbon, carbon fiber, carbon black such as acetylene black, Ketjen black, channel black, furnace black, lamp black, thermal black or the like; a conductive fiber such as carbon fiber, metallic fiber or the like; a conductive tube such as carbon nanotubes or the like; metallic powder such as carbon fluoride powder, aluminum powder, nickel powder or the like; a conductive whisker such as zinc oxide, potassium titanate or the like; a conductive metal oxide such as titanium oxide or the like; or a conductive material such as a polyphenylene derivative or the like. In addition, metallic fibers such as metal mesh; metallic powders such as copper, silver, nickel and aluminum; or organic conductive materials such as polyphenylene derivatives may also be used. In yet another embodiment, a binder may be provided, such as for example one or more of polyethylene, polyethylene oxide, polypropylene, polytetrafluoroethylene (PTFE), polyvinylidene fluoride (PVDF), styrene-butadiene rubber, a tetrafluoroethylene-perfluoro alkylvinyl ether copolymer, a vinylidene fluoride-hexafluoropropylene copolymer, a vinylidene fluoride-chlorotrifluoroethylene copolymer, an ethylene-tetrafluoroethylene copolymer, a polychlorotrifluoroethylene, vinylidene fluoride-pentafluoro propylene copolymer, a propylene-tetrafluoroethylene copolymer, an ethylene-chlorotrifluoroethylene copolymer, a vinylidene fluoride-hexafluoropropylene-tetrafluoroethylene copolymer, a vinylidene fluoride-perfluoromethylvinyl ether-tetrafluoro ethylene copolymer, an ethylene-acrylic acid copolymer and the like may be used either alone or as a mixture.

In one embodiment, the anodically active material is microstructured to provide a significant void volume fraction to accommodate volume expansion and contraction as lithium ions (or other carrier ions) are incorporated into or leave the negative electrode active material during charging and discharging processes. In general, the void volume fraction of (each of) the anodically active material layer(s) is at least 0.1. Typically, however, the void volume fraction of (each of) the anodically active material layer(s) is not greater than 0.8. For example, in one embodiment, the void volume fraction of (each of) the anodically active material layer(s) is about 0.15 to about 0.75. By way of the further example, in one embodiment, the void volume fraction of (each of) the anodically active material layer(s) is about 0.2 to about 0.7. By way of the further example, in one embodiment, the void volume fraction of (each of) the anodically active material layer(s) is about 0.25 to about 0.6.

Depending upon the composition of the microstructured anodically active material and the method of its formation, the microstructured anodically active material may comprise macroporous, microporous, or mesoporous material layers or a combination thereof, such as a combination of microporous and mesoporous, or a combination of mesoporous and macroporous. Microporous material is typically characterized by a pore dimension of less than 10 nm, a wall dimension of less than 10 nm, a pore depth of 1-50 micrometers, and a pore morphology that is generally characterized by a “spongy” and irregular appearance, walls that are not smooth, and branched pores. Mesoporous material is typically characterized by a pore dimension of 10-50 nm, a wall dimension of 10-50 nm, a pore depth of 1-100 micrometers, and a pore morphology that is generally characterized by branched pores that are somewhat well defined or dendritic pores. Macroporous material is typically characterized by a pore dimension of greater than 50 nm, a wall dimension of greater than 50 nm, a pore depth of 1-500 micrometers, and a pore morphology that may be varied, straight, branched, or dendritic, and smooth or rough-walled. Additionally, the void volume may comprise open or closed voids, or a combination thereof. In one embodiment, the void volume comprises open voids, that is, the anodically active material contains voids having openings at the lateral surface of the negative electrode active material through which lithium ions (or other carrier ions) can enter or leave the anodically active material; for example, lithium ions may enter the anodically active material through the void openings after leaving the cathodically active material. In another embodiment, the void volume comprises closed voids, that is, the anodically active material contains voids that are enclosed by anodically active material. In general, open voids can provide greater interfacial surface area for the carrier ions whereas closed voids tend to be less susceptible to solid electrolyte interface while each provides room for expansion of the anodically active material upon the entry of carrier ions. In certain embodiments, therefore, it is preferred that the anodically active material comprise a combination of open and closed voids.

In one embodiment, the anodically active material comprises porous aluminum, tin or silicon or an alloy, an oxide, or a nitride thereof. Porous silicon layers may be formed, for example, by anodization, by etching (e.g., by depositing precious metals such as gold, platinum, silver or gold/palladium on the surface of single crystal silicon and etching the surface with a mixture of hydrofluoric acid and hydrogen peroxide), or by other methods known in the art such as patterned chemical etching. Additionally, the porous anodically active material will generally have a porosity fraction of at least about 0.1, but less than 0.8 and have a thickness of about 1 to about 100 micrometers. For example, in one embodiment, the anodically active material comprises porous silicon, has a thickness of about 5 to about 100 micrometers, and has a porosity fraction of about 0.15 to about 0.75. By way of further example, in one embodiment, the anodically active material comprises porous silicon, has a thickness of about 10 to about 80 micrometers, and has a porosity fraction of about 0.15 to about 0.7. By way of further example, in one such embodiment, the anodically active material comprises porous silicon, has a thickness of about 20 to about 50 micrometers, and has a porosity fraction of about 0.25 to about 0.6. By way of further example, in one embodiment, the anodically active material comprises a porous silicon alloy (such as nickel silicide), has a thickness of about 5 to about 100 micrometers, and has a porosity fraction of about 0.15 to about 0.75.

In another embodiment, the anodically active material comprises fibers of aluminum, tin or silicon, or an alloy thereof. Individual fibers may have a diameter (thickness dimension) of about 5 nm to about 10,000 nm and a length generally corresponding to the thickness of the anodically active material. Fibers (nanowires) of silicon may be formed, for example, by chemical vapor deposition or other techniques known in the art such as vapor liquid solid (VLS) growth and solid liquid solid (SLS) growth. Additionally, the anodically active material will generally have a porosity fraction of at least about 0.1, but less than 0.8 and have a thickness of about 1 to about 200 micrometers. For example, in one embodiment, the anodically active material comprises silicon nanowires, has a thickness of about 5 to about 100 micrometers, and has a porosity fraction of about 0.15 to about 0.75. By way of further example, in one embodiment, the anodically active material comprises silicon nanowires, has a thickness of about 10 to about 80 micrometers, and has a porosity fraction of about 0.15 to about 0.7. By way of further example, in one such embodiment, the anodically active material comprises silicon nanowires, has a thickness of about 20 to about 50 micrometers, and has a porosity fraction of about 0.25 to about 0.6. By way of further example, in one embodiment, the anodically active material comprises nanowires of a silicon alloy (such as nickel silicide), has a thickness of about 5 to about 100 micrometers, and has a porosity fraction of about 0.15 to about 0.75.

In yet other embodiments, the anodic negative electrode (i.e., the electrode or the counter-electrode) is coated with a particulate lithium material selected from the group consisting of stabilized lithium metal particles, e.g., lithium carbonate-stabilized lithium metal powder, lithium silicate stabilized lithium metal powder, or other source of stabilized lithium metal powder or ink. The particulate lithium material may be applied on the negative electrode active material layer by spraying, loading or otherwise disposing the lithium particulate material onto the negative electrode active material layer at a loading amount of about 0.05 to 5 mg/cm², e.g., about 0.1 to 4 mg/cm², or even about 0.5 to 3 mg/cm². The average particle size (D₅₀) of the lithium particulate material may be 5 to 200 μm, e.g., about 10 to 100 μm, 20 to 80 μm, or even about 30 to 50 μm. The average particle size (D₅₀) may be defined as a particle size corresponding to 50% in a cumulative volume-based particle size distribution curve. The average particle size (D₅₀) may be measured, for example, using a laser diffraction method.

The anodic type of the electrode structure 202 or the counter-electrode structure 204 includes a current collector 214 or 218 that is an anodic current collector. In general, the anode current collector will have an electrical conductivity of at least about 10³ Siemens/cm. For example, in one such embodiment, the anode current collector will have a conductivity of at least about 10⁴ Siemens/cm. By way of further example, in one such embodiment, the anode current collector will have a conductivity of at least about 10⁵ Siemens/cm. Exemplary electrically conductive materials suitable for use as anode current collectors include metals, such as, copper, nickel, cobalt, titanium, and tungsten, and alloys thereof.

In one embodiment, anodic current collectors, that is whichever of the electrode current collector 214 or the counter-electrode current collector 218 is the anodic type, has an electrical conductance that is substantially greater than the electrical conductance of its associated electrode or counter-electrode active material 212, 216. For example, in one embodiment the ratio of the electrical conductance of anodic current collector to the electrical conductance of the anodic active material is at least 100:1 when there is an applied current to store energy in the device or an applied load to discharge the device. By way of further example, in some embodiments the ratio of the electrical conductance of anodic current collector to the electrical conductance of the anodic active material at least 500:1 when there is an applied current to store energy in the device or an applied load to discharge the device. By way of further example, in some embodiments the ratio of the electrical conductance of anodic current collector to the electrical conductance of the anodic active material is at least 1000:1 when there is an applied current to store energy in the device or an applied load to discharge the device. By way of further example, in some embodiments the ratio of the electrical conductance of anodic current collector to the electrical conductance of the anodic active material layer is at least 5000:1 when there is an applied current to store energy in the device or an applied load to discharge the device. By way of further example, in some embodiments the ratio of the electrical conductance of anodic current collector to the electrical conductance of the anodic active material is at least 10,000:1 when there is an applied current to store energy in the device or an applied load to discharge the device.

In general, the cathodic type current collectors, that is whichever of the electrode current collector 214 or the counter-electrode current collector 218 is the cathodic type, may comprise a metal such as aluminum, carbon, chromium, gold, nickel, NiP, palladium, platinum, rhodium, ruthenium, an alloy of silicon and nickel, titanium, or a combination thereof (see “Current collectors for positive electrodes of lithium-based batteries” by A. H. Whitehead and M. Schreiber, Journal of the Electrochemical Society, 152(11) A2105-A2113 (2005)). By way of further example, in one embodiment, the cathodic current collectors comprise gold or an alloy thereof such as gold silicide. By way of further example, in one embodiment, the cathodic current collectors comprise nickel or an alloy thereof such as nickel silicide.

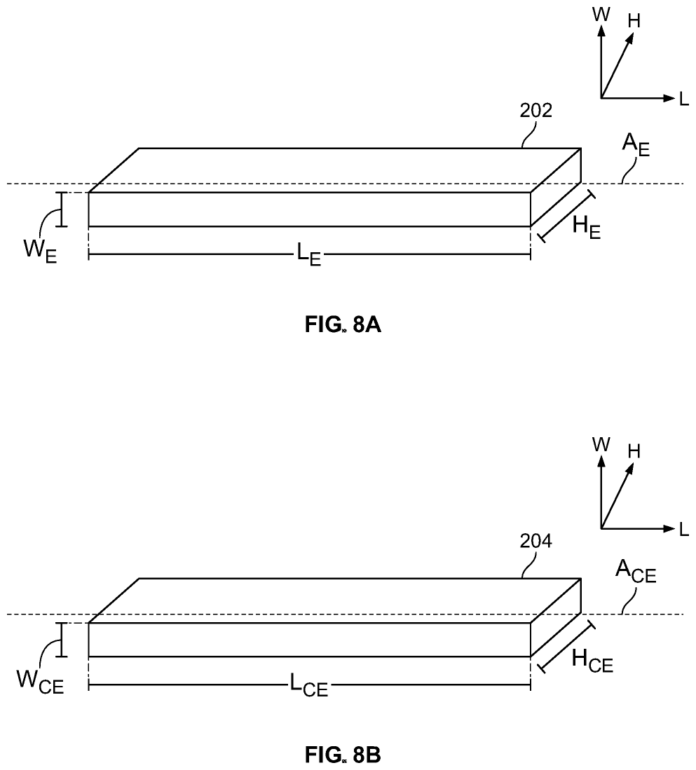

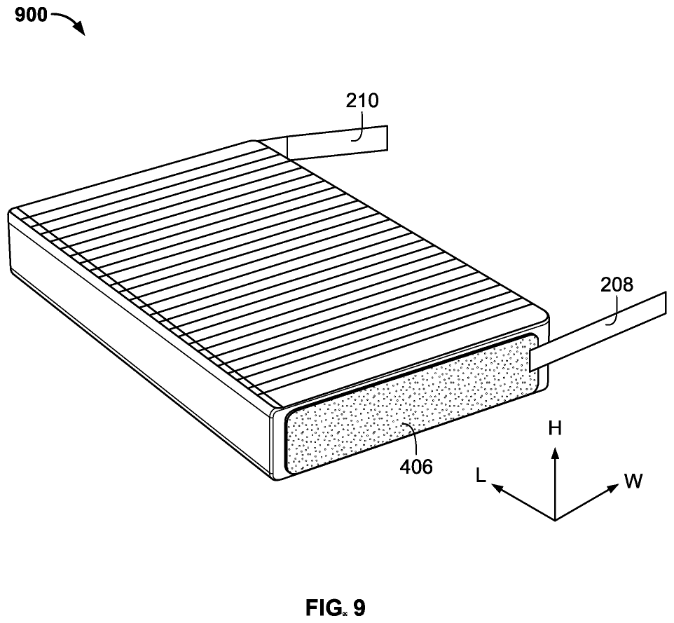

With reference to FIG. 8A, each anodic electrode structure, that is each electrode structure 202, or counter-electrode-structure 204 that is of the anodic type, has a length (L_{E}) measured along a longitudinal axis (A_{E}) of the electrode, a width (W_{E}), and a height (H_{E}) measured in a direction that is orthogonal to each of the directions of measurement of the length L_{E} and the width W_{E}.

The length L_{E} of the members of the population of anodic electrode structure will vary depending upon the energy storage device and its intended use. In general, however, the anodic electrode structures will typically have a length L_{E} in the range of about 5 mm to about 500 mm. For example, in one such embodiment, the anodic electrode structures have a length L_{E} of about 10 mm to about 250 mm. By way of further example, in one such embodiment the members of the anode population have a length L_{E} of about 25 mm to about 100 mm. According to one embodiment, the anodic electrode structures include one or more first electrode members having a first length, and one or more second electrode members having a second length that is other than the first. In yet another embodiment, the different lengths for the one or more first electrode members and one or more second electrode members may be selected to accommodate a predetermined shape for an electrode assembly, such as an electrode assembly shape having different lengths along one or more of the longitudinal and/or transverse axis, and/or to provide predetermined performance characteristics for the secondary battery.

The width W_{E} of the anodic electrode structures will also vary depending upon the energy storage device and its intended use. In general, however, each anodic electrode structure will typically have a width W_{E} within the range of about 0.01 mm to 2.5 mm. For example, in one embodiment, the width W_{E} of each anodic electrode structure will be in the range of about 0.025 mm to about 2 mm. By way of further example, in one embodiment, the width W_{E} of each anodic electrode structure will be in the range of about 0.05 mm to about 1 mm. According to one embodiment, the anodic electrode structures include one or more first electrode members having a first width, and one or more second electrode members having a second width that is other than the first. In yet another embodiment, the different widths for the one or more first electrode members and one or more second electrode members may be selected to accommodate a predetermined shape for an electrode assembly, such as an electrode assembly shape having different widths along one or more of the longitudinal and/or transverse axis, and/or to provide predetermined performance characteristics for the secondary battery.

The height H_{E} of the anodic electrode structures will also vary depending upon the energy storage device and its intended use. In general, however, the anodic electrode structures will typically have a height H_{E} within the range of about 0.05 mm to about 25 mm. For example, in one embodiment, the height H_{E} of each anodic electrode structure will be in the range of about 0.05 mm to about 5 mm. By way of further example, in one embodiment, the height H_{E} of each anodic electrode structure will be in the range of about 0.1 mm to about 1 mm. According to one embodiment, the anodic electrode structures include one or more first electrode members having a first height, and one or more second electrode members having a second height that is other than the first. In yet another embodiment, the different heights for the one or more first electrode members and one or more second electrode members may be selected to accommodate a predetermined shape for an electrode assembly, such as an electrode assembly shape having different heights along one or more of the longitudinal and/or transverse axis, and/or to provide predetermined performance characteristics for the secondary battery.

In general, the anodic electrode structures have a length L_{E} that is substantially greater than each of its width W_{E} and its height H_{E}. For example, in one embodiment, the ratio of L_{E} to each of W_{E} and H_{E} is at least 5:1, respectively (that is, the ratio of L_{E} to W_{E} is at least 5:1, respectively and the ratio of L_{E} to H_{E} is at least 5:1, respectively), for each member of the anode population. By way of further example, in one embodiment the ratio of L_{E} to each of W_{E} and H_{E} is at least 10:1. By way of further example, in one embodiment, the ratio of L_{E} to each of W_{E} and H_{E} is at least 15:1. By way of further example, in one embodiment, the ratio of L_{E} to each of W_{E} and H_{E} is at least 20:1, for each member of the anode population.

In one embodiment, the ratio of the height H_{E} to the width W_{E} of the anodic electrode structures is at least 0.4:1, respectively. For example, in one embodiment, the ratio of H_{E} to W_{E} will be at least 2:1, respectively, for each member of the anode population. By way of further example, in one embodiment the ratio of H_{E} to W_{E} will be at least 10:1, respectively. By way of further example, in one embodiment the ratio of H_{E} to W_{E} will be at least 20:1, respectively. Typically, however, the ratio of H_{E} to W_{E} will generally be less than 1,000:1, respectively. For example, in one embodiment the ratio of H_{E} to W_{E} will be less than 500:1, respectively. By way of further example, in one embodiment the ratio of H_{E} to W_{E} will be less than 100:1, respectively. By way of further example, in one embodiment the ratio of H_{E} to W_{E} will be less than 10:1, respectively. By way of further example, in one embodiment the ratio of H_{E} to W_{E} will be in the range of about 2:1 to about 100:1, respectively, for each member of the anodic electrode structure population.

With reference to FIG. 8B, each cathodic electrode structure, that is each electrode structure 202 or counter-electrode-structure 204 that is of the cathodic type, has a length (L_{CE}) measured along the longitudinal axis (A_{CE}), a width (W_{CE}), and a height (H_{CE}) measured in a direction that is perpendicular to each of the directions of measurement of the length L_{CE} and the width W_{CE}.

The length L_{CE} of the cathodic electrode structures will vary depending upon the energy storage device and its intended use. In general, however, each member of the cathode population will typically have a length L_{CE} in the range of about 5 mm to about 500 mm. For example, in one such embodiment, each cathodic electrode structure has a length L_{CE} of about 10 mm to about 250 mm. By way of further example, in one such embodiment each cathodic electrode structure has a length L_{CE} of about 25 mm to about 100 mm. According to one embodiment, the cathodic electrode structures include one or more first electrode members having a first length, and one or more second electrode members having a second length that is other than the first. In yet another embodiment, the different lengths for the one or more first electrode members and one or more second electrode members may be selected to accommodate a predetermined shape for an electrode assembly, such as an electrode assembly shape having different lengths along one or more of the longitudinal and/or transverse axis, and/or to provide predetermined performance characteristics for the secondary battery.

The width W_{CE} of the cathodic electrode structures will also vary depending upon the energy storage device and its intended use. In general, however, cathodic electrode structures will typically have a width W_{CE} within the range of about 0.01 mm to 2.5 mm. For example, in one embodiment, the width W_{CE} of each cathodic electrode structure will be in the range of about 0.025 mm to about 2 mm. By way of further example, in one embodiment, the width W_{CE} of each cathodic electrode structure will be in the range of about 0.05 mm to about 1 mm. According to one embodiment, the cathodic electrode structures include one or more first electrode members having a first width, and one or more second electrode members having a second width that is other than the first. In yet another embodiment, the different widths for the one or more first electrode members and one or more second electrode members may be selected to accommodate a predetermined shape for an electrode assembly, such as an electrode assembly shape having different widths along one or more of the longitudinal and/or transverse axis, and/or to provide predetermined performance characteristics for the secondary battery.

The height H_{CE} of the cathodic electrode structures will also vary depending upon the energy storage device and its intended use. In general, however, cathodic electrode structures will typically have a height H_{CE} within the range of about 0.05 mm to about 25 mm. For example, in one embodiment, the height H_{CE} of each cathodic electrode structure will be in the range of about 0.05 mm to about 5 mm. By way of further example, in one embodiment, the height H_{CE} of each cathodic electrode structure will be in the range of about 0.1 mm to about 1 mm. According to one embodiment, the cathodic electrode structures include one or more first cathode members having a first height, and one or more second cathode members having a second height that is other than the first. In yet another embodiment, the different heights for the one or more first cathode members and one or more second cathode members may be selected to accommodate a predetermined shape for an electrode assembly, such as an electrode assembly shape having different heights along one or more of the longitudinal and/or transverse axis, and/or to provide predetermined performance characteristics for the secondary battery.

In general, each cathodic electrode structure has a length L_{CE} that is substantially greater than width W_{CE} and substantially greater than its height H_{CE}. For example, in one embodiment, the ratio of L_{CE} to each of W_{CE} and H_{CE} is at least 5:1, respectively (that is, the ratio of L_{CE} to W_{CE} is at least 5:1, respectively and the ratio of L_{CE} to H_{CE} is at least 5:1, respectively), for each cathodic electrode structure. By way of further example, in one embodiment the ratio of L_{CE} to each of W_{CE} and H_{CE} is at least 10:1 for each cathodic electrode structure. By way of further example, in one embodiment, the ratio of L_{CE} to each of W_{CE} and H_{CE} is at least 15:1 for each cathodic electrode structure. By way of further example, in one embodiment, the ratio of L_{CE} to each of W_{CE} and H_{CE} is at least 20:1 for each cathodic electrode structure.

In one embodiment, the ratio of the height H_{CE} to the width W_{CE} of the cathodic electrode structures is at least 0.4:1, respectively. For example, in one embodiment, the ratio of H_{CE} to W_{CE} will be at least 2:1, respectively, for each cathodic electrode structure. By way of further example, in one embodiment the ratio of H_{CE} to W_{CE} will be at least 10:1, respectively, for each cathodic electrode structure. By way of further example, in one embodiment the ratio of H_{CE} to W_{CE} will be at least 20:1, respectively, for each cathodic electrode structure. Typically, however, the ratio of H_{CE} to W_{CE} will generally be less than 1,000:1, respectively, for each member of the anode population. For example, in one embodiment the ratio of H_{CE} to W_{CE} will be less than 500:1, respectively, for each cathodic electrode structure. By way of further example, in one embodiment the ratio of H_{CE} to W_{CE} will be less than 100:1, respectively. By way of further example, in one embodiment the ratio of H_{CE} to W_{CE} will be less than 10:1, respectively. By way of further example, in one embodiment the ratio of H_{CE} to W_{CE} will be in the range of about 2:1 to about 100:1, respectively, for each cathodic electrode structure.

Returning to FIG. 2, the separator structures 205 separate the electrode structures 202 from the counter-electrode structures. The separator structures 205 are made of electrically insulating but ionically permeable separator material. The electrically insulating separator structures are designed to prevent electrical short circuits while also allowing the transport of ionic charge carriers that are needed to close the circuit during the passage of current in an electrochemical cell. In one embodiment, the electrically insulating separator structures are microporous and permeated with an electrolyte, e.g., a non-aqueous liquid or gel electrolyte. Alternatively, the electrically insulating separator structures may comprise a solid electrolyte, i.e., a solid ion conductor, which can serve as both a separator and the electrolyte in a battery. The separator structures 205 are adapted to electrically isolate each member of the population of electrode structures 202 from each member of the population of counter-electrode structures 204. Each separator structure 205 will typically include a microporous separator material that can be permeated with a non-aqueous electrolyte; for example, in one embodiment, the microporous separator material includes pores having a diameter of at least 50 Å, more typically in the range of about 2,500 Å, and a porosity in the range of about 25% to about 75%, more typically in the range of about 35-55%. Additionally, the microporous separator material may be permeated with a non-aqueous electrolyte to permit conduction of carrier ions between adjacent members of the electrode and counter-electrode populations. In certain embodiments, for example, and ignoring the porosity of the microporous separator material, at least 70 vol % of electrically insulating separator material between a member of the electrode structure 110 population and the nearest member(s) of the counter-electrode structure 112 population (i.e., an “adjacent pair”) for ion exchange during a charging or discharging cycle is a microporous separator material; stated differently, microporous separator material constitutes at least 70 vol % of the electrically insulating material between a member of the electrode structure 110 population and the nearest member of the counter-electrode 112 structure population.

In one embodiment, the microporous separator material comprises a particulate material and a binder, and has a porosity (void fraction) of at least about 20 vol. % The pores of the microporous separator material will have a diameter of at least 50 Å and will typically fall within the range of about 250 to 2,500 Å. The microporous separator material will typically have a porosity of less than about 75%. In one embodiment, the microporous separator material has a porosity (void fraction) of at least about 25 vol %. In one embodiment, the microporous separator material will have a porosity of about 35-55%.

The binder for the microporous separator material may be selected from a wide range of inorganic or polymeric materials. For example, in one embodiment, the binder can be an organic polymeric material such as a fluoropolymer derived from monomers containing vinylidene fluoride, hexafluoropropylene, tetrafluoropropene, and the like. In another embodiment, the binder is a polyolefin such as polyethylene, polypropylene, or polybutene, having any of a range of varying molecular weights and densities. In another embodiment, the binder is selected from the group consisting of ethylene-diene-propene terpolymer, polystyrene, polymethyl methacrylate, polyethylene glycol, polyvinyl acetate, polyvinyl butyral, polyacetal, and polyethyleneglycol diacrylate. In another embodiment, the binder is selected from the group consisting of methyl cellulose, carboxymethyl cellulose, styrene rubber, butadiene rubber, styrene-butadiene rubber, isoprene rubber, polyacrylamide, polyvinyl ether, polyacrylic acid, polymethacrylic acid, polyacrylonitrile, polyvinylidene fluoride polyacrylonitrile and polyethylene oxide. In another embodiment, the binder is selected from the group consisting of acrylates, styrenes, epoxies, and silicones. Other suitable binders may be selected from polyvinylidene fluoride-co-hexafluoropropylene, polyvinylidene fluoride-co-trichloroethylene, polymethylmethacrylate, polyacrylonitrile, polyvinylpyrrolidone, polyvinyl acetate, polyethylene-co-vinyl acetate, polyethylene oxide, cellulose acetate, cellulose acetate butyrate, cellulose acetate propionate, cyanoethylpullulan, cyanoethyl polyvinylalcohol, cyanoethylcellulose, cyanoethylsucrose, pullulan, carboxymethyl cellulose, acrylonitrile-styrene-butadiene copolymer, polyimide or mixtures thereof. In yet another embodiment, the binder may be selected from any of polyvinylidene fluoride-hexafluoro propylene, polyvinylidene fluoride-trichloroethylene, polymethyl methacrylate, polyacrylonitrile, polyvinyl pyrrolidone, polyvinyl acetate, ethylene vinyl acetate copolymer, polyethylene oxide, cellulose acetate, cellulose acetate butyrate, cellulose acetate propionate, cyanoethyl pullulan, cyanoethyl polyvinyl alcohol, cyanoethyl cellulose, cyanoethyl sucrose, pullulan, carboxyl methyl cellulose, acrylonitrile styrene butadiene copolymer, polyimide, polyethylene terephthalate, polybutylene terephthalate, polyester, polyacetal, polyamide, polyetheretherketone, polyether sulfone, polyphenylene oxide, polyphenylene sulfide, polyethylene naphthalene, and/or combinations thereof. In another embodiment, the binder is a copolymer or blend of two or more of the aforementioned polymers.

The particulate material comprised by the microporous separator material may also be selected from a wide range of materials. In general, such materials have a relatively low electronic and ionic conductivity at operating temperatures and do not corrode under the operating voltages of the battery electrode or current collector contacting the microporous separator material. For example, in one embodiment, the particulate material has a conductivity for carrier ions (e.g., lithium) of less than 1×10−4 S/cm. By way of further example, in one embodiment, the particulate material has a conductivity for carrier ions of less than 1×10−5 S/cm. By way of further example, in one embodiment, the particulate material has a conductivity for carrier ions of less than 1×10−6 S/cm. For example, in one embodiment, the particulate material is an inorganic material selected from the group consisting of silicates, phosphates, aluminates, aluminosilicates, and hydroxides such as magnesium hydroxide, calcium hydroxide, etc. Exemplary particulate materials include particulate polyethylene, polypropylene, a TiO2-polymer composite, silica aerogel, fumed silica, silica gel, silica hydrogel, silica xerogel, silica sol, colloidal silica, alumina, titania, magnesia, kaolin, talc, diatomaceous earth, calcium silicate, aluminum silicate, calcium carbonate, magnesium carbonate, or a combination thereof. For example, in one embodiment, the particulate material comprises a particulate oxide or nitride such as TiO2, SiO2, Al2O3, GeO2, B2O3, Bi2O3, BaO, ZnO, ZrO2, BN, Si3N4, Ge3N4. See, for example, P. Arora and J. Zhang, “Battery Separators” Chemical Reviews 2004, 104, 4419-4462). Other suitable particles can comprise BaTiO3, Pb(Zr,Ti)O3 (PZT), Pb1−xLaxZr1−yTiyO3 (PLZT), PB(Mg3Nb2/3)O3−PbTiO3 (PMN-PT), hafnia (HfO2), SrTiO3, SnO2, CeO2, MgO, NiO, CaO, ZnO, ZrO2, Y2O3, Al2O3, TiO2, SiC or mixtures thereof. In one embodiment, the particulate material will have an average particle size of about 20 nm to 2 micrometers, more typically 200 nm to 1.5 micrometers. In one embodiment, the particulate material will have an average particle size of about 500 nm to 1 micrometer.

In yet another embodiment, the separator structures comprise 205 a solid electrolyte, for example as in a solid state battery. Generally speaking, the solid electrolyte can facilitate transport of carrier ions, without requiring addition of a liquid or gel electrolyte. According to certain embodiments, in a case where a solid electrolyte is provided, the solid electrolyte may itself be capable of providing insulation between the electrodes and allowing for passage of carrier ions therethrough, and may not require addition of a liquid electrolyte permeating the structure.

In general, the electrically insulating separator material will have a thickness of at least about 4 um. For example, in one embodiment, the electrically insulating separator material will have a thickness of at least about Sum. By way of further example, in one such embodiment the electrically insulating separator material will have a thickness of at least about 12 um. By way of further example, in one such embodiment the electrically insulating separator material will have a thickness of at least about 15 um. In some embodiments, the electrically insulating separator material will have a thickness of up to 25 um, up to 50 um, or any other suitable thickness. Typically, however, the electrically insulating separator material will have a thickness of less than about 12 um or even less than about 10 um.

In general, the material of the separator structures 205 may be selected from a wide range of material having the capacity to conduct carrier ions between the positive and negative active material of a unit cell. For example, the separator structures 205 may comprise a microporous separator material that may be permeated with a liquid, nonaqueous electrolyte. Alternatively, the separator structures 205 may comprise a gel or solid electrolyte capable of conducting carrier ions between the positive and negative electrodes of a unit cell.

In one embodiment, the separator structures 205 may comprise a polymer based electrolyte. Exemplary polymer electrolytes include PEO-based polymer electrolytes, polymer-ceramic composite electrolytes, polymer-ceramic composite electrolytes, and polymer-ceramic composite electrolyte.

In another embodiment, the separator structures 205 may comprise an oxide based electrolyte. Exemplary oxide-based electrolytes include lithium lanthanum titanate (Li_{0.34}La_{0.56}TiO₃), Al-doped lithium lanthanum zirconate (Li_{6.24}La₃Zr₂Al_{0.24}O_{11.98}), Ta-doped lithium lanthanum zirconate (Li_{6.4}La₃Zr_{1.4}Ta_{0.6}O₁₂) and lithium aluminum titanium phosphate (Li_{1.4}Al_{0.4}Ti_{1.6}(PO₄)₃).

In another embodiment, the separator structures 205 may comprise a solid electrolyte. Exemplary solid electrolytes include sulfide based electrolytes such as lithium tin phosphorus sulfide (Li₁₀SnP₂S₁₂), lithium phosphorus sulfide (β-Li₃PS₄) and lithium phosphorus sulfur chloride iodide (Li₆PS₅Cl_{0.9}I_{0.1}). In some embodiments, the separator structures 205 may comprise a solid-state lithium ion conducting ceramic, such as a lithium-stuffed garnet.

In an alternative embodiment, the particulate material comprised by the microporous separator material may be bound by techniques such as sintering, binding, curing, etc. while maintaining the void fraction desired for electrolyte ingress to provide the ionic conductivity for the functioning of the battery.

Some embodiments include electrolyte that may be any of an organic liquid electrolyte, an inorganic liquid electrolyte, an aqueous electrolyte, a non-aqueous electrolyte, a solid polymer electrolyte, a solid ceramic electrolyte, a solid glass electrolyte, a garnet electrolyte, a gel polymer electrolyte, an inorganic solid electrolyte, a molten-type inorganic electrolyte or the like. Other arrangements and/or configurations of separator structures, with or without liquid electrolyte, may also be provided. In one embodiment, the solid electrolyte can comprise a ceramic or glass material that is capable of providing electrical insulation while also conducting carrier ions therethrough. Examples of ion conducting material can include garnet materials, a sulfide glass, a lithium ion conducting glass ceramic, or a phosphate ceramic material. In one embodiment, a solid polymer electrolyte can comprise any of a polymer formed of polyethylene oxide (PEO)-based, polyvinyl acetate (PVA)-based, polyethyleneimine (PEI)-based, polyvinylidene fluoride (PVDF)-based, polyacrylonitrile (PAN)-based, LiPON (lithium phosphorus oxynitride), and polymethyl methacrylate (PMMA)-based polymers or copolymers thereof. In another embodiment, a sulfide-based solid electrolyte may be provided, such as a sulfide-based solid electrolyte comprising at least one of lithium and/or phosphorous, such as at least one of Li2S and P2S5, and/or other sulfides such as SiS2, GeS2, Li3PS4, Li4P2S7, Li4SiS4, Li2S-P2S5, and 50Li4SiO4.50Li3BO3, and/or B2S3. Yet other embodiments of solid electrolyte can include nitrides, halides and sulfates of lithium (Li) such as Li3N, LiI, Li5NI2, Li3N-LiI—LiOH, LiSiO4, LiSiO4-LiI—LiOH, Li2SiS3, Li4SiO4, Li4SiO4-LiI—LiOH, and Li3PO4-Li2S-SiS2, Li2S—P2S5, Li2S—P2S5-L4SiO4, Li2S-Ga2S3-GeS2, Li2S-Sb2S3-GeS2, Li3.25-Ge0.25-P0.75S4, (La,Li)TiO3 (LLTO), Li6La2CaTa2O12, Li6La2ANb2O12(A=Ca, Sr), Li2Nd3TeSbO12, Li3BO2.5N0.5, Li9SiAlO8, LiI+xAlxGe2−x(PO4)3 (LAGP), Li1+xAlxTi2−x(PO4)3 (LATP), Li1+xTi2−xAlxSiy(PO4)3−y, LiAlxZr2−x(PO4)3, LiTixZr2−x(PO4)3, Yet other embodiments of solid electrolyte can include garnet materials, such as for example described in U.S. Pat. No. 10,361,455, which is hereby incorporated herein in its entirety. In one embodiment, the garnet solid electrolyte is a nesosilicate having the general formula X3Y2(SiO4)3, where X may be a divalent cation such as Ca, Mg, Fe or Mn, or Y may be a trivalent cation such as Al, Fe, or Cr.

In some embodiments, the separator structure comprises a microporous separator material that is permeated with a non-aqueous electrolyte suitable for use as a secondary battery electrolyte. Typically, the non-aqueous electrolyte comprises a lithium salt and/or mixture of salts dissolved in an organic solvent and/or solvent mixture. Exemplary lithium salts include inorganic lithium salts such as LiClO4, LiBF4, LiPF6, LiAsF6, LiCl, and LiBr; and organic lithium salts such as LiB(C6H5)4, LiN(SO2CF3)2, LiN(SO2CF3)3, LiNSO2CF3, LiNSO2CF5, LiNSO2C4F9, LiNSO2C5F11, LiNSO2C6F13, and LiNSO2C7F15. As yet another example, the electrolyte can comprise sodium ions dissolved therein, such as for example any one or more of NaClO4, NaPF6, NaBF4, NaCF3SO3, NaN(CF3SO2)2, NaN(C2F5SO2)2, NaC(CF3SO2)3. Salts of magnesium and/or potassium can similarly be provided. For example magnesium salts such as magnesium chloride (MgCl2), magnesium bromide MgBr2), or magnesium iodide (MgI2) may be provided, and/or as well as a magnesium salt that may be at least one selected from the group consisting of magnesium perchlorate (Mg(ClO4)2), magnesium nitrate (Mg(NO3)2), magnesium sulfate (MgSO4), magnesium tetrafluoroborate (Mg(BF4)2), magnesium tetraphenylborate (Mg(B(C6H5)4)2, magnesium hexafluorophosphate (Mg(PF6)2), magnesium hexafluoroarsenate (Mg(AsF6)2), magnesium perfluoroalkylsulfonate ((Mg(Rf1SO3)2), in which Rf1 is a perfluoroalkyl group), magnesium perfluoroalkylsulfonylimide (Mg((Rf2SO2)2N)2, in which Rf2 is a perfluoroalkyl group), and magnesium hexaalkyl disilazide ((Mg(HRDS)2), in which R is an alkyl group). Exemplary organic solvents to dissolve the lithium salt include cyclic esters, chain esters, cyclic ethers, and chain ethers. Specific examples of the cyclic esters include propylene carbonate, ethylene carbonate, butylene carbonate, γ-butyrolactone, vinylene carbonate, 2-methyl-γ-butyrolactone, acetyl-γ-butyrolactone, and γ-valerolactone. Specific examples of the chain esters include dimethyl carbonate, diethyl carbonate, dibutyl carbonate, dipropyl carbonate, methyl ethyl carbonate, methyl butyl carbonate, methyl propyl carbonate, ethyl butyl carbonate, ethyl propyl carbonate, butyl propyl carbonate, alkyl propionates, dialkyl malonates, and alkyl acetates. Specific examples of the cyclic ethers include tetrahydrofuran, alkyltetrahydrofurans, dialkyltetrahydrofurans, alkoxytetrahydrofurans, dialkoxytetrahydrofurans, 1,3-dioxolane, alkyl-1,3-dioxolanes, and 1,4-dioxolane. Specific examples of the chain ethers include 1,2-dimethoxyethane, 1,2-diethoxythane, diethyl ether, ethylene glycol dialkyl ethers, diethylene glycol dialkyl ethers, triethylene glycol dialkyl ethers, and tetraethylene glycol dialkyl ethers.

In one embodiment, the separator structures' microporous separator may be permeated with a non-aqueous, organic electrolyte including a mixture of a lithium salt and a high-purity organic solvent. In addition, the electrolyte may be a polymer using a polymer electrolyte or a solid electrolyte.

The electrode busbar 208 is a cathodic electrode busbar when the electrode structure 202 is a cathodic type and is an anodic electrode busbar when the electrode structure 202 is an anodic type. Similarly, the counter-electrode busbar is a cathodic electrode busbar when the counter-electrode structure 204 is a cathodic type and is an anodic electrode busbar when the counter-electrode structure 204 is an anodic type. In the example embodiment, the anodic type busbar is a copper busbar and the cathodic type busbar is an aluminum busbar. In other embodiments, the electrode busbar 208 and the counter-electrode busbar 210 may be any suitable conductive material to allow the electrode assembly 200 to function as described herein.

The counter-electrode structures 204, and more specifically, the counter-electrode current collectors 218, are directly connected to the counter-electrode busbar 210. That is, the counter-electrode current collectors 218 are welded, soldered, or glued to the counter-electrode busbar 210 without any components electrically or physically positioned between them. The welds may be made using a laser welder, friction welding, ultrasonic welding or any suitable welding method for welding the counter-electrode busbar 210 to the counter-electrode current collectors 218.

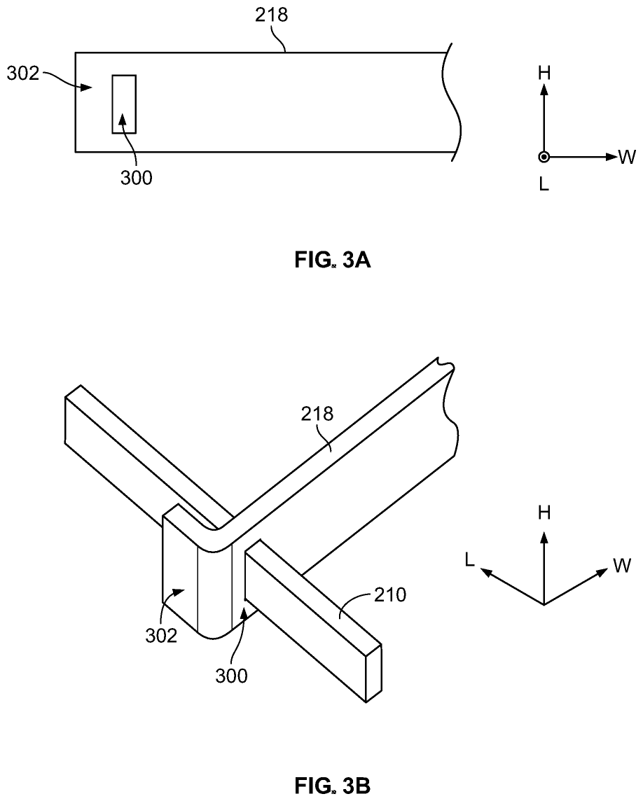

FIGS. 3A and 3B illustrate an example technique for connection between one of the counter-electrode current collectors 218 and the counter-electrode busbar 210. FIG. 3A is a view of an end portion of one of the counter-electrode current collectors 218. The end of the counter-electrode current collector 218 includes a slot 300 that is sized and shaped to receive the counter-electrode busbar 210. A portion 302 of the counter-electrode current collector 218 extends past the slot 300. The counter-electrode busbar 210 is inserted through the slot 300, and the portion 302 of the counter-electrode current collectors 218 is bent over to contact the counter-electrode busbar 210, as shown in FIG. 3B. The portion 302 of the counter-electrode current collector 218 that is in contact with the counter-electrode busbar 210 is then welded to the counter-electrode busbar 210.

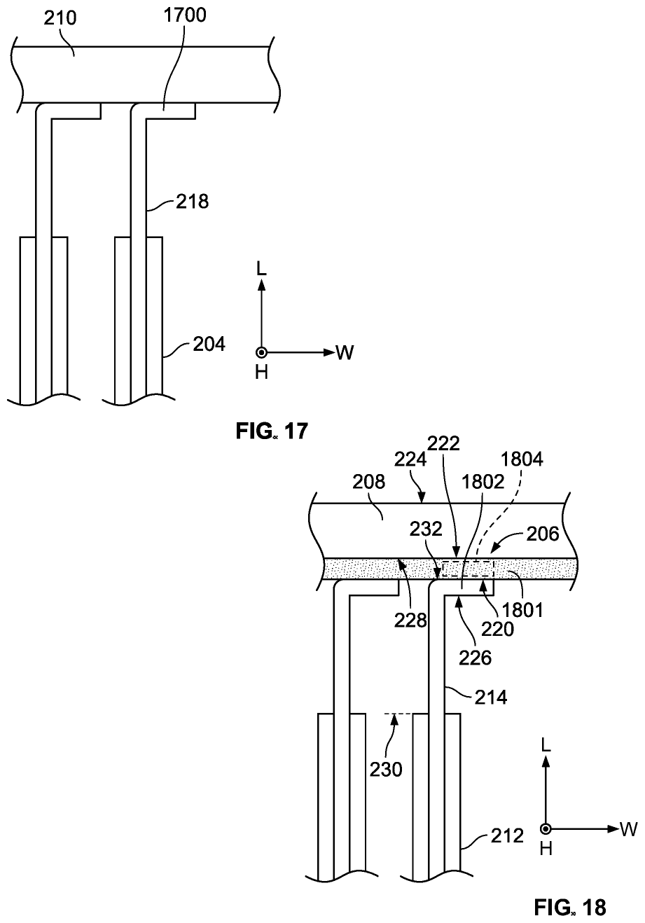

FIG. 17 illustrates another example technique for connection between one of the counter-electrode current collectors 218 and the counter-electrode busbar 210. In this example, the counter-electrode current collector 218 does not include the slot 300. A portion 1700 of the counter-electrode current collector 218 is bent to approximately a ninety-degree angle and the counter-electrode busbar 210 is positioned over the portion 1700. The counter-electrode busbar 210 is then attached directly to the portion 1700 of the counter-electrode current collector 218, such as by gluing, welding, soldering, or using any other suitable technique for joining the counter-electrode current collectors 218 to the counter-electrode busbar 210.

Returning to FIG. 2, each member of the population of current limiters 206 is electrically connected between a different electrode current collector 214 and the electrode busbar 208. The current limiters 206 are configured to limit the current that may flow through the electrode current collector 214, and correspondingly through the electrode structure 202, to which it is connected. Thus, for example, if a short circuit is formed between one of the electrode current collectors 214 and one of the counter-electrode current collectors 218, the current limiter 206 limits the amount of current that can flow from the other electrodes and counter electrodes of the electrode assembly and thereby limits the temperature experienced by the electrode assembly 200 and a thermal runaway is prevented. Specifically, the current limiters 206 limit an amount of current that may be conducted through a unit cell during a discharge of the electrode assembly in which there is an electrical short between the electrode and counter-electrode of the unit cell to a value I, which is less than a current (sometimes referenced herein as Iₜᵣ or I_{L}) through a member of the unit cell population that would induce thermal runaway of the member of the unit cell population. The current limiters provide a soft landing for the battery in the event of a short circuit. The current limiters continuously allow a non-zero level of current to flow in the event of a short circuit but limit that current to below a level that would trigger a thermal runaway. This current will continue to flow until the battery is discharged and the risk of thermal runaway is ended.

The current limiters 206 are resistive current limiters. The current limiters 206 have a nonzero resistance within the range of normal operating temperatures of the electrode assembly 200. In one example, the normal operating temperatures are between negative twenty ° C. and eighty ° C. In other embodiments, the normal operating temperatures are between negative forty ° C. and eighty-five ° C., between negative forty ° C. and one hundred and fifty ° C., or any other suitable range of normal operating temperatures. The resistance is such that the current limiters 206 limit the current that may pass through any unit cell and prevent the current from reaching a level that may cause catastrophic failure or any other maximum current level that is determined for other performance or abuse tolerance reasons as determined during battery design. In some embodiments, the current limiters 206 do not rely on a fuse or any PTC characteristic of the resistive material. That is, although the current limiters 206 may exhibit PTC, a PTC is not required for the current limiters 206 to function as described herein. Rather, in such embodiments, the resistance of the current limiters 206 in the range of normal operating temperatures of the electrode assembly 200 is sufficient to limit the current. In some embodiments, the resistance may increase or decrease (i.e., the current limiters may have a negative temperature coefficient) within the normal range of operating temperatures. In some embodiments, the current limiters have a resistance within the normal range of operating temperatures, and the resistance further increases at or above a temperature threshold or target temperature.

The current limiters 206 are each electrically in series with the electrode current collector 214 to which it is attached. Thus, the resistance of each current limiter 206 and its associated electrode structure 202 is increased by adding the resistance of the associated electrode structure 202 and the resistance of the current limiter 206 attached thereto. Adding resistance to a battery is conventionally discouraged, because the added resistance will increase the losses experienced by the battery when current is flowing into the electrode structures 202 (during charging) and out of the electrode structures (during discharge). However, because the electrode current collectors 214 are all connected to the electrode busbar 208 in parallel (electrically parallel), the increase in total resistance seen at the electrode busbar 208 is much smaller than the resistance of each individual current limiter 206. Moreover, the resistance of the current limiters 206 in this disclosure is selected to be small enough to have a limited voltage drop across the current limiters 206 and thereby have a limited loss of power. In the example embodiment, the resistance of the current limiters is selected to have no more than a 20 mV drop across each of the current limiters 206 during charging or discharging at a 1C rate to limit losses during normal operation while still protecting the battery during a short circuit.

In the example embodiment, each individual unit cell, that is each pair of one electrode structure 202 and one counter-electrode structure 204, without a current limiter 206 has a relatively small size (compared to a laminar battery), a relatively low capacity, and an internal resistance high enough that current through an isolated unit cell cannot reach levels sufficient to cause thermal runaway and catastrophic failure, even when there is a short circuit between the electrode structure 202 and the counter-electrode structure 204 of the unit cell. However, when multiple unit cells are connected in parallel to a busbar, such as the electrode busbar 208, in an electrode assembly, such as electrode assembly 200, all of the unit cells contribute current to the unit cell that has a short circuit within it. Under such circumstances, without a current limiter 206, sufficient current may pass through the shorted unit cell to cause thermal runaway and catastrophic failure of the electrode assembly 200 and the battery containing it. By adding the current limiters 206, the resistance of a unit cell is effectively increased. With the fixed voltage V of the unit cells, increasing the resistance will result in a corresponding reduction in the maximum current according to Ohm's law.

More specifically, the capacity of the electrode assembly 200 is subdivided into a number (n) of electrode unit cells, each of which includes one electrode structure 202 and one counter-electrode structure 204. Each unit cell forms a voltage (V). Each individual electrode unit cell has its own characteristic resistance (R_{bl}) which is a function of conductivity and geometry of the unit cell assembly. Each individual unit cell is capable of discharging a power (\dot{q}_{bl}) across a short circuit, such as forced internal short circuit (FISC) resistance (Rₛ). For an individual unit cell, the FISC power is given by:

$${\dot{q}}_{bl} = \frac{{V}^{2}}{{R}_{s} + {R}_{bl}} \qquad ( 1 )$$

When electrode structure 202 and counter-electrode structure 204 of each unit cell are connected in parallel to their respective busbars 208, 210, all unit cells contribute power discharging across the FISC (\dot{q}_{cell}) of the individual affected (i.e., shorted) unit cell. The FISC power of all unit cells of the cell connected in parallel is given by:

$${\dot{q}}_{cell} = \frac{{V}^{2}}{{R}_{s} + {R}_{bl} / n} \qquad ( 2 )$$

Adding in the current limiters 206, each of which has a nonzero resistance (R_{cld}) results in a FISC power for a shorted unit cell given by:

$${\dot{q}}_{FISC} = \frac{{V}^{2}}{{R}_{s} + {[ {R}_{bl}^{- 1} + {( {R}_{cld} + \frac{{R}_{bl} + {R}_{cld}}{n - 1} )}^{- 1} ]}^{- 1}} \qquad ( 3 )$$

The resistance R_{cld} of each current limiter 206 is selected such that the FISC power \dot{q}_{FISC} of for a shorted unit cell is less than the power minimum for occurrence of thermal runaway (\dot{q}ₜᵣ) or other maximum power considerations chosen due to battery design constraints.

The required resistance of the current limiters 206 may also be viewed from the perspective of the resistance needed to limit the current through a shorted unit cell below a threshold current that is sufficient to cause thermal runaway. Thus, by knowing the voltage produced by each unit cell, the capacity of each unit cell, the internal resistance of each unit cell, the resistance of the electrode busbar 208, and the resistance of the counter-electrode busbar 210, a resistance for the current limiters 206 can be calculated that will limit a current through the shorted unit cell to less than the threshold current needed to cause thermal runaway. The threshold current needed to cause thermal runaway may vary somewhat depending on the construction of the electrode assembly and the capacity of the individual unit cells, but for similarly constructed electrode assemblies, the threshold current will remain relatively constant. In the example embodiment, the threshold current is about 8 amps. In other embodiments, the threshold current may be about 4 amps, about 8 amps, about 10 amps, about 12 amps, or between 8 amps and 12 amps. The resistance needed for the current limiters 206 will vary depending on the specific configuration of the battery and its components. For similar electrode assemblies, the resistance needed to limit the current below the threshold current will generally increase as the capacity of the individual unit cells increases.

More specifically, the capacity of traditional stack battery cells is subdivided into a number of electrode unit cells (N) where each positive and negative electrode forms a voltage (V). The number of unit cells in a complete stack is represented by the capital letter N, while the number of unit cells as a variable, for example when performing an iterative assay with different numbers of unit cells, is represented by the lowercase letter n. Each individual electrode unit cell has its own characteristic resistance (R_{bl}) which is a function of conductivity and geometry of the unit cell assembly. Each individual unit cell is capable of discharging a current (I_{bl}) across a forced internal short circuit (FISC) resistance (Rₛ). The FISC current of an individual unit cell is given by

$${I}_{bl} = \frac{V}{{R}_{s} + {R}_{bl}} \qquad ( 4 )$$

When positive and negative electrodes of each unit cell are connected in parallel through their respective current collecting terminals with their own characteristic resistance (Rₜ), all unit cells of the cell contribute current (I_{cell}) discharging across the FISC of an individual affected unit cell. The FISC current of all unit cells of the cell connected in parallel is given by:

$${I}_{cell} = \frac{V}{{R}_{s} + {[ {R}_{bl}^{- 1} + {( {R}_{t} + \frac{{R}_{bl}}{N - 1} )}^{- 1} ]}^{- 1}} \qquad ( 5 )$$

In at least some cases, the characteristic resistance of an individual unit cell is low enough that the current it is capable of discharging across a FISC is sufficient to exceed a thermal runaway current (Iₜᵣ), which is a current that may be sufficient to cause self-accelerating exothermic decomposition and thermal runaway. When multiple electrode unit cells are mutually connected through shared terminals, discharge current across the FISC of an individual affected unit cell is increasingly likely to exceed the thermal runaway current (Iₜᵣ) and result in catastrophic failure of the cell.

The resistance of each current limiter 206 is selected to be sufficient to limit the current that may pass through any individual unit cell below the thermal runaway current (Iₜᵣ). The resistance of each current limiter (R_{cld}) is determined as a resistance that will satisfy:

$$\frac{{V}_{TOC}}{{R}_{s , WCFISC} + {[ {R}_{bl}^{- 1} + {( {R}_{cld} + {R}_{t} + \frac{{R}_{bl} + {R}_{cld}}{N - 1} )}^{- 1} ]}^{- 1}} < {I}_{tr} , \qquad ( 6 )$$

where V_{TOC} is the voltage of a unit cell at top of charge, and R_{S,WCFISC} is equivalent to the impedance of the unit cells in an assembly without a current limiting device in a worst case forced internal short circuit at the top of charge in an assembly of N unit cells. In the example, the worst case is considered to occur when the resistance of the forced internal short circuit is approximately equal to the resistance of the shorted unit cell. The impedance is used because the current changes very rapidly upon occurrence of a short circuit. In one embodiment, R_{S,WCFISC} is the impedance at 20 kHz. Thus, the resistance R_{S,WCFISC} may be described by:

$${R}_{s , WCFISC} = {R}_{20 kHz} ( {V}_{TOC} , N ) \qquad ( 7 )$$

Other embodiments may use impedance at any other frequency or a direct current resistance. In some embodiments, the actual short circuit resistance of a shorted unit cell is calculated and used in equation (6) instead of the worst case internal short circuit resistance R_{s,WCFISC}. As used herein, the short circuit resistance Rₛ can refer to either the actual, measured short circuit resistance of a unit cell or the worst case internal short circuit resistance R_{s,WCFISC}, unless otherwise specified. An example method for determining the actual short circuit resistance is provided below.

The resistance of an individual unit cell is determined by the impedance at top of charge further considering the number of unit cell subdivisions and the resistance of the terminals calculated based on their material composition and geometry. For the example using the 20 kHz impedance, the resistance of a unit cell is given by:

$${R}_{bl} = \frac{{R}_{20 kHz} ( {V}_{TOC} , N )}{N} - {R}_{t} \qquad ( 8 )$$

In the example embodiment, the thermal runaway current (Iₜᵣ) to be used in equation (6) above is determined by performing a worst case forced internal short circuit assay that is described below. In other embodiments, the thermal runaway current (Iₜᵣ) may be estimated, derived from simulations, determined using a different assay, or arrived at through any other suitable methods. However, determined, the thermal runaway current (Iₜᵣ) is then used in equation (6) to determine the resistance needed in the current limiter (R_{cld}) to satisfy the inequality. By selecting providing current limiters 206 with the resistance R_{cld}, the current limiters 206 will effectively limit the current through any unit cell to less than the thermal runaway current (Iₜᵣ), even in the event of an internal short circuit in a unit cell.

For the example embodiment, the resistance of each current limiter 206 at 25 degrees Celsius (° C.) is about 0.25 ohms (Ω) and limits the short circuit current to less than about 8 amps. This results in a 20 mV or less voltage drop across each current limiter 206 when the electrode assembly 200 is charging or discharging at a 1C rate. In other embodiments, the resistance of each current limiter 206 is between 0.25Ω and 2.5Ω. In some embodiments, the resistance of each current limiter 206 is between 0.1Ω and 1.5Ω. These ranges provide a range of resistances that balance the need to limit the current during a short circuit while also limiting losses during normal operation of the battery. The exact value within the ranges, as well as which range is to choose, may be selected based on the voltage, capacity, or other characteristics of the particular battery. More generally, in some embodiments, the resistance of each current limiter 206 is determined by selecting a resistance that produces a voltage drop of less than 0.5 volts when the electrode assembly 200 (or an individual unit cell) is charging or discharging at a 1C rate when discharged from a top of charge (TOC) condition. That is, the current at the 1C rate time the resistance of the current limiter 206 is less than 0.5 volts to minimize losses during normal operation while still sufficiently limiting current during a short circuit.

The current limiters 206 are positioned on the electrode busbar 208 in the example embodiment. The current limiters are physically positioned between the electrode current collectors 214 and the electrode busbar 208. In other embodiments, the current limiters 206 may be electrically coupled between the electrode current collectors 214 and the electrode busbar 208, but physically outside of the connection between the electrode current collectors 214 and the electrode busbar 208.

In the embodiments described herein, the current limiters 206 have a measurable resistance at room temperature/normal operating temperatures sufficient to prevent thermal runaway during start of a short circuit without lag. As the temperatures of the current limiters 206 increase during a short circuit, the resistance of the current limiters 206 increases at or above a transition temperature, which provides additional protection during the short circuit. For example, the current limiters 206 at least partially melt, expand, and/or partially detach from the electrode busbar 208 and/or the electrode current collector 214 at or above the transition temperature, which increases the resistance of the current limiters 206 and provides additional protection from the short circuit.

In FIG. 2, interfaces 220, 222 are formed between the electrode current collectors 214, the electrode busbar 208, and the current limiters 206. In particular, the interface 220 is formed between the electrode current collectors 214 and the current limiters 206, and the interface 222 is formed between the electrode busbar 208 and the current limiters 206. The current limiters 206 adhere to the electrode current collectors 214 and the electrode busbar 208 at the interfaces 220, 222, respectively. For example, during normal operating currents and temperatures for the current limiters 206, the interfaces 220, 220, respectively, form mechanical and electrical connections between the current limiters 206, the electrode current collectors 214, and the electrode busbar 208.

More specifically, the current limiters 206 adhere to the electrode current collectors 214 and the electrode busbar 208 at the interfaces 220, 222, respectively, when the current limiters 206 are below a transition temperature. The transition temperature may be adjusted prior to assembling the electrode assembly 200 by modifying one or more design parameters of the current limiters 206 in order to specifically select the transition temperature where the current limiters 206 begin to melt and reduce the adhesion to the electrode current collectors 214 and the electrode busbar 208 at the interfaces 220, 222. For example, the chemical composition of the current limiters 206, the additives included in the current limiters 206, the thickness of the current limiters 206, and the like may be modified to adjust the transition temperature.

The transition temperature may be the minimum expected temperature of the current limiters 206 during abnormal operation of the electrode assembly 200. The abnormal operation of the electrode assembly 200 may be, for example, exceeding the rated current and/or temperature of the electrode assembly 200. When the current limiters 206 are at or above the transition temperature, the current limiters 206 at least partially melt, reducing the adhesion between the current limiters 206 and one or more of the electrode current collectors 214 and the electrode busbar 208 at the interfaces 220, 222, respectively. This reduced adhesion results in an increase in resistance. In particular, the adhesion is reduced when the current limiters 206 are at or above the transition temperature as compared to when the current limiters 206 are below the transition temperature. Reducing the adhesion may include generating voids at the interfaces 220, 222, a partial delamination at the interfaces 220, 222, a reduction in the contacting surfaces at the interfaces 220, 222, reducing a mechanical strength at the interfaces 220, 222, etc. Generally, the increase in resistance between the electrode busbar 208 and the electrode current collectors 214 may be due to an increase in the resistances at the interfaces 220, 222. Each of the interfaces 220, 222 have a contact resistance, the electrode current collectors 214 have a resistance, and the electrode busbar 208 has a resistance, and the current limiters 206 have a resistance, each of which is in series. By reducing the adhesion at the interfaces 220, 222, one or more of the contact resistances at the interfaces 220, 222 increases, resulting in an overall increase in the series resistance through the electrode current collectors 214 and the electrode busbar 208, independently of any change in resistance through the current limiters 206.

In other embodiments, the transition temperature may be selected to be an amount above the minimum expected temperature of the current limiters 206 during abnormal operation of the electrode assembly 200 to allow a minor abnormal operation to occur for a limited amount of time without melting the current limiters 206.

For example, one or more of the current limiters 206 may at least partially melt in response to an electrical short between the electrode structure 202 and the counter-electrode structure 204 of a unit cell, such as an electrical short between electrode active material 212 and the counter-electrode active material 216 (or between the electrode current collector 214 and the counter-electrode current collector 218) of a unit cell. The higher-than-normal currents flowing through the electrode current collector 214 and the current limiter 206 associated with the shorted unit cell heat the current limiter 206 to a temperature at or above the transition temperature, causing the current limiter 206 associated with the shorted unit cell to at least partially melt. The electrical short between the electrode active material 212 and the counter-electrode active material 216 may be generated, for example, by penetration by a foreign, conductive object, due to one or more electrically conductive dendrites that extend through the separator structures 205, by a foreign, conductive material inclusion within the assembly, or by any other occurrence that electrically connects the electrode active material 212 and the counter-electrode active material 216.

When the current limiters 206 at least partially melt, the adhesion between the current limiters 206 and the electrode current collector 214 at the interface 220 reduces and/or the adhesion between the current limiters 206 and the electrode busbar 208 at the interface 222 reduces. The reduced adhesion causes the electrical resistance between the electrode current collector 214 and the electrode busbar 208 to increase. The increased electrical resistance limits the amount of current that can flow between the electrode current collector 214 and the electrode busbar through the at least partially melted current limiter 206, thereby limiting the increase in temperature and preventing thermal runaway from occurring.

In some embodiments, the current limiters 206 comprise an adhesive polymer and a conductive material suspended in the polymer. In these embodiments, for example, the polymer at least partially melts at or above the transition temperature to reduce the adhesion between the current limiters 206 and the electrode current collectors 214 at the interface 220 and/or the adhesion between the current limiters 206 and the electrode busbar 208 at the interface 222, thereby increasing the electrical resistance between the electrode current collectors 214 and the electrode busbar 208. In some embodiments, the polymer comprises an electrical insulator.

At least partially melting the polymer, in an embodiment, increases a bulk resistivity of the current limiters 206, increasing the electrical resistance between the electrode current collectors 214 and the electrode busbar 208. In another embodiment, at least partially melting the polymer increases an interfacial resistance between the current limiters 206 and electrode current collector 214 at the interface 220 and/or increases the interfacial resistance between the current limiters 206 and the electrode busbar 208 at the interface 222, increasing the electrical resistance between the electrode current collectors 214 and the electrode busbar 208.

In some embodiments, at least partially melting the polymer modifies the electrical resistance of the current limiters 206 in other ways. In an embodiment, at least partially melting the polymer reduces a contact of the conductive material within the current limiters 206, which increases the volume resistivity of the current limiters 206 and increases the electrical resistance between the electrode current collectors 214 and the electrode busbar 208. In another embodiment, at least partially melting the polymer may cause the polymer and/or portions of the polymer to flow and/or wick into the region proximate to the interface 220 and/or flow and/or wick into the region proximate to the interface 222. The polymer flowing into such regions places more of the polymer between the conductive material in the current limiter 206 and the interface 220, 222, which increases the electrical resistance between the electrode current collectors 214 and the electrode busbar 208.

In some embodiments, the current limiters 206 at least partially char at or above the transition temperature, which increases the electrical resistance between the electrode current collectors 214 and the electrode busbar 208. In an embodiment, charring the current limiters 206 forms an electrical insulating layer between the current limiters 206 and the electrode current collectors 214 at the interface 220 and/or forms an electrical insulating layer between the current limiters 206 and the electrode busbar 208 at the interface 222, depending on the location of the charring.

In some embodiments, at least partially melting the current limiters 206 at least partially detaches the current limiters 206 from the electrode current collectors 214 at the interface 220 and/or at least partially detaches the current limiters 206 from the electrode busbar 208 at the interface 222, which increases the electrical resistance between the electrode current collectors 214 and the electrode busbar 208. In some embodiments, the detachment is not reversable. For example, the current limiters 206 may remain at least partially detached from the electrode current collectors 214 and/or the electrode busbar 208 at the interfaces 220, 222, respectively, even if the temperature of the current limiters 206 falls below the transition temperature. In this example, the electrode assembly 200 may continue to operate at a reduced energy capacity and/or a reduced current handling capacity. That is, the unit cell that experienced an abnormal event that caused its current limiter 206 to at least partially melt and permanently detach from its current collector 214 and/or the electrode busbar 208 will be inoperable to conduct current to the electrode busbar, but the remaining unit cells (which did not experience an abnormality causing their current limiter 206 to melt) may continue to conduct current to the electrode busbar 208.

In some embodiments, the current limiters 206 change volume based on changes in the temperature of the current limiters 206. In an embodiment, the current limiters 206 comprise a polymeric material and at least one phase change element that varies a volume of the current limiters 206 based on a temperature. In this embodiment, the phase change element facilitates the current limiters 206 expanding in volume based on changes in the temperature of the current limiters 206, which reduces the adhesion between the current limiters 206 and the electrode current collectors 214 at the interface 220 and/or reduces the adhesion between the current limiters 206 and the electrode busbar 208 at the interface 222, increasing the electrical resistance between the electrode current collectors 214 and the electrode busbar 208.

As discussed above, the current limiters 206 adhere to the electrode current collectors 214 and the electrode busbar 208 at the interfaces 220, 222, respectively, when the current limiters 206 are below a transition temperature. The transition temperature may be adjusted prior to assembling the electrode assembly 200 by modifying one or more design parameters of the current limiters 206 in order to specifically select the transition temperature where the current limiters 206 begin to change volume and/or the transition temperature where the current limiters 206 change volume by a threshold amount.

For example, the transition temperature may be the minimum expected temperature of the current limiters 206 during abnormal operation of the electrode assembly 200. The abnormal operation of the electrode assembly 200 may be, for example, exceeding the rated current and/or temperature of the electrode assembly 200. When the current limiters 206 are at or above the transition temperature, the current limiters 206 change in volume, reducing the adhesion between the current limiters 206 and one or more of the electrode current collectors 214 and the electrode busbar 208 at the interfaces 220, 222, respectively, which increases the electrical resistance between the electrode current collectors 214 and the electrode busbar 208. This reduced adhesion results in an increase in resistance. In particular, the adhesion is reduced when the current limiters 206 are at or above the transition temperature as compared to when the current limiters 206 are below the transition temperature. In other embodiments, the transition temperature may be selected to be an amount above the minimum expected temperature of the current limiters 206 during abnormal operation of the electrode assembly 200 to allow a minor abnormal operation to occur for a limited amount of time without changing the volume of the current limiters 206.

For example, one or more of the current limiters 206 may expand in volume in response to an electrical short between the electrode structure 202 and the counter-electrode structure 204 of a unit cell, such as an electrical short between the electrode active material 212 and the counter-electrode active material 216 (or between the electrode current collector 214 and the counter-electrode current collector 218 of the unit cell). The higher than normal currents flowing through the electrode current collector 214 and the current limiter 206 associated with the shorted unit cell heat the current limiters 206 to a temperature at or above the transition temperature, causing the current limiter 206 associated with the shorted unit cell to expand in volume. The electrical short between the electrode active material 212 and the counter-electrode active material 216 may be generated, for example, by penetration by a foreign, conductive object, due to one or more electrically conductive dendrites that extend through the separator structures 205, by a foreign, conductive material inclusion within the electrode assembly 200, or by any other occurrence that electrically connects the electrode active material 212 and the counter-electrode active material 216.

When the current limiters 206 expand in volume, the adhesion between the current limiters 206 and the electrode current collector 214 at the interface 220 reduces and/or the adhesion between the current limiters 206 and the electrode busbar 208 reduces. The reduced adhesion causes the electrical resistance between the electrode current collector 214 and the electrode busbar 208 to increase. The increased electrical resistance limits the amount of current that can flow between the electrode current collector 214 and the electrode busbar 208 through the expanded current limiter 206, thereby limiting the increase in temperature and preventing thermal runaway from occurring.

In an embodiment, below the transition temperature, the current limiters 206 adhere to the electrode current collectors 214 and the electrode busbar 208, at the interface 220, 222, respectively. Below the transition temperature, the current limiters 206 may have a first volume that is substantially constant. At or above the transition temperature, the current limiters 206 expand from the first volume towards a second volume, which reduces the adhesion between the current limiters 206 and the electrode current collectors 214 at the interface 220, and/or reduces the adhesion between the current limiters 206 and the electrode busbar 208 at the interface 222, increasing the resistance between the electrode current collectors 214 and the electrode busbar 208.

In some embodiments, increasing the volume of the current limiters 206 at least partially detaches the current limiters 206 from the electrode current collectors 214 at the interface 220 and/or at least partially detaches the current limiters 206 from the electrode busbar 208 at the interface 222, which increases the electrical resistance between the electrode current collectors 214 and the electrode busbar 208. In some embodiments, the detachment is not reversable. For example, the current limiters 206 may remain at least partially detached from the electrode current collectors 214 and/or the electrode busbar 208 at the interfaces 220, 222, respectively, even if the temperature of the current limiters 206 falls below the transition temperature. In this example, the electrode assembly 200 may continue to operate at a reduced energy capacity and/or a reduced current handling capacity. That is, the unit cell that experienced an abnormal event that caused its current limiter 206 to at least partially melt and permanently detach from its current collector 214 and/or the electrode busbar 208 will be inoperable to conduct current to the electrode busbar, but the remaining unit cells (which did not experience an abnormality causing their current limiter 206 to melt) may continue to conduct current to the electrode busbar 208.

Some non-limiting embodiments of the phase change element include one or more of expandable graphite, sodium carbonate, and calcium carbonate. In other embodiments, the phase change element includes any material which operates to modify the volume of the current limiters 206 based on temperature.

In some embodiments, the electrode current collectors 214 and/or the electrode busbar 208 at least partially detach from the current limiters 206 at or above a transition temperature. In this embodiment, the electrode current collectors 214 and the electrode busbar 208 adhere to the current limiters 206 at the interfaces 220, 222, respectively, below the transition temperature. However, at or above the transition temperature, the electrode current collectors 214 and/or the electrode busbar 208 at least partially detach from the current collectors at the interfaces 220, 222, respectively. The transition temperature may be adjusted prior to assembling the electrode assembly 200 by modifying one or more design parameters of the electrode current collectors 214 and/or the electrode busbar 208 in order to specifically select the transition temperature where the electrode current collectors 214 and/or the electrode busbar 208 at least partially detach from the current limiters 206. In some embodiments, the electrode busbar 208 and/or the electrode current collectors 214 comprise one or more of a bimetal, a trimetal, and/or nitinol.

The at least partial detachment at the interface 220 and/or the interface 222 may be due, for example, due to thermal stress applied by the current limiters 206 to the electrode current collector 214 and/or due to thermal stress applied by the current limiters 206 to the electrode busbar 208. For example, Joule heating of the electrode busbar 208 by one or more of the current limiters 206 may cause the electrode busbar to flex, warp, or deform, which at least partially detaches the current limiters 206 from the interface 220 and/or the interface 222. In another example, Joule heating of the electrode current collectors 214 by the current limiters 206 may cause the electrode current collector 214 to flex, warp, or deform, which at least partially detaches the current limiters 206 from the interface 220 and/or the interface 222. In another example, heating of the electrode current collectors 214 and/or the electrode busbar 208 may cause at least a partial detachment at the interfaces 220, 222, respectively.

For example, the transition temperature may be the minimum expected temperature of the electrode busbar 208 and/or the electrode current collectors 214 during abnormal operation of the electrode assembly 200. The abnormal operation of the electrode assembly 200 may be, for example, exceeding the rated current and/or temperature of the electrode assembly 200.

Partial detachment may increase the resistance between one or more of the electrode current collectors 214 and the electrode busbar 208, while a full detachment may generate an open circuit between one or more of the electrode current collectors 214 and the electrode busbar 208.

For example, at least a partial detachment may occur in response to an electrical short between the electrode structure 202 and the counter-electrode structure 204 of a unit cell, such as an electrical short between the electrode active material 212 and the counter-electrode active material 216 (or between the electrode current collector 214 and the counter-electrode current collector 218) of a unit cell. The higher-than-normal currents flowing through the electrode current collector 214 and the current limiter 206 associated with the shorted unit cell heat the current limiter 206 to a temperature at or above the transition temperature, causing the current limiter 206 associated with the shorted unit cell to at least partially detach. The electrical short between the electrode active material 212 and the counter-electrode active material 216 may be generated, for example, by penetration by a foreign, conductive object, due to one or more electrically conductive dendrites that extend through separator structures 205, by a foreign, conductive material inclusion withing the electrode assembly 200, or by any other occurrence that electrically connects the electrode active material 212 and the counter-electrode active material 216.

When the current limiters 206 at least partially detach, the adhesion between the current limiters 206 and the electrode current collector 214 at the interface 220 reduces and/or the adhesion between the current limiters 206 and the electrode busbar 208 at the interface 222 reduces. The reduced adhesion causes the electrical resistance between the electrode current collector 214 and the electrode busbar 208 to increase. The increased electrical resistance limits the amount of current that can flow between the electrode current collector 214 and the electrode busbar through the at least partially detached current limiter 206, thereby limiting the increase in temperature and preventing thermal runaway from occurring.

In some embodiments, the at least partial detachment is not reversable. For example, the current limiters 206 may remain at least partially detached from the electrode current collectors 214 and/or the electrode busbar 208 at the interfaces 220, 222, respectively, even if the temperature of the electrode current collectors 214 and/or the electrode busbar 208 falls below the transition temperature. In this example, the electrode assembly 200 may continue to operate at a reduced energy capacity and/or a reduced current handling capacity. In other embodiments, the at least partial detachment includes an electrical detachment between the electrode busbar 208 and the electrode current collectors 214.

Each unit cell of the population of unit cells of the electrode assembly 200 has an ionic resistance (also referred to as an internal resistance). In some embodiments, the current limiters 206 at least partially melt upon a formation of an electrical short in a member of the population of unit cells, when the electrical short has an electrical resistance that is less than the ionic resistance of the member of the population of unit cells in which the electrical short is formed. In embodiments where the current limiters 206 comprise at least one phase change element that expands a volume of the current limiters 206 at or above the transition temperature, the current limiters 206 expand from the first volume below the transition temperature towards the second volume at or above the transition temperature upon a formation of an electrical short in a member of the population of unit cells, when the electrical short has an electrical resistance that is less than the ionic resistance of the member of the population of unit cells in which the electrical short is formed. In some embodiments, at least one of the electrode current collectors 214 and the electrode busbar 208 at least partially detach from the current limiters 206 upon a formation of an electrical short in a member of the population of unit cells, when the electrical short has an electrical resistance that is less than the ionic resistance of the member of the population of unit cells in which the electrical short is formed. In other embodiments, at least one of the electrode current collectors 214 and the electrode busbar 208 electrically detach from the current limiters 206 upon a formation of an electrical short in a member of the population of unit cells, when the electrical short has an electrical resistance that is less than the ionic resistance of the member of the population of unit cells in which the electrical short is formed.

Each unit cell of the population of unit cells of the electrode assembly 200 has a capacity (C), and the current limiters 206 at least partially melt upon a passage of an electrical current through the current limiters 206 at a current of at least x times C. In embodiments where the current limiters 206 comprise at least one phase change element that expands a volume of the current limiters 206 at or above the transition temperature, the current limiters 206 expand from the first volume below the transition temperature towards the second volume at or above the transition temperature upon a passage of an electrical current through the current limiters 206 at a current of at least x times C. In other embodiments, at least one of the electrode current collectors 214 and the electrode busbar 208 at least partially detach from the current limiters 206 upon a passage of an electrical current through the current limiters 206 at a current of at least x times C. In other embodiments, at least one of the electrode current collectors 214 and the electrode busbar 208 electrically detach from the current limiters 206 upon a passage of an electrical current through the current limiters 206 at a current of at least x times C. In some embodiments, x is between about 1C to about 15, inclusive. In one embodiment, x is about 1. In another embodiment, x is about 2. In another embodiment, x is about 3. In another embodiment, x is about 4. In another embodiment, x is about 5. In another embodiment, x is about 6. In another embodiment, x is about 7. In another embodiment, x is about 8. In another embodiment, x is about 9. In another embodiment, x is about 10. In another embodiment, x is about 11. In another embodiment, x is about 12. In another embodiment, x is about 13. In another embodiment, x is about 14. In another embodiment, x is about 15. In some embodiments, a current of at least x times C is a C-rate of at least x times C, where C-rate and current are interchangeable. In these embodiments, x is from about 1C to about 15C, inclusive.

In some embodiments, the transition temperature is from about 60 degrees C. to about 125 degrees C. In another embodiment, the transition temperature is about 60 degrees C. In another embodiment, the transition temperature is about 65 degrees C. In another embodiment, transition temperature is about 70 degrees C. In another embodiment, the transition temperature is about 72 degrees C. In another embodiment, the transition temperature is about 75 degrees C. In another embodiment, the transition temperature is about 80 degrees C. In another embodiment, the transition temperature is about 85 degrees C. In another embodiment, the transition temperature is about 90 degrees C. In another embodiment, the transition temperature is about 95 degrees C. In another embodiment, the transition temperature is about 100 degrees C. In another embodiment, the transition temperature is about 105 degrees C. In another embodiment, the transition temperature is about 110 degrees C. In another embodiment, the transition temperature is about 115 degrees C. In another embodiment, the transition temperature is about 120 degrees C. In another embodiment, the transition temperature is about 125 degrees C.

For example, 60 degrees C. may be about the maximum temperature where a Li-ion cell should be expected to perform reliably for extended periods of time. 125 degrees C. is about the maximum temperature where a Li-ion cells could be expected to perform under abusive operating conditions if a diethyl carbonate-based electrolyte were employed (e.g., the boiling point of which is from about 126 degrees C. to about 128 degrees C. In another example, 72 degrees C. is about the maximum soak temperature where the Li-ion cells need to retain voltage under UN38.3, IEC62133, and UL1642 standards. In some embodiments the transition temperature may be about 85 degrees C. in embodiments where electrolyte salts begin to decompose and the battery may be irreversibly damaged (e.g., 85 degrees C. for LiPF6). In some embodiments, the transition temperature may be about 90 degrees C. where the electrolyte solvent begins to boil, and the battery may be irreversibly damaged (e.g., 90 degrees C. for dimethyl carbonate, which lowers the boiling point of linear alkyl carbonate solvents used for most electrolytes).

In some embodiments, the electrical resistance increases without completely detaching both the electrode busbar 308 and the electrode current collectors 214 from the current limiters 206. In other embodiments, the electrode busbar 208 is configured by design to flex, warp, or deform at or above the transition temperature to at least partially detach the electrode busbar 208 from at least one of the electrode current collector 214 and the current limiters 206. In other embodiments, electrode busbar 208 comprises a bimetal. In other embodiments, the electrode busbar 208 comprises a trimetal. In other embodiments, the electrode busbar 208 comprises nitinol.

In some embodiments, the electrode current collectors 214 are configured by design to flex, warp, or deform at or above the transition temperature to at least partially detach the electrode current collectors 214 from at least one of the electrode busbar 208 and the current limiters 206. In other embodiments, electrode current collectors 214 comprise a bimetal. In other embodiments, the electrode current collectors 214 comprise a trimetal. In other embodiments, the electrode current collectors 214 comprise nitinol.

In some embodiments, the electrode busbar 208 and/or the counter-electrode busbar 210 are thermally coupled to an enclosure (not shown in FIG. 2) in order to promote heat transfer from the electrode assembly 200 to the enclosure. In some embodiments, the enclosure is hermetically sealed. In some embodiments, the enclosure is a pouch for the electrode assembly 200. For example, Joule heating of the current limiters 206 may thermally heat the electrode busbar 208, which conducts heat away from the electrode assembly 200 to the pouch (not shown in FIG. 2). Other embodiments of the electrode assembly 200 includes current limiters 206 disposed between counter-electrode busbar 210 and counter-electrode current collectors 218, which may operate in a similar manner as described for FIG. 2.

The specific physical orientation and connections of the components of the electrode assembly 200 may be varied in different embodiments. In particular, the connections between and orientations of the electrode current collectors 214, the current limiters 206, and the electrode busbar 208 of the electrode assembly 200 may be varied. Several variations of the orientations and connections will be discussed below. All of the features discussed above with respect to FIG. 2 apply to the configurations discussed below unless explicitly stated otherwise.

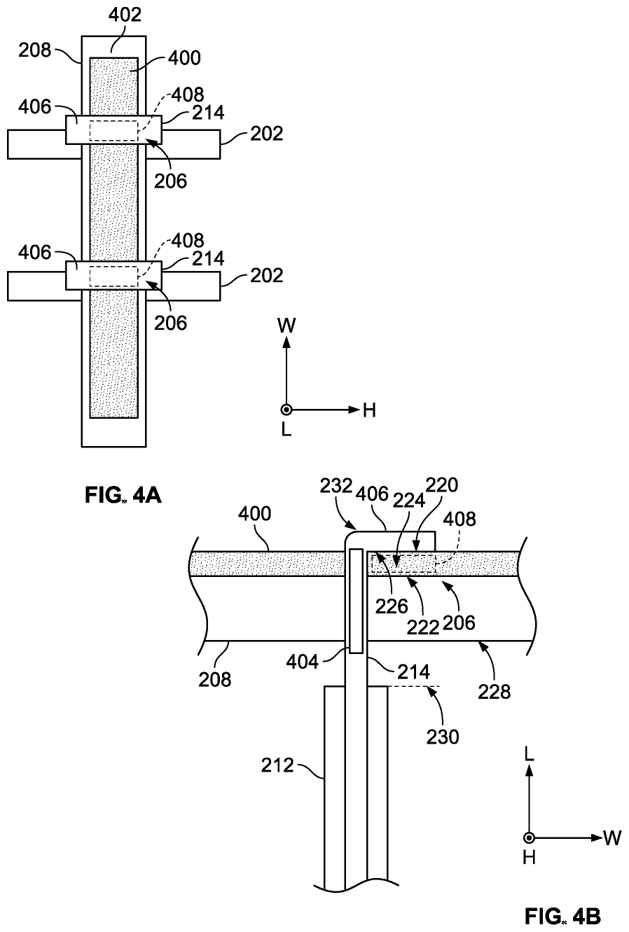

Referring now to FIGS. 4A and 4B, in some embodiments using the connection method shown in FIGS. 3A and 3B, the example current limiters 206 are comprised of a unitary layer 400 of a conductive adhesive disposed on the surface 402 of the electrode busbar 208 to which the electrode current collectors 214 will be welded. The electrode current collectors 214 include a slot 404 (FIG. 4B) and a portion 406, similar to the slot 300 and the portion 302 of the counter-electrode current collector 218 shown in FIGS. 3A and 3B, which are similarly used to connect the electrode current collectors 214 to the electrode busbar 108. Each individual current limiter 206 is a portion 408 of the unitary layer 400 located between the portion 406 of the current collector that is bent over and welded to the electrode busbar 208. In other embodiments, the conductive adhesive is applied on the electrode busbar 208 in individual portions, one for each electrode current collector 214 that will be connected to the electrode busbar 208. For example, the conductive adhesive is applied to the electrode busbar 208 around the location of the portion 406 over which the electrode current collector will be positioned when the portion 406 is bent over the electrode busbar. Each application of the conductive adhesive, and thus each current limiter 206, is physically separate from each other application of the conductive adhesive. In other embodiments, the conductive adhesive of the current limiters 206 is applied to each electrode current collector 214; such that the conductive adhesive will be positioned around the location of the portion 406 in FIG. 4B, and each current limiter 206 will be physically separated from the other current limiters 206. In other embodiments, the busbars are connected to the current collectors by any other suitable connective arrangement (e.g., without using a slot, with the busbar on top of the ends of the current collectors, etc.), with the conductive adhesive is positioned between the current collectors and the busbar(s). As discussed previously with respect to FIG. 2, the current limiters 206, formed by the portion 406 of the unitary layer 400, include the interfaces 220, 222 between the current limiters 206 and the electrode current collectors 214 and the electrode busbar 208, respectively.

In FIG. 4B, the interfaces 220, 222 are formed between the portion 406 of the electrode current collectors 214, the electrode busbar 208, and the portion 408 of the unitary layer 400. In particular, the interface 220 is formed between the portion 406 of the electrode current collectors 214 and the portion 408 of the unitary layer 400, and the interface 222 is formed between the electrode busbar 208 and the portion 408 of the unitary layer 400. The portion 408 of the unitary layer 400 adhere to the portion 406 of the electrode current collectors 214 and the electrode busbar 208 at the interfaces 220, 222, respectively. For example, during normal operating currents and temperatures for the portion 408 of the unitary layer 400, the interfaces 220, 220, respectively, form mechanical and electrical connections between the portion 408 of the unitary layer 400, the portion 406 of the electrode current collectors 214, and the electrode busbar 208.

In an embodiment, each member of the population of unit cells of the electrode assembly 200 has an ionic resistance, and the surface 228 of the electrode busbar and a surface 230 of the electrode active material layer 212 are separated by a separation distance. The separation distance between the surfaces 228, 230 decreases upon a formation of an electrical short in a member of the population of unit cells, where the electrical short has a resistance that is less than the ionic resistance of the member of the population of unit cells in which the electrical short is formed. In another embodiment, the surface 224 of the electrode busbar and the surface 226 of the portion 406 of the electrode current collector 214 are separated by a separation distance. The separation distance between the surfaces 224, 226 increase upon a formation of an electrical short in a member of the population of unit cells, where the electrical short has a resistance that is less than the ionic resistance of the member of the population of unit cells in which the electrical short is formed.

In another embodiment, each of the population of unit cells of the electrode assembly 200 has a capacity (C), and the surface 228 of the electrode busbar and a surface 230 of the electrode active material layer 212 are separated by a separation distance. The separation distance between the surfaces 228, 230 decreases upon a passage of an electrical current through the portion 408 of the unitary layer 400 at a current of at least x times C. In another embodiment, the surface 224 of the electrode busbar and the surface 226 of the portion 406 of the electrode current collector 214 are separated by a separation distance. The separation distance between the surfaces 224, 226 increases upon a passage of an electrical current through the portion 408 of the unitary layer 400 at a current of at least x times C. In some embodiments, x is from about 1 to about 15.

FIG. 18 illustrates another example embodiment in which the electrode current collectors 214 do not include the slot 300. The current limiters 206 are comprised of a unitary layer 1801 of a conductive adhesive disposed on the surface 228 of the electrode busbar 208 to which the electrode current collectors 214 will be attached. A portion 1802 of the electrode current collector 214 is bent to approximately a ninety-degree angle and the electrode busbar 208 is positioned over the portion 1802. It should be understood that the portion 1802 need not be bent to exactly ninety degrees and may be generally perpendicular to the rest of the current collector. The electrode busbar 208 is then attached to the portion 1802 of the electrode current collector 214, such as by gluing, welding, soldering, or using any other suitable technique for joining the electrode current collectors 214 to the electrode busbar 208. In an example embodiment, the electrode busbar 208 is attached to the portion 1802 by hot pressing the electrode busbar to soften the conductive adhesive and applying pressure to the busbar to adhere the electrode busbar 208 to the portion 1802 using the conductive adhesive. Although illustrated butted against the conductive adhesive, it should be understood that portions 1802 of the current collectors may extend into the conductive adhesive. Each individual current limiter 206 is a portion 1804 of the unitary layer 1801 located between the portion 1802 of the current collector that is bent over and attached to the electrode busbar 208.

In FIG. 18, the interfaces 220, 222 are formed between the portion 1802 of the electrode current collectors 214, the electrode busbar 208, and the portion 1804 of the unitary layer 1801. In particular, the interface 220 is formed between the portion 1802 of the electrode current collectors 214 and the portion 1804 of the unitary layer 1801, and the interface 222 is formed between the electrode busbar 208 and the portion 1804 of the unitary layer 1801. The portion 1804 of the unitary layer 1801 adhere to the portion 1802 of the electrode current collectors 214 and the electrode busbar 208 at the interfaces 220, 222, respectively. For example, during normal operating currents and temperatures for the portion 1804 of the unitary layer 1801, the interfaces 220, 220, respectively, form mechanical and electrical connections between the portion 1802 of the electrode current collectors 214 and the electrode busbar 208.

In an embodiment, each of the population of unit cells of the electrode assembly 200 has an ionic resistance, and the surface 228 of the electrode busbar and a surface 230 of the electrode active material layer 212 are separated by a separation distance. The separation distance between the surfaces 228, 230 increases upon a formation of an electrical short in a member of the population of unit cells, where the electrical short has a resistance that is less than the ionic resistance of the member of the population of unit cells in which the electrical short is formed. In another embodiment, the surface 228 of the electrode busbar 208 and the surface 232 of the portion 1802 of the electrode current collector 214 are separated by a separation distance. The separation distance between the surfaces 228, 232 increases upon a formation of an electrical short in a member of the population of unit cells, where the electrical short has a resistance that is less than the ionic resistance of the member of the population of unit cells in which the electrical short is formed.

In another embodiment, each of the population of unit cells of the electrode assembly 200 has a capacity (C), and the surface 228 of the electrode busbar 208 and the surface 230 of the electrode active material layer 212 are separated by a separation distance. The separation distance between the surfaces 228, 230 increases upon a passage of an electrical current through the portion 1804 of the unitary layer 1801 at a current of at least x times C. In another embodiment, the surface 228 of the electrode busbar 208 and the surface 232 of the portion 1802 of the electrode current collector 214 are separated by a separation distance. The separation distance between the surfaces 228, 232 increases upon a passage of an electrical current through the portion 1804 of the unitary layer 1801 at a current of at least x times C. FIG. 22 illustrates another example embodiment in which the electrode current collectors 214 do not include the slot 300. The current limiters 206 are comprised of the unitary layer 1801 of the conductive adhesive disposed on the surface 228 of the electrode busbar 208 to which the electrode current collectors 214 will be attached. In this embodiment, the electrode current collectors 214 extend substantially straight from the electrode active material 212, such that an end 2202 of the electrode current collector 214 is positioned adjacent to the surface 228 the electrode busbar 208. The electrode busbar 208 is then mechanically attached to the end 2202 of the electrode current collector 214, by the unitary layer of conductive adhesive, and/or by gluing, welding, soldering, or using any other suitable technique for joining the electrode current collectors 214 to the electrode busbar 208. In an example embodiment, the electrode busbar 208 is attached to the end 2202 by hot pressing the electrode busbar 208 to soften the conductive adhesive and applying pressure to the electrode busbar 208 to adhere the electrode busbar 208 to the end 2202 of the electrode current collector 214 using the conductive adhesive. Although illustrated as extending into the conductive adhesive, it should be understood that end 2202 of the electrode current collectors 214 may abut to the conductive adhesive. Each individual current limiter 206 is a portion 1804 of the unitary layer 1801 located between the end 2202 of the electrode current collector 214 and the surface 228 of the electrode busbar 208. The current limiters 206 formed from the portion 1804 of the unitary layer 1801 may operate similarly as previously described.

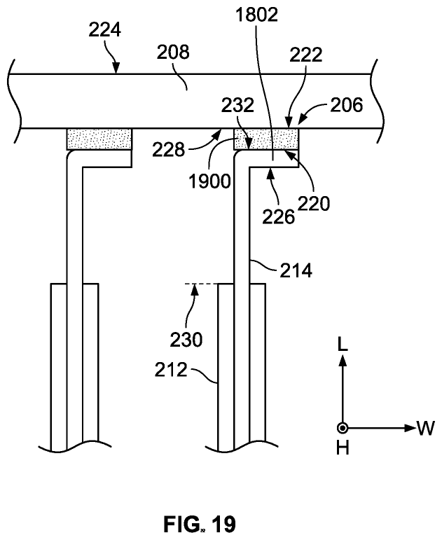

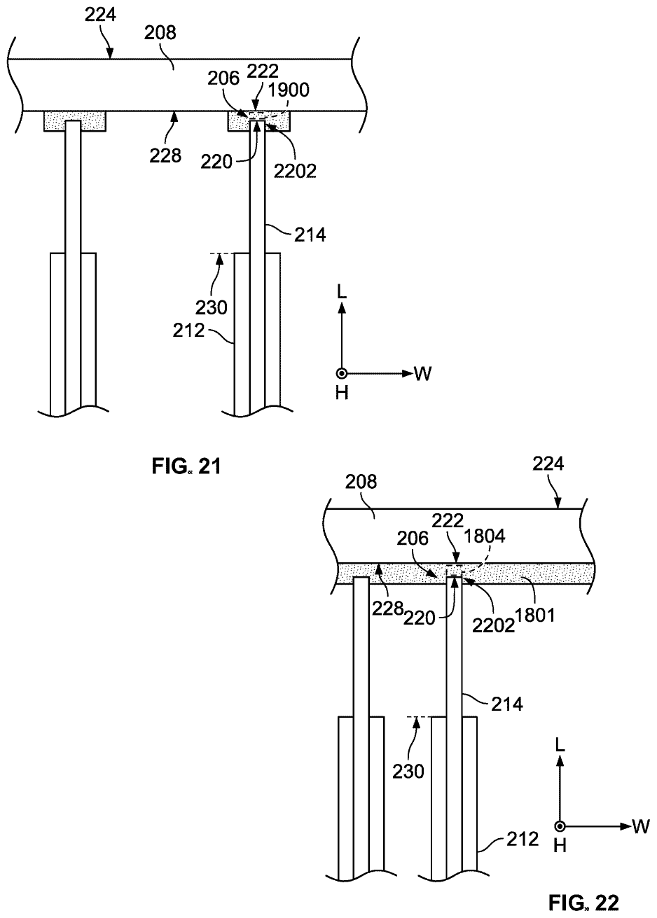

In other embodiments, as shown for example in FIGS. 19 and 21, the conductive adhesive is applied on the electrode busbar 208 in individual portions 1900, one for each electrode current collector 214 that will be connected to the electrode busbar 208. For example, the conductive adhesive is applied to the electrode busbar 208 around the location of the portion (e.g., 1802 in FIG. 19) of the electrode busbar over which the individual portion 1900 will be positioned. Each application of the conductive adhesive, and thus each current limiter 206, is physically separate from each other application of the conductive adhesive. In other embodiments, the conductive adhesive of the current limiters 206 is applied to each electrode current collector 214, such that the conductive adhesive will be positioned around the location of the portion (e.g., 1802 in FIG. 21), and each current limiter 206 will be physically separated from the other current limiters 206.

In FIG. 19, the interfaces 220, 222 are formed between the portion 1802 of the electrode current collectors 214, the electrode busbar 208, and the portion 1900 of the conductive adhesive. In particular, the interface 220 is formed between the portion 1802 of the electrode current collectors 214 and the portion 1900 of the conductive adhesive, and the interface 222 is formed between the electrode busbar 208 and the portion 1900 of the conductive adhesive. The portion 1900 of the conductive adhesive adhere to the portion 1802 of the electrode current collectors 214 and the electrode busbar 208 at the interfaces 220, 222, respectively. For example, during normal operating currents and temperatures for the portion 1900 of the conductive adhesive, the interfaces 220, 220, respectively, form mechanical and electrical connections between the portion 1900 of the conductive adhesive, the portion 1802 of the electrode current collectors 214, and the electrode busbar 208.

In another embodiment, each of the population of unit cells of the electrode assembly 200 has a capacity (C), and the surface 228 of the electrode busbar 208 and the surface 230 of the electrode active material layer 212 are separated by a separation distance. The separation distance between the surfaces 228, 230 increases upon a passage of an electrical current through the portion 1900 of the conductive adhesive at a current of at least x times C. In another embodiment, the surface 228 of the electrode busbar 208 and the surface 232 of the portion 1802 of the electrode current collector 214 are separated by a separation distance. The separation distance between the surfaces 228, 232 increases upon a passage of an electrical current through the portion 1900 of the conductive adhesive at a current of at least x times C.

In other embodiments, as shown for example in FIG. 21, the conductive adhesive is applied on the electrode busbar 208 in individual portions 1900, one for each electrode current collector 214 that will be connected to the electrode busbar 208. For example, the conductive adhesive is applied to the electrode busbar 208 around the location of the end 2202 over which the electrode current collector 214 will be positioned when the end 2202 is positioned adjacent to the electrode busbar 208. Each application of the conductive adhesive, and thus each current limiter 206, is physically separate from each other application of the conductive adhesive. In other embodiments, the conductive adhesive of the current limiters 206 is applied to each electrode current collector 214, such that the conductive adhesive will be positioned around the location of the end 2202, and each current limiter 206 will be physically separated from the other current limiters 206. The current limiters 206 formed from the portion 1900 of the conductive adhesive may operate similarly as previously described.

In still other embodiments, a resistor other than a conductive adhesive is used for the current limiters 206. For example, a conductive film having the desired resistance may be applied in a unitary strip to the electrode busbar 208, applied in individual portions to the electrode busbar, or applied in individual portions to each electrode current collector 214 in manners similar to the conductive adhesive. Alternatively, a non-adhesive conductive polymer may be applied in place of the conductive adhesive. Further, in some embodiments, discrete resistors may be electrically connected between the electrode current collectors 214 and the electrode busbar 208. The discrete resistors may be physically located between the electrode current collectors 214 and the electrode busbar 208 or may be physically outside of the interface between the electrode current collectors 214 and the electrode busbar 208, but electrically between the electrode current collectors 214 and the electrode busbar 208. The discrete resistors may be any suitable resistor, including wire wound resistors, thick film resistors, thin film resistors, carbon film resistors, carbon pile resistors, metal film resistors, foil resistors, or the like.

In some embodiments, one or more interface layers are included between the current limiters 206 and the electrode busbar 208 or between the current limiters 206 and the electrode current collectors 214. In general, the resistance between the electrode busbar 208 and each electrode current collector 214 is defined by the resistance of the current limiter 206, plus the resistance of the interface between the current limiter 206 and the electrode current collector 214, plus the resistance of the interface between the current limiter 206 and the electrode busbar 208. Generally, the interface resistances may be produced by imperfect (e.g., “real” connections rather than “ideal”) electrical connection between the current limiter 206 and the electrode busbar 208 and the electrode current collector 214. Without being limited to any particular theory, the imperfect electrical connection may be caused by, for example, microscope structural variations of the surface of the electrode busbar 208 and/or electrode current collector 214, the distribution and structure of conductive particles in the current limiter 206, and the like.

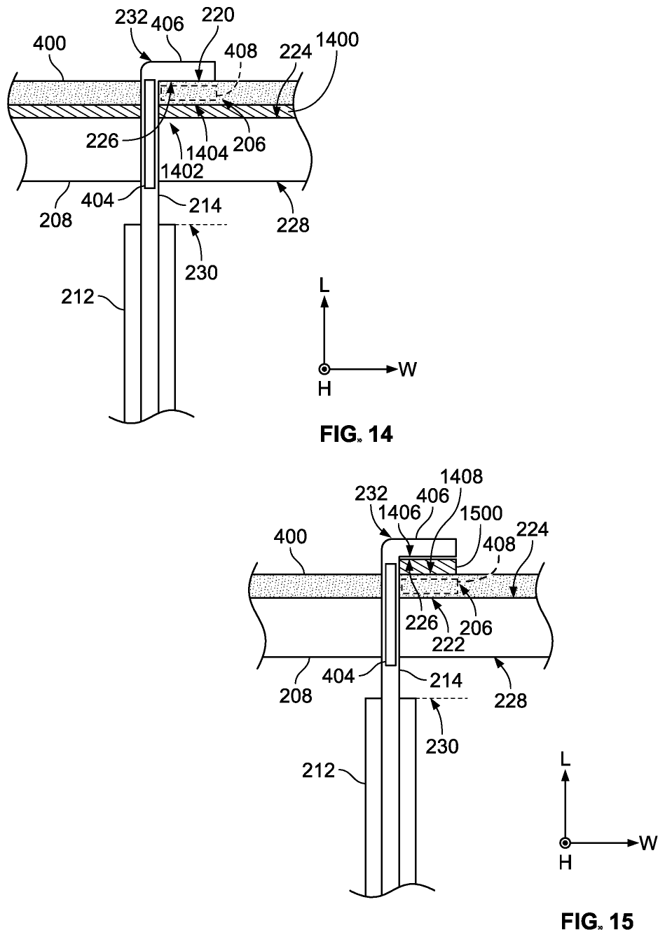

The interface layer is provided to improve the electrical connection between these components to reduce the series resistance of the electrical connection between the current limiter 206, the electrode busbar 208, and the electrode current collector 214. Referring now to FIGS. 14-16, embodiments similar to that shown in FIG. 4B is shown. Similar reference numbers in FIGS. 14-16 refer to similar components in FIG. 4B. In FIG. 14, an interface layer 1400 is applied to the electrode busbar 208. In this embodiment, the current limiter 206 is formed from portion 408 of unitary layer 400 and operates substantially the same as previously describe for FIGS. 4A and 4B.

In FIG. 14, the interface 220 is formed between the portion 406 of the electrode current collectors 214 and the portion 408 of the unitary layer 400, an interface 1402 is formed between the electrode busbar 208 and the interface layer 1400, and an interface 1404 is formed between the interface layer 1400 and the portion 408 of the unitary layer 400. During normal operation, adhesion is formed at interfaces 220, 1402, 1404. For example, during normal operating currents and temperatures for the portion 408 of the unitary layer 400, the interfaces 220, 1402, 1404 form mechanical and electrical connections between the portion 406 of the electrode current collectors 214 and the electrode busbar 208.

In FIG. 15, an interface layer 1500 is applied to electrode current collector 214. The interface layer 1500 may be applied to each electrode current collector 214, or less than all electrode current collectors 214.

In FIG. 15, the interface 222 is formed between the portion 408 of the unitary layer 400 and the electrode busbar 208, an interface 1406 is formed between the portion 406 of the electrode current collectors 214 and the interface layer 1500, and an interface 1408 is formed between the interface layer 1500 and the portion 408 of the unitary layer 400. During normal operation, adhesion is formed at interfaces 222, 1406, 1408. For example, during normal operating currents and temperatures for the portion 408 of the unitary layer 400, the interfaces 222, 1406, 1408 form mechanical and electrical connections between the portion 406 of the electrode current collectors 214 and the electrode busbar 208.

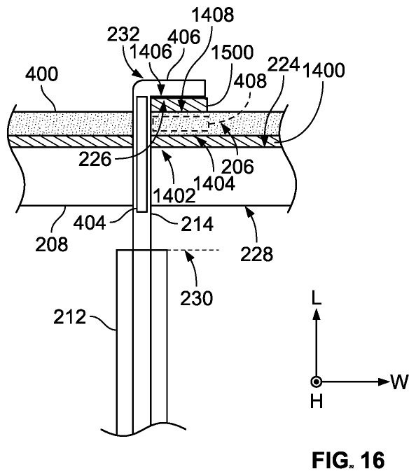

In FIG. 16, interface layer 1400 is applied to the electrode busbar 208 and interface layer 1500 is applied to electrode current collector 214.

In FIG. 16, the interface 1402 is formed between the electrode busbar 208 and the interface layer 1400, the interface 1404 is formed between the interface layer 1400 and the portion 408 of the unitary layer 400, the interface 1406 is formed between the portion 406 of the electrode current collectors 214 and the interface layer 1500, and the interface 1408 is formed between the interface layer 1500 and the portion 408 of the unitary layer 400. During normal operation, adhesion is formed at interfaces 1402, 1404, 1406, 1408. For example, during normal operating currents and temperatures for the portion 408 of the unitary layer 400, the interfaces 1402, 1404, 1406, 1408 form mechanical and electrical connections between the portion 406 of the electrode current collectors 214 and the electrode busbar 208.

In some embodiments, the interface layers 1400 and 1500 are carbon-based coatings. For example, the interface layers 1400 and/or 1500 may be coatings produced by slurry coating carbon nanotubes onto the electrode busbar 208 and/or the electrode current collector 214. In other embodiments, the interface layers are graphite coatings or any other suitable electrically conductive coating. In some embodiments, the interface layers 1400 and/or 1500 are applied using a hot anvil approach in which heat is applied to the electrode busbar 208 and/or the electrode current collector 214 to coat the electrode busbar 208 and/or the electrode current collector 214 with the selected materials to form the interface layers 1400 and/or 1500.

The conductive adhesive used in the current limiters 206 in the example embodiments is an adhesive polymer, copolymer, or blend with a conductive material suspended therein. In the example embodiments, the conductive adhesive is a thermoplastic material. In other embodiments, the conducive adhesive is a thermoset material. The adhesive polymer is substantially nonconducting (e.g., insulating) prior to suspension of the conductive material therein. Generally, desirable polymers are any that are (a) stable in the environment of a Li-ion battery cell (i.e. do not dissolve in the electrolytes, react with electrolyte components or any other battery components, or undergo redox chemistry or reactions that degrade the material during cell operation) and (b) have melting points above the typical working temperature of a Li-ion battery. Because adhesion is an important property of the conductive adhesive, polymers that exhibit adhesive qualities are desirable as at least one component of the conductive adhesive. Flexibility in the polymer is another desirable trait. Therefore, materials or blends of materials with some elasticity and particularly with a glass transition temperature (Tg) above 0° C. are preferred, but not required. In some embodiments, the conductive adhesive is a polymer blend with at least one component with a high elasticity (measured by standard methods such as modulus and/or elongation to break. In some embodiments, the adhesive polymer is a flowable adhesive polymer. In such embodiments, the conductive adhesive should have flow properties that allow for melt processing, including compounding of conductive aids and other additives if desired, film/sheet preparation by standard methods such as cast film, blown film, and calendering. For example, the melt flow index (12, 190° C., ASTM D1238) of the polymer blend used for the conductive adhesive should be in the range of 0.1 to 1000 grams (g)/10 minutes(min), preferably 0.1 to 100 g/10 min, most preferably 0.5 to 20 g/10 min. Melting points of the polymers used in the conductive adhesive should allow for melt processing and bonding to the cell via a melt press or related technique, and should be above the typical working temperature range of the cell.

Polymers that melt from 40° C. to 300° C. may be used for the conductive adhesive. Polymers with a melting point in the range of 60° C. to 200° C. are preferred, polymers with a melting point in the range of 70° C. to 165° C. are most preferred.

Example suitable adhesive polymers or copolymers for use in the conductive adhesive include EAA (ethylene-co-acrylic acid) and EMAA (ethylene-co-methacrylic acid), ionomers of the EAA or EMAA, polyethylene and copolymers thereof (such as, ethylene/1-octene, ethylene/1-hexene, ethylene/1-butene, and ethylene/propylene copolymers), polypropylene and copolymers thereof, a functionalized or derivatized polyethylene or polypropylene (such as, maleic anhydride grafted materials), or the like.

The conductive material suspended in the polymer to form the conductive adhesive may be any powder, fiber, particle, or the like that confers the desired conductivity to the conductive adhesive after compounding with the polymer blend. Most desirable are materials that confer the desired conductivity at lower loadings, because high loading of additives may change the properties of the polymer blend in undesirable ways. For example, high loadings may lead to a significant decrease in melt processability, impacting the ability to manufacture films or sheets of conductive polymer using conventional equipment. In addition, conductive additives are often expensive materials, and lower loadings are desirable to maintain a lower cost for manufacturing.

The conductive material may be metal powder or fiber, conductive carbon black, metal coated carbon fiber, and carbon nanotubes, or blends thereof. In various embodiments, the conductive material may be carbon black, nickel particles, copper particles, gold particles, silver particles, tin particles, titanium particles, graphite particles, molybdenum particles, platinum particles, chromium particles, aluminum particles, or any other metallic particles, including alloys. Preferable conductive materials for use in the conductive adhesive are metal coated carbon fibers and conductive carbon blacks, or blends thereof. The metal coated carbon fibers may be coated in nickel, copper, gold, silver, tin, titanium, molybdenum, platinum chromium, aluminum, or any other metallic coating, including alloys. In a most preferred example, the conductive materials include nickel coated carbon fibers and “superconductive” carbon blacks (examples include but are not limited to Nouryon Ketjenblack EC 300-J and EC 600-JD materials, Orion Printex XE2B, Cabot Vulcan XCmax™ 22).

For embodiments in which the conductive material is a fiber (such as a nickel coated carbon fiber), the conductive material will generally have an elongated shape. It is preferable in such embodiments for the fibers to have a relatively large aspect ratio (length to diameter). In one example embodiment, nickel coated carbon fibers used as the conductive material in the conductive adhesive have an aspect ratio of about 850:1. Other useful aspect ratios for conductive materials are from 10:1 to 10,000:1, preferably 50:1 to 5000:1, and most preferably 100:1 to 2000:1.

Loading of conductive material into the polymer to form the conductive adhesive may be in the range of 1% to 50% conductive material (as weight percent of the total mixture). Preferably the loading of conductive material is from 2% to 40%, and most preferably the loading is from 3% to 30%.

The resistivity of the conductive adhesive should be in the range of 5.0×10⁻⁷ and 5.0×10³ Ω-cm, preferably from 5.0×10⁻⁵ and 5.0×10¹ Ω-cm, and most preferably from 5.0×10⁻³ and 5.0×10⁻¹ Ω-cm. The polymer resistivity is measured by making a sheet or film of the polymer blend with conductive additive(s), then laminating that sheet or film to a copper test structure consisting of four rectangular bars adhered adjacent to one another in an array with defined interspacing. Lamination may be accomplished using methods such as a hot press or heated calender. Once lamination is complete, the resistivity measurement is accomplished using a typical four-point probe method, where the source probes apply a current through the sheet of film by contacting the two outermost bars and the sense probe measures the potential between the innermost bars allowing for determination of the bulk resistivity when the geometry of the four-point test structure array and thickness of the sheet or film is defined.

In an example embodiment, the conductive material is carbon black. The conductive adhesive is formed by mixing carbon black in the adhesive polymer until the adhesive polymer has a volume resistivity of between about 0.01 and 1.0 Ω-cm. The resistivity can be adjusted by adjusting the amount of carbon black added to the adhesive polymer. Adding more carbon black will decrease the resistivity (i.e., make it more conductive), and adding less carbon black will increase the resistivity (i.e., make it less conductive). In the example embodiment, carbon black is added to the adhesive polymer in an amount between 5% to 30% by weight to achieve the desired resistivity. The conductive adhesive so prepared is applied to the electrode busbar 208 at a thickness of between 20 microns and 200 microns thick. By adjusting the resistivity of the adhesive polymer and the thickness of application, the desired resistance for the current limiters 206 may be achieved.

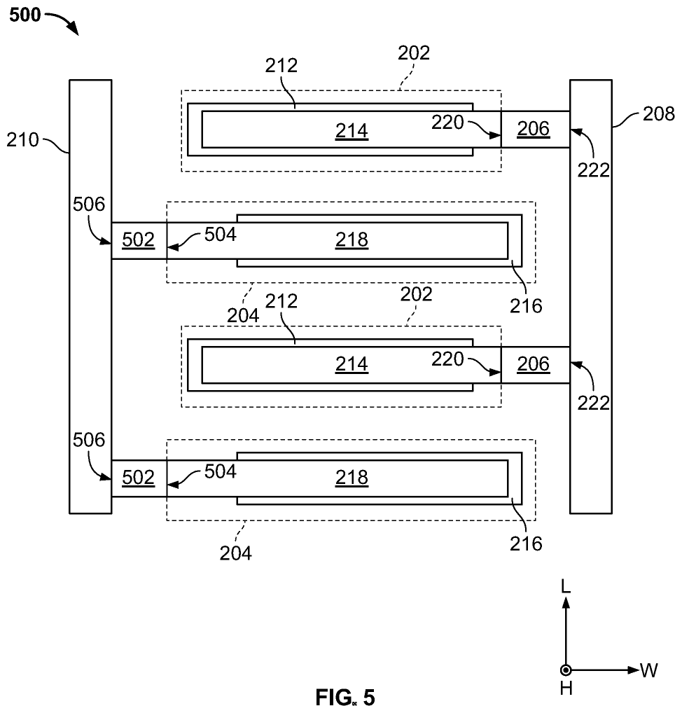

FIG. 5 is a simplified diagram of another example electrode assembly 500 for cycling between a charged state and a discharged state in a battery. The electrode assembly 500 is similar to the electrode assembly 200, and the same reference numbers are used to identify common components. The features and operation are the same as for electrode assembly 200, except as explicitly stated herein. For clarity of illustration, the separator structures 205 are not shown in FIG. 5 but are included in this example electrode assembly 500. Unlike the electrode assembly 200, the electrode assembly 500 includes a population of additional current limiters 502. The additional current limiters 502 are each electrically connected between a different one of the counter-electrode current collectors 218 and the counter-electrode busbar 210. In some embodiments, the additional current limiters 502 are the same as the current limiters 206 discussed above, and the connections are made in the same ways as the current limiters 206. However, in some embodiments, the additional current limiters 502 have a different composition and/or are different from the current limiters 206. For example, a conductive film may be used as the resistance for the additional current limiters 502, while a conductive adhesive is used in the current limiters 206. Alternatively, one type of conductive adhesive may be used in the current limiters 206, and a different type of conductive adhesive may be used in the additional current limiters 502. This may be especially useful when the counter-electrode busbar 210 and the electrode busbar 208 are made of different materials that may adhere to different conductive adhesives differently. As another example, the additional current limiters 502 may use different conductive materials suspended in the conductive adhesive than the current limiters 206. Further, in some embodiments, the additional current limiters 502 have a different resistance than the current limiters 206. In particular embodiments, the additional current limiters 502 have a resistance that is less than the resistance of the current limiters 206, including having a resistance of less than 0.25Ω, when the resistance of the current limiter 206 is sufficient to limit current below a threshold which would lead to a catastrophic failure.

In FIG. 5, interfaces 504, 506 are formed between the counter-electrode current collectors 218, the counter-electrode busbar 210, and the additional current limiters 502. In particular, the interface 504 is formed between the counter-electrode current collectors 218 and the additional current limiters 502, and the interface 506 is formed between the counter-electrode busbar 210 and the additional current limiters 502. The additional current limiters 502 adhere to the counter-electrode current collectors 218 and the counter-electrode busbar 210 at the interfaces 504, 506, respectively. For example, during normal operating currents and temperatures for the additional current limiters 502, the interfaces 504, 506, respectively, form mechanical and electrical connections between the additional current limiters 502, the counter-electrode current collectors 218, and the counter-electrode busbar 210.

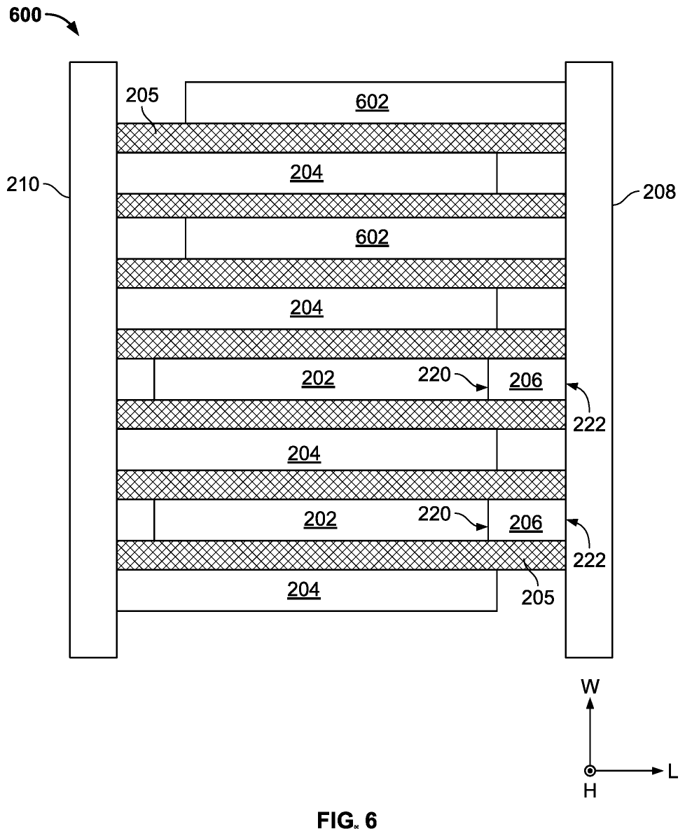

FIG. 6 is a simplified diagram of another example electrode assembly 600 for cycling between a charged state and a discharged state in a battery. The electrode assembly 600 is similar to the electrode assembly 200, and the same reference numbers are used to identify common components. The features and operation are the same as for electrode assembly 200, except as explicitly stated herein. Some details of the electrode structures 202 and the counter electrode structures 204 are removed for clarity of illustration, but all aspects of the electrode structures 202 and the counter electrode structures 204 discussed above are the same in the electrode assembly 600. Unlike the electrode assembly 200, the electrode assembly 600 includes a population of additional electrode structures 602 that are connected directly to the electrode busbar 208. That is, the additional electrode structures 602 are connected to the electrode busbar 208 without a current limiter 206.

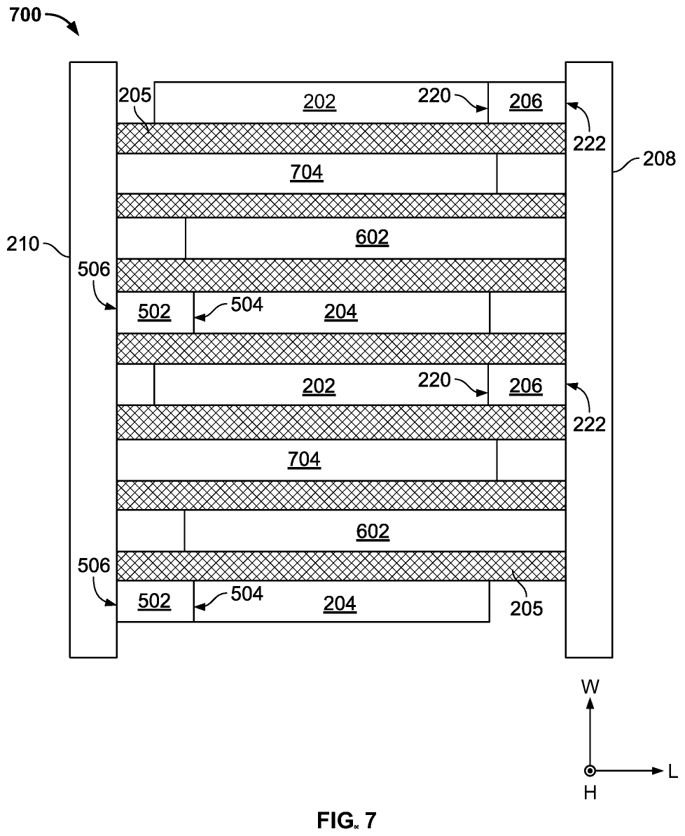

FIG. 7 is a simplified diagram of another example electrode assembly 700 for cycling between a charged state and a discharged state in a battery. The electrode assembly 700 is similar to the electrode assembly 500, and the same reference numbers are used to identify common components. The features and operation are the same as for electrode assembly 200, except as explicitly stated herein. Some details of the electrode structures 202 and the counter electrode structures 204 are removed for clarity of illustration, but all aspects of the electrode structures 202 and the counter electrode structures 204 discussed above are the same in the electrode assembly 700. Unlike the electrode assembly 500, the electrode assembly 500 includes the population of additional electrode structures 602 and a population of additional counter-electrode structures 704 that are all connected directly to the electrode busbar 208. That is, the additional electrode structures 602 and the additional counter-electrode structures 704 are connected to the electrode busbar 208 without a current limiter 206 or an additional current limiter 502. Current limiters 206 and additional current limiters 502 operate substantially the same as previously described for FIGS. 2 and 5, for electrode structures 202 and counter-electrode structures 204.

FIG. 9 is an example stacked cell 900 created as part of the manufacture of a secondary battery. To form a secondary battery, an electrode assembly, such as the electrode assembly 200, 500, 600, or 700 is first assembled. Electrode structures 202, counter-electrode structures 204, and (if applicable) additional electrode structures 602 and/or additional counter-electrode structures 704 are assembled. The formed electrode, counter-electrode, additional electrode, and additional counter-electrode structures 202, 204, 602, 704 will be referred to as “electrode sub-units” in the following paragraphs. A predetermined number of electrode sub-units are stacked in a stacking direction (e.g., in the width direction in FIG. 2) with separator structures 205 to form the multi-unit electrode stack. Generally, at least ten electrode structures 202 and at least ten counter-electrode structures 204 are included in the multi-unit electrode stack. In some embodiments at least twenty electrode structures 202 and at least twenty counter-electrode structures 204 are included in the multi-unit electrode stack. Other embodiments may include any suitable number of electrode structures 202 and at least ten counter-electrode structures 204 in the multi-unit electrode stack. The multi-unit electrode stack is then placed in a pressurized constraint having pressure plates that apply pressure to the multi-unit electrode stack to adhere all of the electrode sub-units together.

In the multi-unit electrode stack, the electrode structure and the counter-electrode structure extend in a longitudinal direction perpendicular to the stacking direction (e.g., in the length direction in FIG. 2). An end portion (for example the portion of the electrode current collector 214 extending above the rest of the electrode structure 202 in FIGS. 4B, 14, 15, 16, 18, and 19) of the electrode current collector extends past the electrode active material and the separator structure in the longitudinal direction. The end portion that extends above the electro active material and the separator structure is bent to be approximately perpendicular to the longitudinal direction of the electrode structure and to extend in the stacking direction or opposite the stacking direction, as shown in FIGS. 4B, 14, 15, 16, 18, and 19. In the embodiments without a slot (e.g., FIGS. 18 and 19), the end portion is bent before the electrode busbar is positioned extending in the stacking direction with a surface of the electrode busbar in contact with the end portions (that is the bent end portion) of the electrode current collectors. In an exemplary embodiment, a conductive adhesive layer (e.g., conductive adhesive discussed herein and functioning as a current limiting device) is located between the surface of the electrode busbar and the end portions of the electrode current collectors. In some embodiments, the conductive adhesive layer is disposed on the surface of the electrode busbar in contact with the electrode current collectors. In other embodiments, the conductive adhesive layer is disposed on the electrode current collectors. In still other embodiments, the conductive adhesive layer is a separate layer positioned between the electrode busbar and the electrode current collectors. Heat and pressure are applied to the electrode busbar to adhere the end portions of the electrode current collectors to the busbar through the conductive adhesive layer. The heat applied may be from 100° C. to 300° C., preferably 125° C. to 250° C., and most preferably from 150° C. to 225° C. The pressure may be from 10 psi to 1000 psi, preferably from 15 psi to 750 psi, and more preferably 20 psi to 500 psi.

In the embodiments using a slot in the current collector (e.g., FIGS. 4B and 14-16), the busbar is inserted through the slots before the current collector is bent. In such embodiments, the electrode busbar 208 and the counter-electrode busbar 210 are placed through the slots 404, 300 (shown in FIGS. 3A-4B) of the respective current collectors 214, 218 with the current limiters 206 (and if applicable, the additional current limiters 502) between the busbars 208, 210 and the current collectors 214, 218. Once the busbars 208, 210 have been placed through the slots 404, 300 the portions 406, 302 are folded down toward their respective busbars 208, 210 respectively. The electrode busbar 208 is welded to the portion 406 of the electrode current collector 214, and the counter-electrode busbar 210 is welded to the portion 302 of the counter-electrode current collector 218. The welds may be made using a laser welder, friction welding, ultrasonic welding or any suitable welding method for welding busbars 208, 210 to the current collectors 214, 218. After welding of the busbars to the multi-unit electrode stack, the stacked cell 900 is complete, and may be placed in a battery formed pouch, metal can, or other suitable container. In other embodiments, any other suitable method of connecting the electrode busbar 208 and the counter-electrode busbar 210 to the current collectors may be used, including methods without slots, attaching the busbars on top of tabs on the current collectors, and the like.

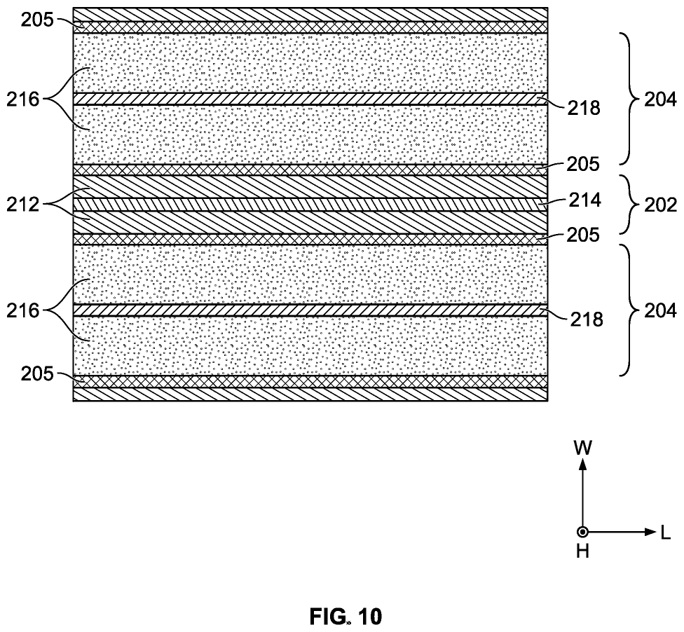

FIG. 10 is a portion of a top view (i.e. as viewed from the height direction H) of the stacked cell 900. The portion of the stacked cell 900 shown in FIG. 9 includes one electrode structure 202 and two counter-electrode structures 204. In this example, the electrode structure 202 is the anode electrode structure, and the counter-electrode structures 204 are the cathode electrode structures.

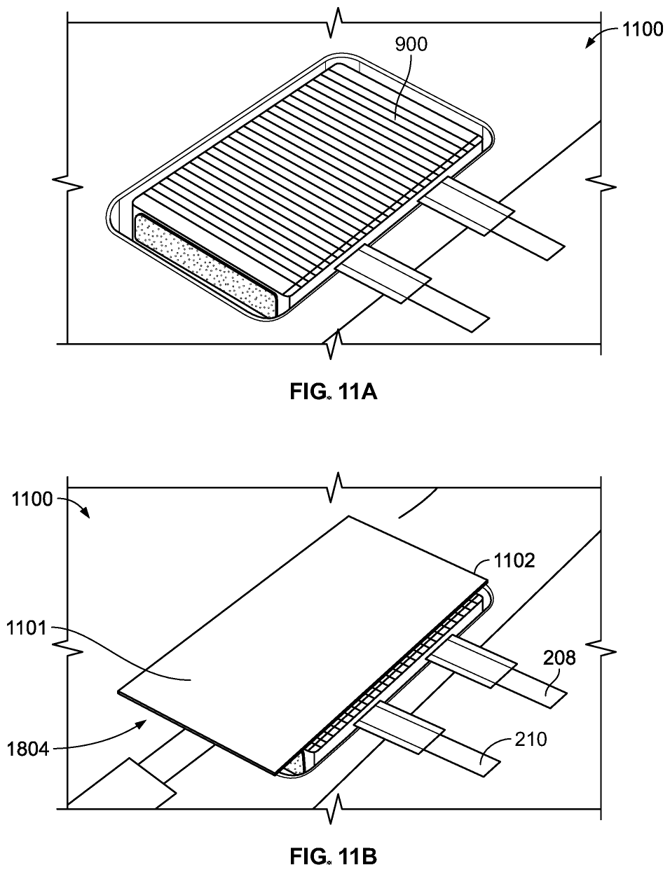

With reference to FIGS. 11A and 11B, after formation of the stacked cell 900, the stacked cell 900 proceeds to a packaging station 1100, where the stacked cell 900 is coated with an insulating packaging material 1101, such as a multi-layer aluminum polymer material, plastic, or the like, to form a battery package 1102. In one embodiment, the battery package 1102 is evacuated using a vacuum and filled through an opening (not shown) with an electrolyte material. The insulating packaging material may be sealed around stacked cell 900 using a heat seal, laser weld, adhesive or any suitable sealing method. After sealing, the battery insulated packing material forms a sealed enclosure. The ends of the busbars 208 and 210 remain exposed, and are not covered by battery package 1102, and the exposed ends function as an electrode terminal and a counter-electrode terminal external to the sealed battery enclosure. The exposed ends of the busbar allow a user to connect the busbars to a device to be powered or to a battery charger. In other embodiments separate external electrode and counter-electrode terminals are welded to the busbars 208 and 210 and are positioned external to the sealed battery package 1102. In some embodiments, the connection between such external electrode and counter-electrode terminals is located within the battery package 1102, and the ends of the busbars 208, 210 do not extend outside of the battery package 1102.

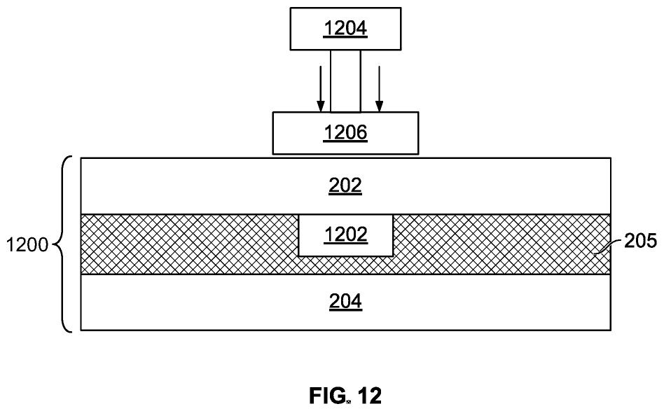

Referring now to FIG. 12, a wet (i.e., the unit cells include a liquid electrolyte) forced internal short circuit (FISC) assay used to determine the thermal runaway current (Iₜᵣ) used in equation (6) may be performed. The FISC assay is an iterative test. The test is performed on an electrode assembly including n unit cells (where n is a positive integer). Each unit cell includes a single electrode structure 202 adjacent a single counter electrode 204 with separator structure 205 between them and including a current limiter 206. The first iteration is performed with an electrode assembly where n=1 (i.e., there is a single unit cell) that is electrically disconnected from any other electrode structures 202, 204. FIG. 12 shows the electrode assembly to be tested including the single unit cell 1200. Note that FIG. 12 is not to scale. To perform the test, a conductive particle 1202 is positioned in the area between the unit cell's fully-charged positive and negative electrodes (e.g., on the separator structure 205 between the electrode structure 202 and the counter-electrode structure 204). In one example, the conductive particle 1202 is a 2 mm×0.2 mm×0.1 mm L-shaped nickel particle. In other embodiments, the conductive particle 1202 may have any other suitable shape and/or may be made of any other suitable conductive material. A servo-motor 1204 press displaces a 5 mm×5 mm flat acrylic resin indenter 1206 at a speed of 1.0 mm/s onto the unit cell 1200 at the location where the embedded conductive particle is located. This causes the conductive particle 1202 to electrically connect the electrode structure 202 and the counter-electrode structure 204 in a short circuit. The servo-motor 1204 continues to displace the indenter 1206 until a voltage drop of more than 80% of the unit cell's voltage has occurred. If the unit cell 1200 experiences catastrophic failure (e.g., the unit cell 1200 catches fire or explodes), the test is stopped. If a single unit cell 1200 fails the test, the configuration of the failed unit cell is not a candidate for use of this test to determine the thermal runaway current (Iₜᵣ), and a different test, estimation, simulation, etc. must be performed to determine the thermal runaway current (Iₜᵣ) for this configuration of a unit cell 1200. Moreover, if the single unit cell 1200 fails the test, the configuration of the failed unit cell may not be a good candidate for use with the current limiters described herein, because the resistance needed for the current limiters in order to suitably limit the current will likely be high enough to incur undesirable energy losses under normal charging and discharging.

If the unit cell 1200 does not experience catastrophic failure, the unit cell 1200 configuration passes the first iteration, n is incremented by 1, and a new assembly including a two unit cells (i.e., n=2) is assembled, with one of the unit cells being configured with the conductive particle 1202 as discussed above for the first step. The FISC test is repeated for this new assembly with two unit cells. If the new assembly passes the test, the above steps in this paragraph are performed again. That is, a new assembly with n=n+1 unit cells is assembled with one of the unit cells including the conductive particle, and the FISC test is performed again. The worst case forced internal short circuit resistance is given in each step by:

$${R}_{s , WCFISC} ( n ) = {R}_{20 kHz ( Vtoc , n )} \qquad ( 9 )$$

In this example, the 20 kHz impedance is used, but the impedance at any other suitable, nonzero frequency may be used. This iteration repeats until an electrode assembly fails the test. Once one of the electrode assemblies fails the test, the test is stopped. The number of unit cells from the last successful iteration (i.e., the electrode assembly having the current value of n−1 unit cells) is used to determine the thermal runaway current (Iₜᵣ). The thermal runaway current (Iₜᵣ) is given by:

$${I}_{tr = \frac{{V}_{TOC}}{2 {R}_{20 kHz ( {V}_{TOC} , n - 1 )}}} \qquad ( 10 )$$

The thermal runaway current (Iₜᵣ) determined from equation (10) is then used in inequality (6) to determine the resistance needed for each current limiter 206, and an electrode assembly may be produced including the current limiters 206 each having the determined resistance.

Although discussed above beginning with a single unit cell and n=1, the above assay may begin with any suitable, non-zero number of unit cells. For example, if it is expected (e.g., estimated, calculated, or the like) that a particular unit cell configuration will fail the test at n=4, the test may be begun at n=3 with an electrode assembly including three unit cells.

The actual short circuit resistance for use as Rₛ in equation (6) may be determined using a dry FISC assay. The dry FISC assay is similar to the FISC assay discussed above, but is performed on one or more unit cells. In the dry FISC assay, one or more unit cells without any electrolyte is subjected to a FISC using the assembly and techniques described above with reference to FIG. 12. That is, the unit cell (including a single electrode structure 202 adjacent a single counter electrode 204 with separator structure 205) has a conductive particle 1202 positioned in the area between the unit cell's positive and negative electrodes (e.g., on the separator structure 205 between the electrode structure 202 and the counter-electrode structure 204), and the indenter 1206 crushes the unit cell to cause the conductive particle 1202 to electrically connect the electrode structure 202 and the counter-electrode structure 204 in a short circuit. The actual short circuit resistance of the shorted unit cell is then measured and may be used in equation (6).

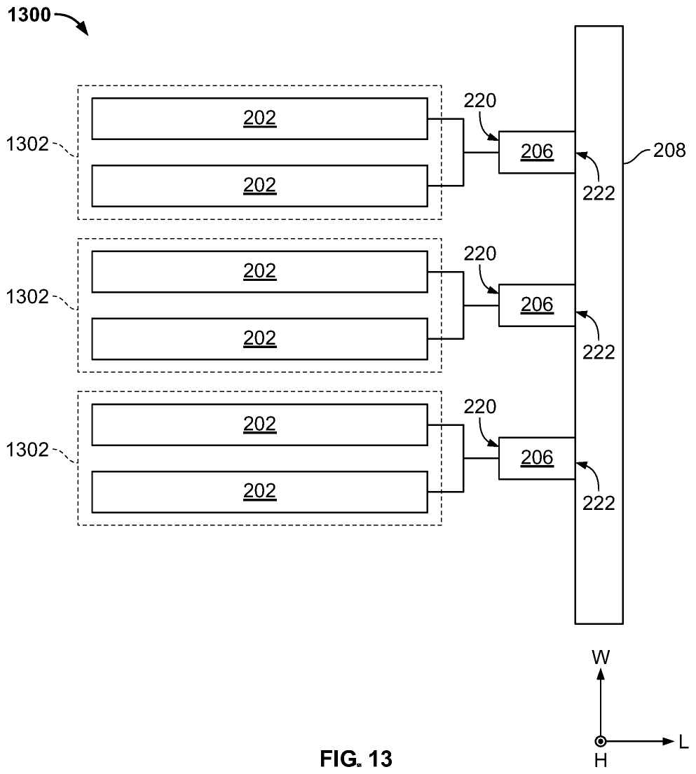

FIG. 13 is a simplified diagram of a portion of another electrode assembly 1300 for cycling between a charged state and a discharged state in a battery. The electrode assembly 1300 includes similar components to the electrode assemblies described above, and the components are the same unless otherwise specified. The population of counter-electrode structures, the population of separator structures, and the counter-electrode busbar are omitted from the figure for clarity. The population of current limiters 206 in the electrode assembly 1300 has fewer members than the population of electrode structures 202. The population of electrode structures is divided into groups 1302 of electrode structures 202. Each group 1302 of electrode structures 202 includes two electrode structures 202 in FIG. 13. In other embodiments, the groups 1302 may include any number of electrode structures 202, as long as the group includes more than one electrode structure 202. Each electrode structure 202 in a group 1302 is electrically connected to the other electrode structures 202 in its group 1302 in parallel. The parallel connection of electrode structures 202 in a group 1302 is connected to the electrode busbar 208 by a single current limiter 206. That is, all of the electrode structures in a group 1302 share a single current limiter 206. Other embodiments may additionally or alternatively include a similar grouped arrangement of counter-electrode structures 204 sharing a single current limiter 206. Moreover, in some embodiments, some of the electrode structures 202 and/or some of the counter-electrode structures 204 in the electrode assembly may be grouped as described above, while other electrode structures 202 and/or counter-electrode structures 204 in the assembly are not grouped and each have their own current limiter 206.

The resistance of the current limiters 206 in the electrode assembly 1300 is determined by a variation of inequality (6) discussed above. Specifically, the resistance of the shared current limiters 206 in the electrode assembly 1300 is determined to satisfy:

$$\frac{{V}_{TOC}}{{R}_{s , WCFISC} + {[ {( \frac{{R}_{bl}}{n} )}^{- 1} + {( {R}_{cld} + {R}_{t} + \frac{{R}_{bl} + {R}_{cld}}{N - 1} )}^{- 1} ]}^{- 1}} < {I}_{tr} , \qquad ( 11 )$$

where n is the number of unit cells (or the number of electrode structures 202) in a group 1302.

In some embodiment, the resistance of the current limiters 206 is defined by a relationship between the resistance of the current limiter and a cell resistance of unit cells. Specifically, within a range of normal operating temperatures between negative 30 degrees Celsius (° C.) and 80° C., each unit cell has a cell resistance R1. Each current limiter has a resistance R2 such that:

$$R 2 / R 1 > 0.01 \qquad ( 12 )$$

when the electrode assembly is within the range of normal operating temperatures. The exact value of the ratio of R2/R1 may vary depending on the capacity and/or voltage of the battery. In example embodiments R2/R1 is approximately equal to 0.5, 0.95, or 0.0275. In some embodiments, R2/R1 may be greater than 0.1, greater than 0.5, greater than 0.95, or greater than 0.1.

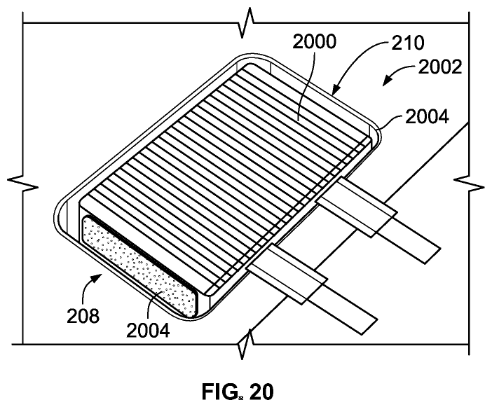

FIG. 20 is another example stacked cell 2000 created as part of the manufacture of a secondary battery. To form a secondary battery, an electrode assembly, such as the electrode assembly 200, 500, 600, or 700 is first assembled. Electrode structures 202, counter-electrode structures 204, and (if applicable) additional electrode structures 602 and/or additional counter-electrode structures 704 are assembled. The formed electrode, counter-electrode, additional electrode, and additional counter-electrode structures 202, 204, 602, 704 will be referred to as “electrode sub-units” in the following paragraphs. A predetermined number of electrode sub-units are stacked in a stacking direction (e.g., in the width direction in FIG. 2) with separator structures 205 to form the multi-unit electrode stack. Generally, at least ten electrode structures 202 and at least ten counter-electrode structures 204 are included in the multi-unit electrode stack. In some embodiments at least twenty electrode structures 202 and at least twenty counter-electrode structures 204 are included in the multi-unit electrode stack. Other embodiments may include any suitable number of electrode structures 202 and at least ten counter-electrode structures 204 in the multi-unit electrode stack. The multi-unit electrode stack is then placed in a pressurized constraint having pressure plates that apply pressure to the multi-unit electrode stack to adhere all of the electrode sub-units together.

In the multi-unit electrode stack, the electrode structure and the counter-electrode structure extend in a longitudinal direction perpendicular to the stacking direction (e.g., in the length direction in FIG. 2). An end portion (for example the portion of the electrode current collector 214 extending above the rest of the electrode structure 202 in FIGS. 18 and 19) of the electrode current collector extends past the electrode active material and the separator structure in the longitudinal direction. In some embodiments, the end portion that extends above the electro active material and the separator structure is bent to be approximately perpendicular to the longitudinal direction of the electrode structure and to extend in the stacking direction or opposite the stacking direction, as shown in FIGS. 18 and 19. In some of the embodiments without a slot (e.g., FIGS. 18 and 19), the end portion is bent before the electrode busbar is positioned extending in the stacking direction with a surface of the electrode busbar in contact with the end portions (that is the bent end portion) of the electrode current collectors. In still other embodiments, the end portion that extends above the electro active material and the separator structure is not bent at all, as shown in FIGS. 21 and 22. In an exemplary embodiment, a conductive adhesive layer (e.g., conductive adhesive discussed herein and functioning as a current limiting device) is located between the surface of the electrode busbar and the end portions of the electrode current collectors. In some embodiments, the conductive adhesive layer is disposed on the surface of the electrode busbar in contact with the electrode current collectors. In other embodiments, the conductive adhesive layer is disposed on the electrode current collectors. In still other embodiments, the conductive adhesive layer is a separate layer positioned between the electrode busbar and the electrode current collectors. Heat and pressure are applied to the electrode busbar to adhere the end portions of the electrode current collectors to the busbar through the conductive adhesive layer. The heat applied may be from 100° C. to 300° C., preferably 125° C. to 250° C., and most preferably from 150° C. to 225° C. The pressure may be from 10 psi to 1000 psi, preferably from 15 psi to 750 psi, and more preferably 20 psi to 500 psi.

As discussed briefly with respect to FIG. 2, in some embodiments, the electrode busbar 208 and/or the counter-electrode busbar 210 are thermally coupled to a pouch 2002, which is at least partially thermally conductive, for the electrode assemblies 200, 500, 600, or 700, in order to promote heat transfer from the electrode busbar 208 and/or the counter-electrode busbar 210 to the pouch 2002. For example, Joule heating of the current limiters 206 may thermally heat the electrode busbar 208, and/or Joule heating of the additional current limiters 502 may heat the counter-electrode busbar 210, which conducts heat away from the electrode assemblies 200, 500, 600, or 700 to the pouch 2002. In this embodiment, a thermally conductive material 2004 is applied to the electrode busbar 208 and/or the counter-electrode busbar 210 and contacts the electrode busbar 208 and/or the counter-electrode busbar 210 and the pouch 2002. In some embodiments, the thermally conductive material 2004 is an electrically insulating material to avoid electrically coupling the electrode busbar 210 to the pouch 2002. In some embodiments, the pouch is made of an electrically insulating material. The thermally conductive material 2004 allows for heat generated by current limiters 206 and/or additional current limiters 502 and applied to electrode busbar 208 and/or counter-electrode busbar 210 to transfer to the pouch 2002 via the thermally conductive material 2004, which removes heat from the stacked cell 2000 and reduces the possibility of a thermal runaway for the stacked cell 2000 during an abnormal operation for the stacked cell 2000.

For example, one or more of the current limiters 206 (see FIG. 2) may be subjected to excessive Joule heating, due to the currents flowing through and heating the current limiters 206 in response to an electrical short between the electrode active material 212 and the counter-electrode active material 216. During these types of abnormal events, heat generated by the current limiters 206 also heats the electrode busbar 208, which thermally transfers this heat to the pouch 2002 via the thermally conductive material 2004. This heat transfer removes heat from the stacked cell 2000 and reduces the risk of fire and/or thermal runaway for the stacked cell 2000.

In another example, one or more of the additional current limiters 502 (see FIG. 5) may be subjected to excessive Joule heating, due to the currents flowing through and heating the additional current limiters 502 in response to an electrical short between the electrode active material 212 and the counter-electrode active material 216. During these types of abnormal events, heat generated by the additional current limiters 502 also heats the counter-electrode busbar 210, which thermally transfers this heat to the pouch 2002 via the thermally conductive material 2004. This heat transfer removes heat from the stacked cell 2000 and reduces the risk of fire and/or thermal runaway for the stacked cell 2000.

In some embodiments, the thermally conductive material 2004 includes an epoxy, glue, or other type of material that secures the electrode busbar 208 and/or the counter-electrode busbar 210 to the pouch 2002.

The following embodiments are provided to illustrate aspects of the disclosure, although the embodiments are not intended to be limiting and other aspects and/or embodiments may also be provided.

Embodiment 1. An electrode assembly for cycling between a charged state and a discharged state, the electrode assembly comprising: a population of unit cells stacked atop each other in a stacking direction, each member of the population of unit cells including an electrode structure, a separator structure, and a counter-electrode structure, wherein: the electrode structure comprises an electrode current collector and an electrode active material layer, the electrode structure extends in a longitudinal direction perpendicular to the stacking direction, an end portion of the electrode current collector extends past an outer surface of the electrode active material layer and the separator structure in the longitudinal direction; and the counter-electrode structure comprises a counter-electrode current collector and a counter-electrode active material layer, the counter-electrode structure extends in a longitudinal direction perpendicular to the stacking direction; an adhesive layer comprising a resistive polymeric material; and an electrode busbar extending in the stacking direction and having a first surface and a second surface opposite the first surface, the first surface positioned adjacent to the end portions of the electrode current collectors, the first surface being attached to the end portions of the electrode current collectors through the adhesive layer.

Embodiment 2. The electrode assembly of Embodiment 1, wherein: (i) the adhesive layer is configured to adhere with the electrode busbar and the electrode current collectors below a transition temperature, and (ii) the adhesive layer is configured to at least partially melt at or above the transition temperature to increase an electrical resistance between the electrode busbar and the electrode current collectors.

Embodiment 3. The electrode assembly of any previous Embodiment, wherein: (i) each member of the population of unit cells has an ionic resistance, and (ii) the adhesive layer is configured to at least partially melt upon a formation of an electrical short in a member of the population of unit cells, the electrical short having an electrical resistance that is less than the ionic resistance of the member of the population of unit cells in which the electrical short is formed.

Embodiment 4. The electrode assembly of any previous Embodiment, wherein: (i) each member of the population of unit cells has a capacity (C), and (ii) the adhesive layer is configured to at least partially melt upon a passage of an electrical current through the adhesive layer of a member of the population of unit cells at a current of at least x times C of the member of the population of unit cells.

Embodiment 5. The electrode assembly of any previous Embodiment, wherein: (i) the resistive polymeric material comprises at least one phase change element that is configured to expand a volume of the adhesive layer at or above a transition temperature, (ii) the adhesive layer has a first volume below the transition temperature; and (iii) the adhesive layer is configured to expand from the first volume towards a second volume at or above the transition temperature to increase an electrical resistance between the electrode busbar and the electrode current collectors.

Embodiment 6. The electrode assembly of any previous Embodiment, wherein: (i) each member of the population of unit cells has an ionic resistance, (i) the resistive polymeric material comprises at least one phase change element that is configured to expand a volume of the adhesive layer at or above a transition temperature, (ii) the adhesive layer has a first volume below the transition temperature; and (iii) the adhesive layer is configured to expand from the first volume towards a second volume at or above the transition temperature upon the formation of an electrical short in a member of the population of unit cells, the electrical short having an electrical resistance that is less than the ionic resistance of the member of the population of unit cells in which the electrical short is formed.

Embodiment 7. The electrode assembly of any previous Embodiment, wherein: (i) each member of the population of unit cells has a capacity (C), (i) the resistive polymeric material comprises at least one phase change element that is configured to expand a volume of the adhesive layer at or above a transition temperature, (ii) the adhesive layer has a first volume below the transition temperature; and (iii) the adhesive layer is configured to expand from the first volume towards a second volume at or above the transition temperature upon a passage of an electrical current through the adhesive layer of a member of the population of unit cells at a current of at least x times C of the member of the population of unit cells.

Embodiment 8. The electrode assembly of any previous Embodiment, wherein: (i) each member of the population of unit cells has an ionic resistance, (ii) the first surface of the electrode busbar and the outer surface of the electrode active material layer are separated by a separation distance, and (iii) the separation distance between the first surface of the electrode busbar and the outer surface of the electrode active material layer increases upon a formation of an electrical short in a member of the population of unit cells, the electrical short having an electrical resistance that is less than the ionic resistance of the member of the population of unit cells in which the electrical short is formed.

Embodiment 9. The electrode assembly of any previous Embodiment, wherein: (i) each member of the population of unit cells has a capacity (C), (ii) the first surface of the electrode busbar and the outer surface of the electrode active material layer are separated by a separation distance, and (iii) upon a passage of an electrical current through the adhesive layer of a member of the population of unit cells at a current of at least x times C of the member of the population of unit cells, the separation distance between the first surface of the electrode busbar and the outer surface of the electrode active material layer increases.

Embodiment 10. The electrode assembly of any previous Embodiment, wherein: (i) each member of the population of unit cells has an ionic resistance, (ii) the first surface of the electrode busbar and the outer surface of the electrode active material layer are separated by a separation distance, and (iii) the separation distance between the first surface of the electrode busbar and the outer surface of the electrode active material layer decreases upon a formation of an electrical short in a member of the population of unit cells, the electrical short having an electrical resistance that is less than the ionic resistance of the member of the population of unit cells in which the electrical short is formed.

Embodiment 11. The electrode assembly of any previous Embodiment, wherein: (i) each member of the population of unit cells has a capacity (C), (ii) the first surface of the electrode busbar and the outer surface of the electrode active material layer are separated by a separation distance, and (iii) upon a passage of an electrical current through the adhesive layer of a member of the population of unit cells at a current of at least x times C of the member of the population of unit cells, the separation distance between the first surface of the electrode busbar and the outer surface of the electrode active material layer decreases.

Embodiment 12. The electrode assembly of any previous Embodiment, wherein: (i) each member of the population of unit cells has an ionic resistance, (ii) the first surface of the electrode busbar and the and the end portions of the electrode current collectors are separated by a separation distance, and (iii) the separation distance between the first surface of the electrode busbar and the end portions of the electrode current collectors increases upon a formation of an electrical short in a member of the population of unit cells, the electrical short having an electrical resistance that is less than the ionic resistance of the member of the population of unit cells in which the electrical short is formed.

Embodiment 13. The electrode assembly of any previous Embodiment, wherein: (i) each member of the population of unit cells has a capacity (C), (ii) the first surface of the electrode busbar and the end portions of the electrode current collectors are separated by a separation distance, and (iii) upon a passage of an electrical current through the adhesive layer of a member of the population of unit cells at a current of at least x times C of the member of the population of unit cells, the separation distance between the first surface of the electrode busbar and the end portions of the electrode current collectors increases.

Embodiment 14. The electrode assembly of any previous Embodiment, wherein: (ii) the resistive polymeric material has a melting point at a temperature defined by a design parameter of the adhesive layer, (iii) the adhesive layer has a first electrical resistance between the electrode busbar and the electrode current collectors below the temperature, and (iv) the electrical resistance of the adhesive layer increases from the first electrical resistance towards a second electrical resistance at or above the temperature as the adhesive layer partially melts.

Embodiment 15. The electrode assembly of any previous Embodiment, wherein: (i) the electrode busbar and the electrode current collectors are configured to adhere to the adhesive layer below a transition temperature, and (ii) at least one of the electrode busbar and the electrode current collectors are configured to at least partially detach from the adhesive layer at or above the transition temperature.

Embodiment 16. The electrode assembly of any previous Embodiment, wherein: (i) each member of the population of unit cells has an ionic resistance, and (ii) at least one of the electrode busbar and the electrode current collectors are configured to at least partially detach from the adhesive layer upon a formation of an electrical short in a member of the population of unit cells, the electrical short having an electrical resistance that is less than the ionic resistance of the member of the population of unit cells in which the electrical short is formed.

Embodiment 17. The electrode assembly of any previous Embodiment, wherein: (i) each member of the population of unit cells has a capacity (C), and (ii) at least one of the electrode busbar and the electrode current collectors are configured to at least partially detach from the adhesive layer upon a passage of an electrical current through the adhesive layer of a member of the population of unit cells at a current of at least x times C of the member of the population of unit cells.

Embodiment 18. The electrode assembly of any previous Embodiment, wherein: (i) the electrode busbar and the electrode current collectors are configured to adhere to the adhesive layer below a transition temperature, and (ii) at least one of the electrode busbar and the electrode current collectors are configured to electrically detach from the adhesive layer at or above the transition temperature.

Embodiment 19. The electrode assembly of any previous Embodiment, wherein: (i) each member of the population of unit cells has an ionic resistance, and (ii) at least one of the electrode busbar and the electrode current collectors are configured to electrically detach from the adhesive layer upon a formation of an electrical short in a member of the population of unit cells, the electrical short having an electrical resistance that is less than the ionic resistance of the member of the population of unit cells in which the electrical short is formed.

Embodiment 20. The electrode assembly of any previous Embodiment, wherein: (i) each member of the population of unit cells has a capacity (C), and (ii) at least one of the electrode busbar and the electrode current collectors are configured to electrically detach from the adhesive layer upon a passage of an electrical current through the adhesive layer of a member of the population of unit cells at a current of at least x times C of the member of the population of unit cells.

Embodiment 21. The electrode assembly of any previous Embodiment, wherein: an end portion of each electrode current collector is bent in a direction orthogonal to the longitudinal direction of the electrode structure and extends in the stacking direction or opposite the stacking direction.

Embodiment 22. The electrode assembly of any previous Embodiment, wherein the resistive polymeric material comprises a thermoplastic material.

Embodiment 23. The electrode assembly of any previous Embodiment, wherein the resistive polymeric material comprises an adhesive polymer and a conductive material suspended in the adhesive polymer.

Embodiment 24. The electrode assembly of Embodiment 23, wherein the conductive material comprises nickel particles.

Embodiment 25. The electrode assembly of Embodiment 23, wherein the conductive material comprises metallic particles.

Embodiment 26. The electrode assembly of Embodiment 23, wherein the conductive material comprises one or more of carbon black, nickel, copper, gold, silver, titanium, graphite, molybdenum, chromium, and aluminum.

Embodiment 27. The electrode assembly of Embodiment 23, wherein the conductive material comprises metal coated carbon fibers.

Embodiment 28. The electrode assembly of Embodiment 27, wherein the metal coated carbon fibers comprise nickel coated carbon fibers.

Embodiment 29. The electrode assembly of Embodiment 27, wherein the metal coated carbon fibers have a length and a diameter and an aspect ratio of the length to the diameter of the metal coated carbon fibers is equal to or greater than 10:1

Embodiment 30. The electrode assembly of Embodiment 29, wherein the metal coated carbon fibers have a length and a diameter and an aspect ratio of the length to the diameter of the metal coated carbon fibers is between 10:1 and 10,000:1 inclusive.

Embodiment 31. The electrode assembly of Embodiment 30, wherein the aspect ratio of the length to the diameter is between 50:1 and 5,000:1 inclusive.

Embodiment 32. The electrode assembly of Embodiment 31, wherein the aspect ratio of the length to the diameter is between 100:1 and 2,000:1 inclusive.

Embodiment 33. The electrode assembly of Embodiment 32, wherein the aspect ratio of the length to the diameter is about 850:1.

Embodiment 34. The electrode assembly of any previous Embodiment, wherein the adhesive layer comprises a hot-melt adhesive polymer.

Embodiment 35. The electrode assembly of any previous embodiment, wherein a melt flow index of the resistive polymeric material determined according to ASTMD 1238 at 190° C. is between 0.1 to 1000 grams (g)/10 minutes (min).

Embodiment 36. The electrode assembly of Embodiment 35, wherein the melt flow index is between 0.1 to 100 g/10 min.

Embodiment 37. The electrode assembly of Embodiment 36, wherein the melt flow index is between 0.5 to 20 g/10 min.

Embodiment 38. The electrode assembly of any previous Embodiment, wherein a melting point of the resistive polymeric material is between 40° C. and 300° C.

Embodiment 39. The electrode assembly of Embodiment 38, wherein the melting point of the resistive polymeric material is between 60° C. and 200° C.

Embodiment 40. The electrode assembly of Embodiment 39, wherein the melting point of the resistive polymeric material is between 70° C. and 165° C.

Embodiment 41. The electrode assembly of any previous Embodiment, wherein: an end portion of each counter-electrode current collector extends past the counter-electrode active material layer and the separator structure in the longitudinal direction opposite of the end portions of the electrode current collectors, the end portion of each counter-electrode current collector bent to be approximately perpendicular to the longitudinal direction of the counter-electrode structure and to extend in the stacking direction or opposite the stacking direction; and a counter-electrode busbar is positioned with a surface of the counter-electrode busbar in contact with the end portions of the counter-electrode current collectors and extending in the stacking direction, and the counter-electrode busbar is attached to the end portions of the counter-electrode current collectors.

Embodiment 42. The electrode assembly of Embodiment 41, wherein the surface of the counter-electrode busbar is in contact with the end portions of the counter-electrode current collectors and has a counter-electrode adhesive layer comprising the resistive polymeric material disposed thereon, and the counter-electrode busbar is attached to the end portions of the counter-electrode current collectors by the counter-electrode adhesive layer.

Embodiment 43. The electrode assembly of any previous Embodiment, wherein the adhesive layer has a resistivity greater than or equal to 0.01 Ω·cm.

Embodiment 44. The electrode assembly of any previous Embodiment, wherein the adhesive layer has a resistivity less than or equal to 1.0 Ω·cm.

Embodiment 45. The electrode assembly of any previous Embodiment, wherein the adhesive layer comprises one of ethylene-co-acrylic acid, an ionomer of ethylene-co-acrylic acid, and a polymer of ethylene-co-acrylic acid.

Embodiment 46. The electrode assembly of any previous Embodiment, wherein the adhesive layer comprises one of ethylene-co-methacrylic acid, an ionomer of ethylene-co-methacrylic acid, and a polymer of ethylene-co-methacrylic acid.

Embodiment 47. The electrode assembly of any previous Embodiment, wherein the adhesive layer comprises a functionalized polyethylene.

Embodiment 48. The electrode assembly of any previous Embodiment, wherein the adhesive layer comprises a functionalized polypropylene.

Embodiment 49. The electrode assembly of any previous Embodiment, wherein the resistive polymeric material comprises a polymer and a conductive material suspended in the polymer, and wherein the polymer is configured to at least partially melt at or above a transition temperature to increase a bulk resistivity of the adhesion layer.

Embodiment 50. The electrode assembly of any previous Embodiment, wherein the resistive polymeric material comprises a polymer and a conductive material suspended in the polymer, and wherein the polymer is configured to at least partially melt at or above a transition temperature to increase a bulk resistivity of the adhesion layer.

Embodiment 51. The electrode assembly of any previous Embodiment, wherein the resistive polymeric material comprises a polymer and a conductive material suspended in the polymer, and wherein the polymer is configured to at least partially melt at or above a transition temperature to increase an interfacial resistance between the adhesive layer and at least one of the electrode busbar and the electrode current collectors.

Embodiment 52. The electrode assembly of any previous Embodiment, wherein the resistive polymeric material comprises a polymer and a conductive material suspended in the polymer, and wherein the polymer is configured to at least partially melt at or above a transition temperature to reduce a contact of the conductive material within a bulk of the adhesion layer and increase a volume resistivity of the adhesion layer.

Embodiment 53. The electrode assembly of any previous Embodiment, wherein the resistive polymeric material comprises a polymer and a conductive material suspended in the polymer, and wherein the polymer is configured to at least partially melt at or above a transition temperature and flows and/or wicks in at interfaces between the conductive material.

Embodiment 54. The electrode assembly of any previous Embodiment, wherein the resistive polymeric material comprises a polymer and a conductive material suspended in the polymer, and wherein the polymer is configured to at least partially melt at or above a transition temperature and flows and/or wicks in at interfaces between the adhesion layer and at least one of the electrode busbar and the electrode current collectors.

Embodiment 55. The electrode assembly of any previous Embodiment, wherein the resistive polymeric material comprises a polymer and a conductive material suspended in the polymer, and wherein the polymer is an electrical insulator.

Embodiment 56. The electrode assembly of any previous Embodiment, wherein the adhesive layer is configured to at least partially char at or above a transition temperature to increase the electrical resistance between the electrode busbar and the electrode current collectors.

Embodiment 57. The electrode assembly of any previous embodiment, wherein the adhesive layer is configured to at least partially char at or above a transition temperature to form an electrically insulating layer between the adhesion layer and at least one of the electrode busbar and the electrode current collectors.

Embodiment 58. The electrode assembly of any previous Embodiment, wherein at least partially detaching from at least one of the electrode busbar and the electrode current collectors is irreversible.

Embodiment 59. The electrode assembly of any previous Embodiment, wherein the at least one phase change element comprises expandable graphite.

Embodiment 60. The electrode assembly of any previous Embodiment, wherein the at least one phase change element comprises sodium carbonate.

Embodiment 61. The electrode assembly of any previous Embodiment, wherein the at least one phase change element comprises calcium carbonate.

Embodiment 62. The electrode assembly of any previous Embodiment, wherein x is from about 1 to about 15.

Embodiment 63. The electrode assembly of Embodiment 62, wherein x is about 1.

Embodiment 64. The electrode assembly of Embodiment 62, wherein x is about 2.

Embodiment 65. The electrode assembly of Embodiment 62, wherein x is about 3.

Embodiment 66. The electrode assembly of Embodiment 62, wherein x is about 4.

Embodiment 67. The electrode assembly of Embodiment 62, wherein x is about 5.

Embodiment 68. The electrode assembly of Embodiment 62, wherein x is about 6.

Embodiment 69. The electrode assembly of Embodiment 62, wherein x is about 7.

Embodiment 70. The electrode assembly of Embodiment 62, wherein x is about 8.

Embodiment 71. The electrode assembly of Embodiment 62, wherein x is about 9.

Embodiment 72. The electrode assembly of Embodiment 62, wherein x is about 10.

Embodiment 73. The electrode assembly of Embodiment 62, wherein x is about 11.

Embodiment 74. The electrode assembly of Embodiment 62, wherein x is about 12.

Embodiment 75. The electrode assembly of Embodiment 62, wherein x is about 13.

Embodiment 76. The electrode assembly of Embodiment 62, wherein x is about 14.

Embodiment 77. The electrode assembly of Embodiment 62, wherein x is about 15.

Embodiment 78. The electrode assembly of any previous embodiment, wherein the resistive adhesive layer is not a fuse.

Embodiment 79. A secondary battery comprising the electrode assembly of any previous Embodiment.

Embodiment 80. The secondary battery of Embodiment 79, wherein the electrode assembly is contained within a hermetically sealed enclosure.

Embodiment 81. The secondary battery of Embodiment 79, wherein the electrode assembly is contained within a hermetically sealed enclosure and the hermetically sealed enclosure is a pouch.

Embodiment 82. The secondary battery of Embodiment 79, wherein the electrode assembly is contained within a hermetically sealed enclosure, and the second surface of the electrode busbar and the hermetically sealed enclosure are in contact with a thermally conductive material.

Embodiment 83. The electrode assembly or secondary battery of any previous embodiment, wherein (i) members of the population of electrode structures are anode structures and members of the population of counter-electrode structures are cathode structures, or (ii) members of the population of electrode structures are cathode structures and members of the population of electrode structures are anode structures.

Embodiment 84. The electrode assembly or secondary battery of any previous embodiment, wherein members of the population of electrode structures are anode structures comprising anodically active material layers, and members of the population of counter-electrode structures are cathode structures comprising cathodically active material layers.

Embodiment 85. The electrode assembly or secondary battery of any previous embodiment, wherein carrier ions are contained within the hermetically sealed battery enclosure.

Embodiment 86. The electrode assembly or secondary battery of any previous embodiment, wherein members of the population of electrode structures comprises anode active material comprising any one of more of carbon materials, graphite, soft or hard carbons, metals, semi-metals, alloys, oxides, compounds capable of forming an alloy with lithium, tin, lead, magnesium, aluminum, boron, gallium, silicon, Si/C composites, Si/graphite blends, SiOx, porous Si, intermetallic Si alloys, indium, zirconium, germanium, bismuth, cadmium, antimony, silver, zinc, arsenic, hafnium, yttrium, lithium, sodium, lithium titanate, palladium, lithium metals, carbon, petroleum cokes, activated carbon, graphite, silicon compounds, silicon alloys, tin compounds, non-graphitizable carbon, graphite-based carbon, LiₓFe₂O₃ (0≤x≤1), LiₓWO₂ (0≤x≤1), SnₓMe₁₋ₓMe′_{y}O_{z} (Me: Mn, Fe, Pb, Ge; Me′: Al, B, P, Si, elements found in Group 1, Group 2 and Group 3 in a periodic table, halogen; 0<x≤1; 1≤y≤3; 1≤z≤8), a lithium alloy, a silicon-based alloy, a tin-based alloy; a metal oxide, SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, Bi₂O₅, a conductive polymer, polyacetylene, Li—Co—Ni-based material, crystalline graphite, natural graphite, synthetic graphite, amorphous carbon, Kish graphite, pyrolytic carbon, mesophase pitch-based carbon fibers, meso-carbon microbeads, mesophase pitches, graphitized carbon fiber, high-temperature sintered carbon, petroleum, coal tar pitch derived cokes, tin oxide, titanium nitrate, lithium metal film, an alloy of lithium and one or more types of metals selected from the group consisting of Na, K, Rb, Cs, Fr, Be, Mg, Ca, Sr, Ba, Ra, Al and Sn, a metal compound capable of alloying and/or intercalating with lithium selected from any of Si, Al, C, Pt, Sn, Pb, Ir, Ni, Cu, Ti, Na, K, Rb, Cs, Fr, Be, Ca, Sr, Sb, Ba, Ra, Ge, Zn, Bi, In, Mg, Ga, Cd, a Sn alloy, an Al alloy, a metal oxide capable of doping and dedoping lithium ions, SiOᵥ (0<v<2), SnO₂, vanadium oxide, lithium vanadium oxide, a composite including a metal compound and carbon material, a Si—C composite, a Sn—C composite, a transition metal oxide, Li₄/3Ti₅/3O₄, SnO, a carbonaceous material, graphite carbon fiber, resin calcination carbon, thermal decomposition vapor growth carbon, corks, mesocarbon microbeads (“MCMB”), furfuryl alcohol resin calcination carbon, polyacene, pitch-based carbon fiber, vapor growth carbon fiber, or natural graphite, and a composition of the formula NaₓSn_{y-z}M_{z} disposed between layers of the layered carbonaceous material, wherein M is Ti, K, Ge, P, or a combination thereof, and 0<x≤15, 1≤y≤5, and 0≤z≤1, as well as oxides, alloys, nitrides, fluorides of any of the foregoing, and any combination of any of the foregoing.

Embodiment 87. The electrode assembly or secondary battery of any previous embodiment, wherein the anode active material comprises at least one of lithium metal, a lithium metal alloy, silicon, silicon alloy, silicon oxide, tin, tin alloy, tin oxide, and a carbon-containing material.

Embodiment 88. The electrode assembly or secondary battery of any previous embodiment, wherein the anode active material comprises at least one of silicon and silicon oxide.

Embodiment 89. The electrode assembly or secondary battery of any previous embodiment, wherein the anode active material comprises at least one of lithium and lithium metal alloy.

Embodiment 90. The electrode assembly or secondary battery of any previous embodiment, wherein the anode active material comprises a carbon-containing material.

Embodiment 91. The electrode assembly or secondary battery of any previous embodiment, wherein members of the population of electrically insulating separators comprise microporous separator material permeated with non-aqueous liquid electrolyte.

Embodiment 92. The electrode assembly or secondary battery of any previous embodiment, wherein members of the population of electrically insulating separators comprise solid electrolyte.

Embodiment 93. The electrode assembly or secondary battery of any previous embodiment, wherein members of the population of electrically insulating separators comprise a ceramic material, glass, or garnet material.

Embodiment 94. The electrode assembly or secondary battery of any previous embodiment, the electrode assembly comprising an electrolyte selected from the group consisting of non-aqueous liquid electrolytes, gel electrolytes, solid electrolytes and combinations thereof.

Embodiment 95. The electrode assembly or secondary battery of any previous embodiment, wherein the electrode assembly comprises a liquid electrolyte.

Embodiment 96. The electrode assembly or secondary battery of any previous embodiment, wherein the electrode assembly comprises an aqueous liquid electrolyte.

Embodiment 97. The electrode assembly or secondary battery of any previous embodiment, wherein the electrode assembly comprises a non-aqueous liquid electrolyte.

Embodiment 98. The electrode assembly or secondary battery of any previous embodiment, wherein the electrode assembly comprises a gel electrolyte.

Embodiment 99. The electrode assembly or secondary battery of any previous embodiment, wherein the electrically insulating separator comprises a solid electrolyte.

Embodiment 100. The electrode assembly or secondary battery of any previous embodiment, wherein the electrically insulating separator comprises a solid polymer electrolyte.

Embodiment 101. The electrode assembly or secondary battery of any previous embodiment, wherein the electrically insulating separator comprises a solid inorganic electrolyte.

Embodiment 102. The electrode assembly or secondary battery of any previous embodiment, wherein the electrically insulating separator comprises a solid organic electrolyte.

Embodiment 103. The electrode assembly or secondary battery of any previous embodiment, wherein the electrically insulating separator comprises a ceramic electrolyte.

Embodiment 104. The electrode assembly or secondary battery of any previous embodiment, wherein the electrically insulating separator comprises an inorganic electrolyte.

Embodiment 105. The electrode assembly or secondary battery of any previous embodiment, wherein the electrically insulating separator comprises a ceramic.

Embodiment 106. The electrode assembly or secondary battery of any previous embodiment wherein the electrically insulating separator comprises a garnet material.

Embodiment 107. The electrode assembly or secondary battery of any previous embodiment, comprising an electrolyte selected from the group consisting of aqueous electrolytes, a non-aqueous liquid electrolyte, a solid polymer electrolyte, a solid ceramic electrolyte, a solid glass electrolyte, a solid garnet electrolyte, a gel polymer electrolyte, an inorganic solid electrolyte, and a molten-type inorganic electrolyte.

Embodiment 108. The electrode assembly or secondary battery of any previous embodiment, wherein members of the population of counter-electrode structures comprise a cathodically active material comprising at least one of transition metal oxides, transition metal sulfides, transition metal nitrides, lithium-transition metal oxides, lithium-transition metal sulfides, lithium-transition metal nitrides, including transition metal oxides, transition metal sulfides, and transition metal nitrides having metal elements having a d-shell or f-shell, and/or where the metal element is any selected from Sc, Y, lanthanoids, actinoids, Ti, Zr, Hf, V, Nb, Ta, Cr, Mo, W, Mn, Tc, Re, Fe, Ru, Os, Co, Rh, Ir, Ni, Pb, Pt, Cu, Ag, and Au, LiCoO₂, LiNi_{0.5}Mn_{1.5}O₄, Li(NiₓCo_{y}Al_{z})O_{z}, LiFePO₄, Li₂MnO₄, V₂O₅, molybdenum oxysulfides, phosphates, silicates, vanadates, sulfur, sulfur compounds, oxygen (air), Li(NiₓMn_{y}Co_{z})O₂, lithium-containing compounds comprising metal oxides or metal phosphates, compounds comprising lithium, cobalt and oxygen (e.g., LiCoO₂), compounds comprising lithium, manganese and oxygen (e.g., LiMn₂O₄) compounds comprising lithium iron and phosphate (e.g., LiFePO), lithium manganese oxide, lithium cobalt oxide, lithium nickel oxide, lithium iron phosphate, lithium cobalt oxide (LiCoO₂), lithium nickel oxide (LiNiO₂), a substituted compound with one or more transition metals, lithium manganese oxide, Li₁₊ₓMn₂₋ₓO₄ (where, x is 0 to 0.33), LiMnO₃, LiMn₂O₃, LiMnO₂, lithium copper oxide (Li₂CuO₂), vanadium oxide, LiV₃O₈, LiFe₃O₄, V₂O₅, Cu₂V₂O₇, Ni site-type lithium nickel oxide represented by the chemical formula of LiNi₁₋ₓMₓO₂ (where, M=Co, Mn, Al, Cu, Fe, Mg, B or Ga, and x=0.01 to 0.3), lithium manganese complex oxide represented by the chemical formula of LiMn₂₋ₓMₓO₂ (where, M=Co, Ni, Fe, Cr, Zn or Ta, and x=0.01 to 0.1), Li₂Mn₃MO₈ (where, M=Fe, Co, Ni, Cu or Zn), LiMn₂O₄ in which a portion of Li is substituted with alkaline earth metal ions, a disulfide compound, Fe₂(MoO₄)₃, a lithium metal phosphate having an olivine crystal structure of Formula 2: Li₁₊ₐFe₋ₓM′ₓ(PO_{4-b})X_{b} wherein M′ is at least one selected from Al, Mg, Ni, Co, Mn, Ti, Ga, Cu, V, Nb, Zr, Ce, In, Zn, and Y, X is at least one selected from F, S, and N, −0.5≤a≤+0.5, 0≤x≤0.5, and 0≤b≤0.1, LiFePO₄, Li(Fe, Mn)PO₄, Li(Fe, Co)PO₄, Li(Fe, Ni)PO₄, LiCoO₂, LiNiO₂, LiMnO₂, LiMn₂O₄, LiNi_{1-y}Co_{y}O₂, LiCo_{1-y}Mn_{y}O₂, LiNi_{1-y}Mn_{y}O₂ (0≤y≤1), Li(NiₐCo_{b}Mn_{c})O₄ (0<a<2, 0<b<2, 0<c<2, and a+b+c=2), LiMn_{2-z}Ni_{z}O₄, LiMn_{2-z}Co_{z}O₄ (0<z<2), LiCoPO₄ and LiFePO₄, elemental sulfur (S8), sulfur series compounds, Li₂Sₙ (n≥1), an organosulfur compound, a carbon-sulfur polymer ((C₂Sₓ)ₙ: x=2.5 to 50, n≥2), an oxide of lithium and zirconium, a composite oxide of lithium and metal (cobalt, manganese, nickel, or a combination thereof), LiₐA_{1-b}M_{b}D₂ (wherein, 0.90≤a≤1, and 0≤b≤0.5), LiₐE_{1-b}M_{b}O_{2-c}D_{c} (wherein, 0.90≤a≤1, 0≤b≤0.5, and 0≤c≤0.05), LiE_{2-b}M_{b}O_{4-c}D_{c} (wherein, 0≤b≤0.5, and 0≤c≤0.05), LiₐNi_{1-b-c}Co_{b}M_{c}Dₐ (wherein, 0.90≤a≤1, 0≤b≤0.5, 0≤c≤0.05, and 0≤a≤2), LiₐNi_{1-b-c}Co_{b}M_{c}O₂₋ₐXₐ (wherein, 0.90≤a≤1, 0≤b≤0.5, 0≤c≤0.05, and 0<a<2), LiₐNi_{1-b-c}Co_{b}M_{c}O₂₋ₐX₂ (wherein, 0.90≤a≤1, 0≤b≤0.5, 0≤c≤0.05, and 0<a<2), LiaNi_{1-b-c}Mn_{b}M_{c}Dₐ (wherein, 0.90≤a≤1, 0≤b≤0.5, 0≤c≤0.05, and 0<a≤2), LiₐNi_{1-b-c}Mn_{b}M_{c}O₂₋ₐXₐ (wherein, 0.90≤a≤1, 0≤b≤0.5, 0≤c≤0.05, and 0<a<2), LiₐNi_{1-b-c}Mn_{b}M_{c}O₂₋ₐX₂ (wherein, 0.90≤a≤1, 04≤b≤0.5, 0≤c≤0.05, and 0<a<2), LiₐNi_{b}E_{c}G_{d}O₂ (wherein, 0.90≤a≤1, 0≤b≤0.9, 0≤c≤0.5, and 0.001≤d≤0.1), LiₐNi_{b}Co_{c}Mn_{d}GeO₂ (wherein, 0.90≤a≤1, 0≤b≤0.9, 0≤c≤0.5, 0≤d≤0.5, and 0.001≤e≤0.1), LiₐNiG_{b}O₂ (wherein, 0.90≤a≤1 and 0.001≤b≤0.1), LiₐCoG_{b}O₂ (wherein, 0.90≤a≤1 and 0.001≤b≤0.1), LiₐMnGbO₂ (wherein, 0.90≤a≤1 and 0.001≤b≤0.1), LiₐMn₂G_{b}O₄ (wherein, 0.90≤a≤1 and 0.001≤b≤0.1), QO₂, QS₂, LiQS₂, V₂O₅, LiV₂O₅, LiX′O₂, LiNiVO₄, Li_{(3-f)}J₂(PO₄)₃ (0≤s≤2); Li_{(3-f)}Fe₂(PO₄)₃ (0≤f≤2), LiFePO₄. (A is Ni, Co, Mn, or a combination thereof, M is Al, Ni, Co, Mn, Cr, Fe, Mg, Sr, V, a rare-earth element, or a combination thereof, D is O, F, S, P, or a combination thereof, E is Co, Mn, or a combination thereof, X is F, S, P, or a combination thereof, G is Al, Cr, Mn, Fe, Mg, La, Ce, Sr, V, or a combination thereof, Q is Ti, Mo, Mn, or a combination thereof, X′ is Cr, V, Fe, Sc, Y, or a combination thereof, and J is V, Cr, Mn, Co, Ni, Cu, or a combination thereof), LiCoO₂, LiMnₓO₂ₓ (x=1 or 2), LiNi₁₋ₓMnₓO₂ₓ (0<x<1), LiNi_{1-x-y}CoₓMn_{y}O₂ (0≤x≤0.5, 0≤y≤0.5), FePO₄, a lithium compound, lithium cobalt oxide, lithium nickel oxide, lithium nickel cobalt oxide, lithium nickel cobalt aluminum oxide, lithium nickel cobalt manganese oxide, lithium manganese oxide, lithium iron phosphate, nickel sulfide, copper sulfide, sulfur, iron oxide, vanadium oxide, a sodium containing material, an oxide of the formula NaM¹ₐO₂ (wherein M¹ is at least one transition metal element, and 0≤a<1), NaFeO₂, NaMnO₂, NaNiO₂, NaCoO₂, an oxide represented by the formula NaMn₁₋ₐM¹ₐO₂ (wherein M¹ is at least one transition metal element, and 0≤a<1), Na[Ni_{1/2}Mn_{1/2}]O₂, Na_{2/3}[Fe_{1/2}Mn_{1/2}]O₂, an oxide represented by Na_{0.44}Mn₁₋ₐM¹ₐO₂(wherein M¹ is at least one transition metal element, and 0≤a<1), an oxide represented by Na_{0.7}Mn₁₋ₐM¹ₐO_{2.05} an (wherein M¹ is at least one transition metal element, and 0≤a<1) an oxide represented by Na_{b}M²_{c}Si₁₂O₃₀ (wherein M² is at least one transition metal element, 2≤b≤6, and 2≤c≤5), Na₆Fe₂Si₁₂O₃₀, Na₂Fe₅Si₁₂O (wherein M² is at least one transition metal element, 2≤b≤6, and 2≤c≤5), an oxide represented by Na_{d}M³ₑSi₆O₁₈ (wherein M³ is at least one transition metal element, 3≤d≤6, and 1≤e≤2), Na₂Fe₂Si₆O₁₈, Na₂MnFeSi₆O₁₈ (wherein M³ is at least one transition metal element, 3≤d≤6, and 1≤e≤2), an oxide represented by Na_{f}M⁴_{g}Si₂O₆ (wherein M⁴ is at least one element selected from transition metal elements, magnesium (Mg) and aluminum (Al), 1≤f≤2 and 1≤g≤2), a phosphate, Na₂FeSiO₆, NaFePO₄, Na₃Fe₂(PO₄)₃, Na₃V₂(PO₄)₃, Na₄Co₃(PO₄)₂P₂O₇, a borate, NaFeBO₄ or Na₃Fe₂(BO₄)₃, a fluoride, Na_{b}M⁵F₆ (wherein M⁵ is at least one transition metal element, and 2≤h≤3), Na₃FeF₆, Na₂MnF₆, a fluorophosphate, Na₃V₂(PO₄)₂F₃, Na₃V₂(PO₄)₂FO₂, NaMnO₂, Na[N_{1/2}Mn_{1/2}]O₂, Na_{2/3}[Fe_{1/2}Mn_{1/2}]O₂, Na₃V₂(PO₄)₃, Na₄Co₃(PO₄)₂P₂O₇, Na₃V₂(PO₄)₂F₃ and/or Na₃V₂(PO₄)₂FO₂, as well as any complex oxides and/or other combinations of the foregoing.

Embodiment 109. The electrode assembly or secondary battery of any previous embodiment, wherein the cathodically active material comprises at least one of a transition metal oxide, transition metal sulfide, transition metal nitride, transition metal phosphate, and transition metal nitride.

Embodiment 110. The electrode assembly or secondary battery of any previous embodiment, wherein the cathodically active material comprises a transition metal oxide containing lithium and at least one of cobalt and nickel.

Embodiment 111. The electrode assembly or secondary battery of any previous embodiment, wherein members of the population of electrode structures comprise anode current collectors comprising at least one of copper, nickel, aluminum, stainless steel, titanium, palladium, baked carbon, calcined carbon, indium, iron, magnesium, cobalt, germanium, lithium, a surface treated material of copper or stainless steel with carbon, nickel, titanium, silver, an aluminum-cadmium alloy, and/or alloys thereof.

Embodiment 112. The electrode assembly or secondary battery of any previous embodiment, wherein members of the population of electrode structures comprise anode current collectors comprising at least one of copper, nickel, stainless steel and alloys thereof.

Embodiment 113. The electrode assembly or secondary battery of any previous embodiment, wherein the counter-electrode structures comprise cathode current collectors comprising at least one of stainless steel, aluminum, nickel, titanium, baked carbon, sintered carbon, a surface treated material of aluminum or stainless steel with carbon, nickel, titanium, silver, or an alloy thereof.

Embodiment 114. The electrode assembly or secondary battery of any previous embodiment, wherein the cathode current collectors comprising at least one of stainless steel, aluminum, nickel, titanium, baked carbon, sintered carbon, a surface treated material of aluminum or stainless steel with carbon, silver, or an alloy thereof.

Embodiment 115. The electrode assembly or secondary battery of any previous embodiment, wherein the cathode current collectors comprising aluminum.

Embodiment 116. The electrode assembly or secondary battery of any previous embodiment, wherein the electrical resistance increases without completely detaching both the electrode busbar and the electrode current collectors from the adhesive layer.

Embodiment 117. The electrode assembly or secondary battery of any previous embodiment, wherein the electrode busbar is configured by design to flex, warp, or deform at or above the transition temperature to at least partially detach the electrode busbar from at least one of the electrode current collector and the adhesive layer.

Embodiment 118. The electrode assembly of Embodiment 117, wherein the electrode busbar comprises a bimetal.

Embodiment 118. The electrode assembly of Embodiment 117, wherein the electrode busbar comprises a trimetal.

Embodiment 119. The electrode assembly of Embodiment 117, wherein the electrode busbar comprises nitinol.

Embodiment 120. The electrode assembly or secondary battery of any previous embodiment, wherein the electrode current collectors are configured by design to flex, warp, or deform at or above the transition temperature to at least partially detach the electrode current collector from at least one of the electrode busbar and the adhesive layer.

Embodiment 121. The electrode assembly of Embodiment 120, wherein the electrode current collectors comprises a bimetal.

Embodiment 122. The electrode assembly of Embodiment 120, wherein the electrode current collectors comprises a trimetal.

Embodiment 123. The electrode assembly of Embodiment 120, wherein the electrode current collectors comprises nitinol.

Embodiment 124. The electrode assembly or secondary battery of any previous embodiment, wherein the transition temperature is from about 60 degrees C. to about 125 degrees C.

Embodiment 125. The electrode assembly or secondary battery of any previous embodiment, wherein the transition temperature is about 60 degrees C.

Embodiment 126. The electrode assembly or secondary battery of any previous embodiment, wherein the transition temperature is about 65 degrees C.

Embodiment 127. The electrode assembly or secondary battery of any previous embodiment, wherein the transition temperature is about 70 degrees C.

Embodiment 128. The electrode assembly or secondary battery of any previous embodiment, wherein the transition temperature is about 75 degrees C.

Embodiment 129. The electrode assembly or secondary battery of any previous embodiment, wherein the transition temperature is about 80 degrees C.

Embodiment 130. The electrode assembly or secondary battery of any previous embodiment, wherein the transition temperature is about 85 degrees C.

Embodiment 131. The electrode assembly or secondary battery of any previous embodiment, wherein the transition temperature is about 90 degrees C.

Embodiment 132. The electrode assembly or secondary battery of any previous embodiment, wherein the transition temperature is about 95 degrees C.

Embodiment 133. The electrode assembly or secondary battery of any previous embodiment, wherein the transition temperature is about 100 degrees C.

Embodiment 134. The electrode assembly or secondary battery of any previous embodiment, wherein the transition temperature is about 105 degrees C.

Embodiment 135. The electrode assembly or secondary battery of any previous embodiment, wherein the transition temperature is about 110 degrees C.

Embodiment 136. The electrode assembly or secondary battery of any previous embodiment, wherein the transition temperature is about 115 degrees C.

Embodiment 137. The electrode assembly or secondary battery of any previous embodiment, wherein the transition temperature is about 120 degrees C.

Embodiment 138. The electrode assembly or secondary battery of any previous embodiment, wherein the transition temperature is about 125 degrees C.

Embodiment 139. An electrode assembly for cycling between a charged state and a discharged state, the electrode assembly comprising: a population of unit cells stacked atop each other in a stacking direction, each member of the population of unit cells including an electrode structure, a separator structure, and a counter-electrode structure, wherein: the electrode structure comprises an electrode current collector and an electrode active material layer, the electrode structure extends in a longitudinal direction perpendicular to the stacking direction, an end portion of the electrode current collector extends past an outer surface of the electrode active material layer and the separator structure in the longitudinal direction; and the counter-electrode structure comprises a counter-electrode current collector and a counter-electrode active material layer, the counter-electrode structure extends in a longitudinal direction perpendicular to the stacking direction; an adhesive layer comprising a resistive polymeric material; and an electrode busbar extending in the stacking direction and having a first surface and a second surface opposite the first surface, the first surface positioned adjacent to the end portions of the electrode current collectors, the first surface being attached to the end portions of the electrode current collectors through the adhesive layer, wherein (i) the first surface of the electrode busbar and the outer surface of the electrode active material layer are separated by a separation distance, and (ii) the separation distance between the first surface of the electrode busbar and the outer surface of the electrode active material layer changes in response to at least one of an electrical short and a current through the adhesive layer.

Embodiment 140. The electrode assembly or secondary battery according to any previous Embodiment, wherein members of the population of electrode structures comprises anode active material comprising any one of more of carbon materials, graphite, soft or hard carbons, metals, semi-metals, alloys, oxides, compounds capable of forming an alloy with lithium, tin, lead, magnesium, aluminum, boron, gallium, silicon, Si/C composites, Si/graphite blends, SiOx, porous Si, intermetallic Si alloys, indium, zirconium, germanium, bismuth, cadmium, antimony, silver, zinc, arsenic, hafnium, yttrium, lithium, sodium, lithium titanate, palladium, lithium metals, carbon, petroleum cokes, activated carbon, graphite, silicon compounds, silicon alloys, tin compounds, non-graphitizable carbon, graphite-based carbon, LiₓFe₂O₃ (0≤x≤1), LiₓWO₂(0≤x≤1), SnₓMe₁₋ₓMe′_{y}O_{z} (Me: Mn, Fe, Pb, Ge; Me′: Al, B, P, Si, elements found in Group 1, Group 2 and Group 3 in a periodic table, halogen; 0<x≤1; 1≤y≤3; 1≤z≤8), a lithium alloy, a silicon-based alloy, a tin-based alloy; a metal oxide, SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, Bi₂O₅, a conductive polymer, polyacetylene, Li—Co—Ni-based material, crystalline graphite, natural graphite, synthetic graphite, amorphous carbon, Kish graphite, pyrolytic carbon, mesophase pitch-based carbon fibers, meso-carbon microbeads, mesophase pitches, graphitized carbon fiber, high-temperature sintered carbon, petroleum, coal tar pitch derived cokes, tin oxide, titanium nitrate, lithium metal film, an alloy of lithium and one or more types of metals selected from the group consisting of Na, K, Rb, Cs, Fr, Be, Mg, Ca, Sr, Ba, Ra, Al and Sn, a metal compound capable of alloying and/or intercalating with lithium selected from any of Si, Al, C, Pt, Sn, Pb, Ir, Ni, Cu, Ti, Na, K, Rb, Cs, Fr, Be, Ca, Sr, Sb, Ba, Ra, Ge, Zn, Bi, In, Mg, Ga, Cd, a Sn alloy, an Al alloy, a metal oxide capable of doping and dedoping lithium ions, SiOᵥ (0<v<2), SnO₂, vanadium oxide, lithium vanadium oxide, a composite including a metal compound and carbon material, a Si—C composite, a Sn—C composite, a transition metal oxide, Li₄/3Ti₅/3O₄, SnO, a carbonaceous material, graphite carbon fiber, resin calcination carbon, thermal decomposition vapor growth carbon, corks, mesocarbon microbeads (“MCMB”), furfuryl alcohol resin calcination carbon, polyacene, pitch-based carbon fiber, vapor growth carbon fiber, or natural graphite, and a composition of the formula NaₓSn_{y-z}M_{z} disposed between layers of the layered carbonaceous material, wherein M is Ti, K, Ge, P, or a combination thereof, and 0<x≤15, 1≤y≤5, and 0≤z≤1, as well as oxides, alloys, nitrides, fluorides of any of the foregoing, and any combination of any of the foregoing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An electrode assembly for cycling between a charged state and a discharged state, the electrode assembly comprising:
a population of unit cells stacked atop each other in a stacking direction, each member of the population of unit cells including an electrode structure, a separator structure, and a counter-electrode structure, wherein:
the electrode structure comprises an electrode current collector and an electrode active material layer, the electrode structure extends in a longitudinal direction perpendicular to the stacking direction, an end portion of the electrode current collector extends past an outer surface of the electrode active material layer and the separator structure in the longitudinal direction; and
the counter-electrode structure comprises a counter-electrode current collector and a counter-electrode active material layer, the counter-electrode structure extends in a longitudinal direction perpendicular to the stacking direction;
an adhesive layer comprising a resistive polymeric material; and
an electrode busbar extending in the stacking direction and having a first surface and a second surface opposite the first surface, the first surface positioned adjacent to the end portions of the electrode current collectors, the first surface being attached to the end portions of the electrode current collectors through the adhesive layer, wherein (i) the adhesive layer is configured to adhere with the electrode busbar and the electrode current collectors below a transition temperature, and (ii) the adhesive layer is configured to at least partially melt at or above the transition temperature to increase an electrical resistance between the electrode busbar and the electrode current collectors.

2. The electrode assembly of claim 1, wherein:
(i) each member of the population of unit cells has an ionic resistance, and (ii) the adhesive layer is configured to at least partially melt upon a formation of an electrical short in a member of the population of unit cells, the electrical short having an electrical resistance that is less than the ionic resistance of the member of the population of unit cells in which the electrical short is formed.

3. The electrode assembly of claim 1, wherein:
(i) each member of the population of unit cells has a capacity (C), and (ii) the adhesive layer is configured to at least partially melt upon a passage of an electrical current through the adhesive layer of a member of the population of unit cells at a current of at least x times C of the member of the population of unit cells.

4. The electrode assembly of claim 1, wherein the resistive polymeric material comprises a polymer and a conductive material suspended in the polymer, and wherein the polymer is configured to at least partially melt at or above the transition temperature to increase a bulk resistivity of the adhesion layer.

5. The electrode assembly of claim 1, wherein the resistive polymeric material comprises a polymer and a conductive material suspended in the polymer, and wherein the polymer is configured to at least partially melt at or above the transition temperature to increase an interfacial resistance between the adhesive layer and at least one of the electrode busbar and the electrode current collectors.

6. The electrode assembly of claim 1, wherein the resistive polymeric material comprises a polymer and a conductive material suspended in the polymer, and wherein the polymer is configured to at least partially melt at or above the transition temperature to reduce a contact of the conductive material within a bulk of the adhesion layer and increase a volume resistivity of the adhesion layer.

7. The electrode assembly of claim 1, wherein the resistive polymeric material comprises a polymer and a conductive material suspended in the polymer, and wherein the polymer is configured to at least partially melt at or above the transition temperature and flows and/or wicks in at interfaces between the conductive material.

8. The electrode assembly of claim 1, wherein the resistive polymeric material comprises a polymer and a conductive material suspended in the polymer, and wherein the polymer is configured to at least partially melt at or above the transition temperature and flows and/or wicks in at interfaces between the adhesion layer and at least one of the electrode busbar and the electrode current collectors.

9. The electrode assembly of claim 1, wherein the adhesive layer is configured to at least partially char at or above the transition temperature to increase the electrical resistance between the electrode busbar and the electrode current collectors.

10. The electrode assembly of claim 1, wherein the adhesive layer is configured to at least partially char at or above the transition temperature to form an electrically insulating layer between the adhesion layer and at least one of the electrode busbar and the electrode current collectors.

11. A secondary battery comprising the electrode assembly of claim 1, wherein the electrode assembly is contained within a hermetically sealed enclosure, and the second surface of the electrode busbar and the hermetically sealed enclosure are in contact with a thermally conductive material.

12. An electrode assembly for cycling between a charged state and a discharged state, the electrode assembly comprising:
a population of unit cells stacked atop each other in a stacking direction, each member of the population of unit cells including an electrode structure, a separator structure, and a counter-electrode structure, wherein:
the electrode structure comprises an electrode current collector and an electrode active material layer, the electrode structure extends in a longitudinal direction perpendicular to the stacking direction, an end portion of the electrode current collector extends past an outer surface of the electrode active material layer and the separator structure in the longitudinal direction; and
the counter-electrode structure comprises a counter-electrode current collector and a counter-electrode active material layer, the counter-electrode structure extends in a longitudinal direction perpendicular to the stacking direction;
an adhesive layer comprising a resistive polymeric material; and
an electrode busbar extending in the stacking direction and having a first surface and a second surface opposite the first surface, the first surface positioned adjacent to the end portions of the electrode current collectors, the first surface being attached to the end portions of the electrode current collectors through the adhesive layer, wherein (i) the resistive polymeric material comprises at least one phase change element that is configured to expand a volume of the adhesive layer at or above a transition temperature, (ii) the adhesive layer has a first volume below the transition temperature; and (iii) the adhesive layer is configured to expand from the first volume towards a second volume at or above the transition temperature to increase an electrical resistance between the electrode busbar and the electrode current collectors.

13. The electrode assembly of claim 12, wherein:
(i) each member of the population of unit cells has an ionic resistance, and (ii) the adhesive layer is configured to expand from the first volume towards the second volume at or above the transition temperature upon a formation of an electrical short in a member of the population of unit cells, the electrical short having an electrical resistance that is less than the ionic resistance of the member of the population of unit cells in which the electrical short is formed.

14. The electrode assembly of claim 12, wherein:
(i) each member of the population of unit cells has a capacity (C), and (ii) the adhesive layer is configured to expand from the first volume towards the second volume at or above the transition temperature upon a passage of an electrical current through the adhesive layer of a member of the population of unit cells at a current of at least x times C of the member of the population of unit cells.

15. The electrode assembly of claim 12, wherein:
(i) the electrode busbar and the electrode current collectors are configured to adhere to the adhesive layer below the transition temperature, and (ii) at least one of the electrode busbar and the electrode current collectors are configured to at least partially detach from the adhesive layer at or above the transition temperature.

16. A secondary battery comprising the electrode assembly of claim 12, wherein the electrode assembly is contained within a hermetically sealed enclosure, and the second surface of the electrode busbar and the hermetically sealed enclosure are in contact with a thermally conductive material.

17. An electrode assembly for cycling between a charged state and a discharged state, the electrode assembly comprising:
a population of unit cells stacked atop each other in a stacking direction, each member of the population of unit cells including an electrode structure, a separator structure, and a counter-electrode structure, wherein:
the electrode structure comprises an electrode current collector and an electrode active material layer, the electrode structure extends in a longitudinal direction perpendicular to the stacking direction, an end portion of the electrode current collector extends past an outer surface of the electrode active material layer and the separator structure in the longitudinal direction; and
the counter-electrode structure comprises a counter-electrode current collector and a counter-electrode active material layer, the counter-electrode structure extends in a longitudinal direction perpendicular to the stacking direction;
an adhesive layer comprising a resistive polymeric material; and
an electrode busbar extending in the stacking direction and having a first surface and a second surface opposite the first surface, the first surface positioned adjacent to the end portions of the electrode current collectors, the first surface being attached to the end portions of the electrode current collectors through the adhesive layer, wherein: (i) the electrode busbar and the electrode current collectors are configured to adhere to the adhesive layer below a transition temperature, and (ii) at least one of the electrode busbar and the electrode current collectors are configured to at least partially detach from the adhesive layer at or above the transition temperature.

18. The electrode assembly of claim 17, wherein:
(i) each member of the population of unit cells has an ionic resistance, and (ii) at least one of the electrode busbar and the electrode current collectors are configured to at least partially detach from the adhesive layer upon a formation of an electrical short in a member of the population of unit cells, the electrical short having an electrical resistance that is less than the ionic resistance of the member of the population of unit cells in which the electrical short is formed.

19. The electrode assembly of claim 17, wherein:
(i) each member of the population of unit cells has a capacity (C), and (ii) at least one of the electrode busbar and the electrode current collectors are configured to at least partially detach from the adhesive layer upon a passage of an electrical current through the adhesive layer of a member of the population of unit cells at a current of at least x times C of the member of the population of unit cells.

20. The electrode assembly of claim 17, wherein the electrode busbar is configured by design to flex, warp, or deform at or above the transition temperature to at least partially detach the electrode busbar from at least one of the electrode current collector and the adhesive layer.

21. The electrode assembly of claim 20, wherein the electrode busbar comprises at least one of a bimetal, a trimetal, and nitinol.

22. The electrode assembly of claim 17, wherein the electrode current collector is configured by design to flex, warp, or deform at or above the transition temperature to at least partially detach the electrode current collector from at least one of the electrode busbar and the adhesive layer.

23. The electrode assembly of claim 22, wherein the electrode busbar comprises at least one of a bimetal, a trimetal, and nitinol.

24. A secondary battery comprising the electrode assembly of claim 17, wherein the electrode assembly is contained within a hermetically sealed enclosure, and the second surface of the electrode busbar and the hermetically sealed enclosure are in contact with a thermally conductive material.

25. An electrode assembly for cycling between a charged state and a discharged state, the electrode assembly comprising:
a population of unit cells stacked atop each other in a stacking direction, each member of the population of unit cells including an electrode structure, a separator structure, and a counter-electrode structure, wherein:
the electrode structure comprises an electrode current collector and an electrode active material layer, the electrode structure extends in a longitudinal direction perpendicular to the stacking direction, an end portion of the electrode current collector extends past an outer surface of the electrode active material layer and the separator structure in the longitudinal direction; and
the counter-electrode structure comprises a counter-electrode current collector and a counter-electrode active material layer, the counter-electrode structure extends in a longitudinal direction perpendicular to the stacking direction;
an adhesive layer comprising a resistive polymeric material; and
an electrode busbar extending in the stacking direction and having a first surface and a second surface opposite the first surface, the first surface positioned adjacent to the end portions of the electrode current collectors, the first surface being attached to the end portions of the electrode current collectors through the adhesive layer, wherein (i) the first surface of the electrode busbar and the outer surface of the electrode active material layer are separated by a separation distance, and (ii) the separation distance between the first surface of the electrode busbar and the outer surface of the electrode active material layer changes in response to at least one of an electrical short and a current through the adhesive layer.

26. The electrode assembly of claim 25, wherein:
(i) each member of the population of unit cells has an ionic resistance, and (ii) the separation distance between the first surface of the electrode busbar and the outer surface of the electrode active material layer increases or decreases upon a formation of an electrical short in a member of the population of unit cells, the electrical short having an electrical resistance that is less than the ionic resistance of the member of the population of unit cells in which the electrical short is formed.

27. The electrode assembly of claim 25, wherein:
(i) each member of the population of unit cells has a capacity (C), and (ii) upon a passage of an electrical current through the adhesive layer of a member of the population of unit cells at a current of at least x times C of the member of the population of unit cells, the separation distance between the first surface of the electrode busbar and the outer surface of the electrode active material layer increases or decreases, wherein x is between about 1 and about 15.

28. The electrode assembly of claim 25, wherein:
(i) each member of the population of unit cells has an ionic resistance, (ii) the first surface of the electrode busbar and the end portions of the electrode current collectors are separated by a separation distance, and (iii) the separation distance between the first surface of the electrode busbar and the end portions of the electrode current collectors increases or decreases upon a formation of an electrical short in a member of the population of unit cells, the electrical short having an electrical resistance that is less than the ionic resistance of the member of the population of unit cells in which the electrical short is formed.

29. The electrode assembly of claim 25, wherein:
(i) each member of the population of unit cells has a capacity (C), (ii) the first surface of the electrode busbar and the end portions of the electrode current collectors are separated by, and (iii) upon a passage of an electrical current through the adhesive layer of a member of the population of unit cells at a current of at least x times C of the member of the population of unit cells, the separation distance between the first surface of the electrode busbar and the end portions of the electrode current collectors increases, wherein x is between about 1 and about 15.

30. A secondary battery comprising the electrode assembly of claim 25, wherein the electrode assembly is contained within a hermetically sealed enclosure, and the second surface of the electrode busbar and the hermetically sealed enclosure are in contact with a thermally conductive material.
